(19) United States
(12) Patent Application Publication
(10) Pub. No.: US 2026/0015100 A1
(43) Pub. Date: Jan. 15, 2026

(54) Providing Feedback on a Mode Transition of a Craft

(71) Applicant: REGENT Craft Inc., North Kingstown, RI (US)

(72) Inventors: Edward Lester, Somerville, MA (US); Andrew Gregg, Roslindale, MA (US); John Cody Allee, Lexington Park, MD (US); Michael Klinker, East Greenwich, RI (US)

(73) Assignee: REGENT Craft Inc., North Kingstown, RI (US)

(21) Appl. No.: 19/331,117

(22) Filed: Sep. 17, 2025

Related U.S. Application Data
(63) Continuation of application No. PCT/US2024/024646, filed on Apr. 15, 2024.
(60) Provisional application No. 63/459,197, filed on Apr. 13, 2023.
(60) Provisional application No. 63/459,201, filed on Apr. 13, 2023.

(51) Int. Cl. B64D 43/00; B63B 1/26; B64C 11/46; B64C 13/04; B64C 35/00

(52) U.S. Cl. CPC B64D 43/00; B63B 1/26; B64C 11/46; B64C 13/0421; B64C 35/006

(57) ABSTRACT

A craft is provided with a lever that can control the power/speed of the craft and semi-automatically transition the craft in various modes of operation. This makes control of the craft somewhat similar to control of a boat, thereby bringing a maritime flight control experience to a wing-in-ground effect vehicles, hydrofoiling vessels, seagliders, and seaplanes. Further, various audio, visual, and/or haptic devices in the cockpit can provide alerts/feedback to the operator on the use of the lever and mode transitions.

### CROSS-REFERENCE TO RELATED APPLICATIONS

This application is a continuation of PCT Application No. PCT/US24/24646, filed Apr. 15, 2024, which claims priority to U.S. Provisional Patent Application No. 63/459,197, filed Apr. 13, 2023, and U.S. Provisional Patent Application No. 63/459,201, filed Apr. 13, 2023, all of which are hereby incorporated by reference.

### BACKGROUND

Some crafts (e.g., seagliders) can operate both in water and in the air. In operation, the hull of the craft is in the water as the craft moves around a harbor and begins taxiing. As the craft gains speed, the craft's hydrofoils cause the hull to rise above the surface of the water. As the craft gains even more speed, lift is generated by aerodynamic surfaces of the craft's wings to cause the craft to become airborne. For landing, the craft gradually descends until the hull is back in the water.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1D is an illustration of a craft of an embodiment.

FIG. 2 is an illustration of a main hydrofoil deployment system of a craft of an embodiment.

FIG. 3 is an illustration of a rear hydrofoil deployment system of a craft of an embodiment.

FIG. 4 is an illustration of a battery system of a craft of an embodiment.

FIG. 5 is an illustration of a control system of a craft of an embodiment.

FIG. 6A is an illustration of a craft of an embodiment in a hull-borne mode of operation.

FIG. 6B is an illustration of a craft of an embodiment in a hydrofoil-borne maneuvering mode of operation.

FIG. 7A is an illustration of a craft of an embodiment in a hydrofoil-borne takeoff mode of operation.

FIG. 7B is a graph that illustrates various lift forces acting on a craft of an embodiment.

FIG. 8 is an illustration of a craft of an embodiment in a wing-borne mode of operation.

FIG. 9 is an illustration of a cockpit of a craft of an embodiment.

FIG. 10 is an illustration of a visual output of a display device in a cockpit of a craft of an embodiment.

FIG. 11 is an illustration of a sidestick controller of an embodiment.

FIG. 12 is an illustration of a lever of an embodiment.

FIG. 13 is a flow chart of a method of an embodiment for transitioning modes in a craft using a lever.

FIG. 14 is an illustration of a lever of an embodiment in a lower detent while in maneuver mode.

FIG. 15 is an illustration of a lever of an embodiment in a main detent upon a transition from maneuver mode to hull mode.

FIG. 16 is an illustration of a lever of an embodiment in a main detent while in hull mode.

FIG. 17 is an illustration of a lever of an embodiment in an upper detent after a transition from hull mode to foil mode.

FIG. 18 is an illustration of a lever of an embodiment in a main detent while in foil mode.

FIG. 19 is an illustration of a lever of an embodiment in a lower detent upon a transition from foil mode to hull mode.

FIG. 20 is an illustration of a lever of an embodiment in an upper detent upon a transition from foil mode to wing mode.

FIG. 21 is an illustration of a lever of an embodiment in a main detent while in wing mode.

FIG. 22 is an illustration of a lever of an embodiment in a lower detent upon a transition from wing mode to hull mode.

FIG. 23 is an illustration of a lever of an embodiment in a main detent while in hull mode.

FIG. 24 is an illustration of a lever of an embodiment in a lower detent upon a transition from hull mode to maneuver mode.

FIG. 25 is an illustration of a lever of an embodiment having two lower detent regions.

FIG. 26 is an illustration of two lower detent regions of an embodiment.

FIG. 27 is an illustration of a switch of an embodiment.

FIGS. 28A-C are illustrations of displays of various speed gauge modes of an embodiment.

FIG. 29 is an illustration of a display of a speed gauge of an embodiment.

FIGS. 30A-C are illustrations of displays of various height gauge modes of an embodiment.

FIG. 31 is an illustration of a display of a height gauge of an embodiment.

FIGS. 32A-H are illustrations of a display of an embodiment.

FIGS. 33A-C are illustrations of a display of an embodiment providing an augmented reality navigation target.

FIG. 34 is an illustration of one form of a visual output of a display device in a cockpit of a craft displaying an augmented environmental overlay view in a main display region of an embodiment.

FIG. 35 is an illustration of one form of a visual output of a display device in a cockpit of a craft displaying a map overview view in a main display region of an embodiment.

FIG. 36 is an illustration of one form of a speed gauge displayed in a visual output of a display device in a cockpit of a craft of an embodiment.

FIG. 37 is an illustration of one form of a height gauge displayed in a visual output of a display device in a cockpit of a craft of an embodiment.

FIGS. 38A-F are illustrations of forms of a flap retraction window displayed in a visual output of a display device in a cockpit of a craft of an embodiment.

FIGS. 39A-H are illustrations of forms of a foil position window displayed in a visual output of a display device in a cockpit of a craft of an embodiment.

FIGS. 40A and 40B are illustrations of forms of an operating mode indicator displayed in a visual output of a display device in a cockpit of a craft of an embodiment.

FIGS. 41A, 41B, and 41C are illustrations of forms of an alert indication area displayed in a visual output of a display device in a cockpit of a craft of an embodiment.

### DETAILED DESCRIPTION

Various examples of systems, devices, and/or methods are described herein. Any embodiment, implementation, and/or feature described herein as being an “example” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein, are meant that the recited characteristic, parameter, or value need not be achieved exactly but that deviations or variations, including, for example, tolerances, measurement error, measurement accuracy limitations and other factors known to skill in the art, may occur in amounts that do not preclude the effect the characteristic was intended to provide.

### I. INTRODUCTION

As mentioned above, the craft (e.g., a seaglider) can operate both in water and in the air. When the hull of the craft is in the water as the craft moves around a harbor and starts taxiing, the operation of the craft is in some ways similar to operating a boat since it involves controlling the craft on the water, in only two dimensions. However, operating the craft to cause it to become airborne is quite different since it involves operating the craft in a third (height) dimension. Differences in controlling the craft while water and while airborne, including the transition between water and air, can involve some challenges. The following embodiments can be used to address these challenges by making the operation of the craft more like the operation of a boat even while operating in the third dimension, i.e., while the craft is in the air. This can decrease the cognitive load of the operator and can improve the overall experience of both the operator and the passengers of the craft. Further, various audio, visual, and/or haptic devices in the cockpit can provide alerts/feedback to the operator on the use of the lever and mode transitions.

In one embodiment, a craft is provided comprising a user input device, a display device. at least one processor, a non-transitory computer-readable medium, program instructions stored on the non-transitory computer-readable medium. The program instructions, when executed by the at least one processor, cause the at least one processor to: transition from a first mode of operating the craft to a second mode of operating that craft in response to actuation of the user input device; and dynamically change a display generated on the display device in response to the transition from the first mode of operating the craft to the second mode of operating the craft. In one embodiment, the display comprises a speed gauge, and a range of the speed gauge is dynamically changed in response to the transition

In another embodiment, a method is provided that is performed in a control system of a craft comprising a user input device and a speaker. The method comprises: receiving a signal indicating movement of the user input device; attempting to transition from a first mode of operating the craft to a second mode of operating that craft in response to receiving the signal; and generating audio via the speaker to provide feedback on the attempt to transition.

In yet another embodiment, a craft is provided comprising a lever positionable in a lower detent, a main detent, and an upper detent. A first gate is configured to provide physical resistance in moving the lever from the lower detent to the main detent, and a second gate is configured to provide physical resistance in moving the lever from the main detent to the upper detent. In other implementations, in addition to or in place of physical resistance, the lever may include a secondary physical action required to move the lever between detents. For example, the lever may include a secondary paddle that is pulled to allow movement between detents.

The craft further comprises a user interface device, at least one processor, a non-transitory computer-readable medium, and program instructions stored on the non-transitory computer-readable medium. The program instructions, when executed by the at least one processor, cause the at least one processor to: transition the craft from maneuver mode to hull mode in response to the lever being moved from the lower detent to the main detent when the craft is in maneuver mode; transition the craft from hull mode to foil mode in response to the lever being moved from the main detent to the upper detent when the craft is in hull mode; transition the craft from foil mode to wing mode in response to the lever being again moved from the main detent to the upper detent when the craft is in wing mode; change a power or a speed of the craft in response to movement of the lever within the main detent; and generate an output via the user interface device in response to movement of the lever.

Other embodiments are disclosed, and the disclosed embodiments can be use alone or in combination.

These and other aspects are discussed in more detail in the passages that follow.

### II. EXAMPLE WING-IN-GROUND EFFECT VEHICLES

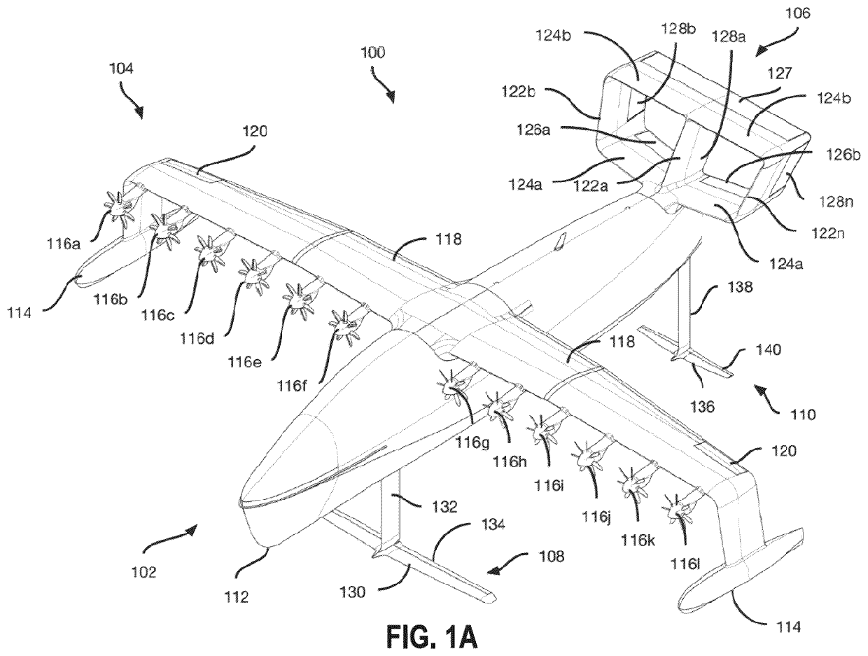

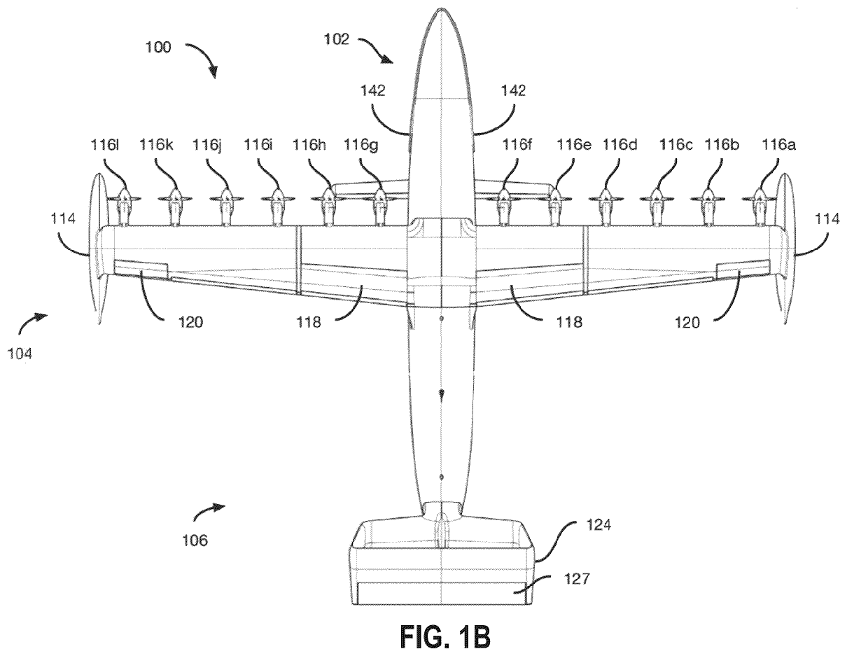

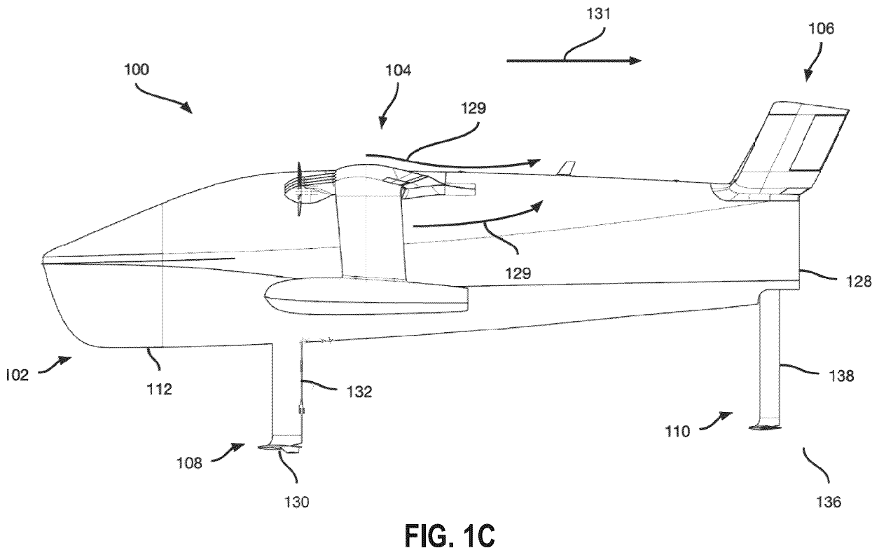

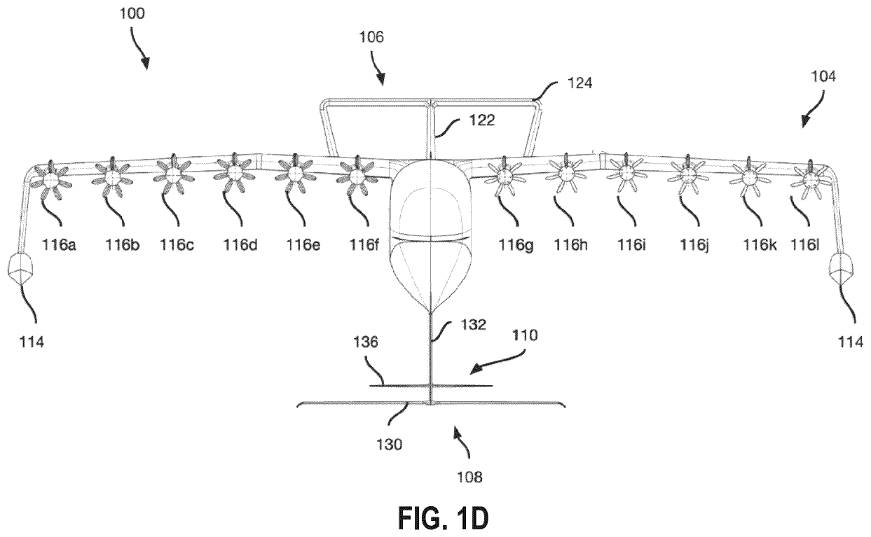

FIGS. 1A-ID illustrate different views of an example of a craft 100. As shown, some examples of the craft 100 include a hull 102, a main wing 104, a tail 106, a main hydrofoil assembly 108, and a rear hydrofoil assembly 110.

### A. Hull

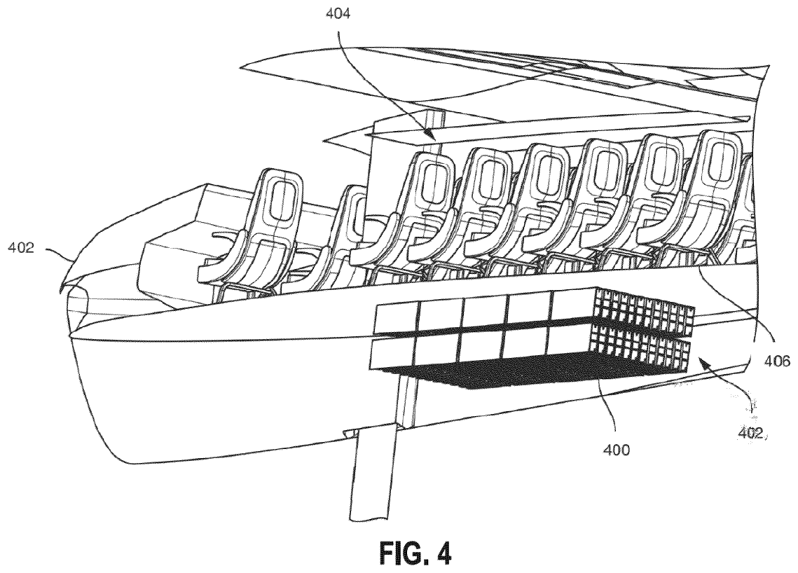

Some examples of the craft 100 operate in a first waterborne mode for an extended period of time, during which the hull 102 is at least partially submerged in water. As such, some examples of the hull 102 are configured to be watertight, particularly for surfaces of the hull that contact the water during this first waterborne operational mode. Further, some examples of the hull 102, as well as the entirety of the craft 100, are configured to be passively stable on all axes when floating in water. To help achieve this, some examples of the hull 102 include a keel (or centerline) 112, which provides improved stability and other benefits described below. Some examples of the craft 100 include various mechanisms for adjusting the center of mass of the craft 100 so that the center of mass aligns with the center of buoyancy of the craft 100. For instance, in some examples, a battery system (described in further detail below in connection with FIG. 4) of the craft 100 is electrically coupled to one or more moveable mounts. Some examples of the mounts are moved by one or more servo motors or the like. In some examples, a control system of the craft 100 is configured to detect a change in its center of buoyancy, for instance, by detecting a rotational change via an onboard gyroscope, and responsively operate the servo motors to move the battery system until the gyroscope indicates that the craft 100 has stabilized. Some examples of the craft 100 include a ballast system for pumping water or air to various tanks distributed throughout the hull 102 of the craft 100. The ballast system facilitates adjusting the center of mass of the craft 100 so that the center of mass aligns with the center of buoyancy of the craft 100. Other example systems may be used to control the center of mass of the craft 100 as well.

Additionally, or alternatively, some examples of the hull 102 are configured to reduce drag forces when both waterborne and wing-borne. For instance, some examples of the hull 102 have a high length-to-beam ratio (e.g., greater than or equal to 8), which facilitates reducing hydrodynamic drag forces when the craft 100 is under forward waterborne motion. Some examples of the keel 112 are curved or rockered to improve maneuverability when waterborne. Further, some examples of the hull 102 are configured to pierce the surface of waves (e.g., to increase passenger and crew comfort) by including a narrow, low-buoyancy bow portion of the hull 102.

### B. Wing and Distributed Propulsion System

As shown in FIGS. 1A-1D, some examples of the main wing 104 include an outrigger 114 at each end of the main wing 104. The outriggers 114 (which are sometimes referred to as “wing-tip pontoons”) are configured to provide a buoyant force to the main wing 104 when submerged or when otherwise in contact with the water, which improves the stability of the craft 100 during waterborne operation.

As shown in FIG. 1D, some examples of the main wing 104 have a gull-wing shape such that the outriggers 114 at the ends of the main wing 104 are at the lowest point of the main wing 104 and are positioned approximately level with (or slightly above) a waterline of the hull 102 when the hull 102 is waterborne.

Some examples of the main wing 104 have a high aspect ratio, which is defined as the ratio of the span of the main wing 104 to the mean chord of the main wing 104. In some examples, the aspect ratio of the main wing 104 is greater than or equal to five, or greater than or equal to six, but other example aspect ratios are possible as well. Such wings tend to have reduced pitch stability and maneuverability due to lower roll angular acceleration. These issues are ameliorated by various mechanisms described below. On the other hand, such wings tend to have increased roll stability and increased efficiency resulting from higher lift-to-drag ratios. Further, high aspect ratio wings provide a longer leading edge for the mounting of a distributed propulsion system along the wing.

As shown in the figures, some examples of the main wing 104 include a number of electric motor propeller assemblies 116 distributed across a leading edge of the main wing 104. This arrangement corresponds to a blown-wing propulsion system. Arranging the propeller assemblies 116 in this manner increases the speed of air moving over the main wing 104, which increases the lift generated by the main wing 104. This increase in lift allows the craft 100 to take off and become wing-borne at slower vehicle speeds. This facilitates, for example, taking off on water which can be difficult at higher speeds due to the various forces that would otherwise act on the craft 100.

The electric motor propeller assemblies 116 tend to be much lighter, less complex, and smaller than the liquid-fueled engines used on conventional craft. Some examples of the electric motor propeller assemblies 116 are controlled by an electronic speed controller and powered by an onboard battery system (e.g., a lithium-ion system, magnesium-ion system, lithium-sulfur system, etc.). Some examples of the electric motor propeller assemblies 116 are controlled by a fuel cell or a centralized liquid-fueled electricity generator. In some examples, the onboard electrical supply system includes multiple systems for supplying power during different operational modes, such as a first battery system configured to deliver large amounts of power during takeoff and a second system with a higher energy density but lower peak power capability for delivering sustained lower power during cruise operation (e.g., during hydrofoil waterborne operation or during wing-borne operation, each of which are described in further detail below).

In some examples, the positioning of the electric motor propeller assemblies 116 along the leading edge of the main wing 104 is determined based on a variety of factors including, but not limited to, (i) the required total thrust for all modes of operation of the craft 100, (ii) the thrust generated by each individual propeller of the propeller assemblies 116, (iii) the radius of each propeller in the respective propeller assemblies 116, (iv) the required tip clearance between each propeller and the surface of the water, and (v) the additional freestream speed over the main wing 104 required for operation.

As shown in the figures, in some examples, the number of propeller assemblies 116 is symmetrical across both sides of the hull 102. In some examples, the propeller assemblies 116 are identical. In some examples, the propeller assemblies 116 have different propeller radii or blade configurations along the span so long as the configuration is symmetrical across the hull 102. The different radii facilitate adequate propeller tip clearance from the water or vehicle structure. In some examples, the different propellers are optimized for different operational conditions, such as wing-borne cruise. The propeller placement and configuration may vary to increase the airflow over the main wing 104 or tail system 106 to improve controllability or stability. While eight total propeller assemblies 116 are illustrated, the actual number of propeller assemblies 116 can vary based on the requirements of the craft 100.

In some examples, the propeller assemblies 116 have different pitch settings or variable pitch capabilities based on their position on the main wing 104. For instance, in some examples, a subset of the propeller assemblies 116 have fixed-pitch propellers sized for cruise speeds, while the remainder of the propeller assemblies 116 have fixed-pitch propellers configured for takeoff or can allow for varying the propeller's pitch.

In some examples, different propeller assemblies 116 are turned off or have reduced rotational speeds during different modes of operation. For instance, during waterborne operation, one or more of the propeller assemblies 116 may be turned off or have reduced rotational speeds in a manner that generates asymmetrical thrust. This may create a yawing moment on the craft 100, allowing the craft 100 to turn without large bank angles and increasing the turning maneuverability of the craft 100. For instance, in order to yaw right, the craft 100 may increase the rotational speeds of the propellers of one or more of propeller assemblies 116g-l while decreasing the rotational speeds of the propellers of one or more of propeller assemblies 116a-f. Similarly, to yaw left, the craft 100 may increase the rotational speeds of the propellers of one or more of propeller assemblies 116a-f while decreasing the rotational speeds of the propellers of one or more of propeller assemblies 116g-l.

Similarly varying rotational speeds or propeller pitches may be used to yaw or roll the aircraft in flight or while foiling due to varied forces and lift distributions imposed over the wing and its control surfaces or in general used to tailor the lift distribution across the wing for optimized efficiency.

In some examples, the propeller assemblies may tilt to vector thrust either to provide directly more vertical lift or to change how the wing is blown depending on the mode of operation so as to tailor the blown lift distribution.

Some examples of the main wing 104 include one or more aerodynamic control surfaces, such as flaps 118 and ailerons 120. Some examples of these controls comprise movable hinged surfaces on the trailing or leading edges of the main wing 104 for changing the aerodynamic shape of the main wing 104. Some examples of the flaps 118 are configured to extend downward below the main wing 104 to reduce stall speed and create additional lift at low airspeeds, while some examples of the ailerons 120 are configured to extend upward above the main wing 104 to decrease lift on one side of the main wing 104 and induce a roll moment in the craft 100. In some examples, the ailerons 120 are additionally configured to extend downward below the main wing 104 in a flaperon configuration to help the flaps 118 generate additional lift on the main wing 104, which, in some examples, is used to either create a rolling moment or additional balanced lift depending on coordinated movement of both ailerons. Some examples of the flaps 118 and ailerons 120 include one or more actuators for raising and lowering the flaps 118 and ailerons 120. Within examples, the flaps 118 include one or more of plain flaps, split flaps, slotted flaps, Fowler flaps, slotted Fowler flaps, Gouge flaps, Junkers flaps, or Zap flaps. Further, in some examples, the flaps 118 (and the ailerons 120 when configured as flaperons) are positioned to be in the wake of one or more of the propeller assemblies 116. In some examples, the ailerons 120 are positioned so that they are in the wake of one or more of the propeller assemblies 116 to increase the effectiveness of the ailerons at low forward velocities. Some of the propeller assemblies 116 are positioned so that no ailerons 120 are in their wake to increase thrust on the outboard wing during a turn without inducing adverse yaw. For example, in a left turn, a normal airplane would have adverse yaw to the right as the right aileron is deflected down, increasing drag. In the present disclosure, however, the right propeller assembly outboard of the right aileron may have its thrust increased relative to the respective left propeller assembly, initiating a turn without adverse yaw.

### C. Tail System

As illustrated in FIGS. 1A-ID, some examples of the tail 106 include a vertical stabilizer 122, a horizontal stabilizer 124, and one or more control surfaces, such as elevators 126. Similar to the flaps 118 and ailerons 120, some examples of the elevators 126 comprise movable hinged surfaces on the trailing or leading edges of the horizontal stabilizer 124 for changing the aerodynamic shape of the horizontal stabilizer 124 to control a pitch of the craft 100. Some examples of the horizontal stabilizer 124 are combined with the elevator 126, creating a fully articulating horizontal stabilizer (e.g., a stabilator). Raising the elevators 126 above the hinge point creates a net downward force on the tail system and causes the craft 100 to pitch upward. Lowering the elevators 126 below the hinge point creates a net upward force on the horizontal stabilizer 124 and causes the craft 100 to pitch downward. Some examples of the elevators 126 include actuators, which are operated by a control system of the craft 100 to raise and lower the elevators 126.

As illustrated in FIGS. 1A-1D, some examples of tail 106 include a rudder 128. Some examples of the rudder 128 comprise a movable hinged surface on the trailing edge of the vertical stabilizer 122 for changing the aerodynamic shape of the vertical stabilizer 122 to control the yaw of the craft 100 when operating in an airborne mode. In some examples, the rudder 128 additionally changes a hydrodynamic shape of the hull 102 to control the yaw of the craft 100 when operating in a waterborne mode. To facilitate such hydrodynamic control, in some examples, the rudder 128 is positioned low enough on the tail 106 that the rudder 128 is partially or entirely submerged when the hull 102 is floating in water. For instance, the rudder 128 is positioned partially or entirely below the waterline of the hull 102. Some examples of the rudder 128 include one or more actuators, which are operated by a control system of the craft 100 to rotate the hinged surface of the rudder 128 to the left or right of the vertical stabilizer 122. Actuating the rudder 128 to the left (relative to the direction of travel) causes the craft 100 to yaw left. Actuating the rudder 128 to the right (relative to the direction of travel) causes the craft 100 to yaw right. As such, the rudder 128 may be used in combination with any of the other mechanisms disclosed herein for controlling the yaw of the craft 100, including in combination with the ailerons 120 during airborne operation and in combination with varying the rotational speeds of different ones of the propeller assemblies 116 to help improve the maneuverability of the craft 100 during waterborne operation.

Some examples of the tail 106 include one or more vertical stabilizers 122a, 122b, 122n, one or more horizontal stabilizers 124a, 124b, one or more control surfaces, such as elevators 126, and one or more tail flaps 127 for enhanced pitch control configured to exert enhanced net downward force on the tail system. It should be understood that although the figures show only two horizontal stabilizers, it is contemplated that more than two of each can be used within the scope of the present teachings. In some applications, it has been found that the transition from waterborne operation to airborne or wing-borne operation can require a larger pitching moment to overcome the larger drag forces existing between the hull 102 and/or the hydrofoil assemblies 108, 110 and the water. This phenomenon can further occur in wheeled aircraft configured for short takeoff and landing (STOL) operations. In this way, at low airspeeds, aerodynamic forces in conventional designs fail to produce sufficient downward force to permit sufficient pitching moment. To provide sufficient pitching moment to pitch the craft 100 upward, a conventional solution would be to increase the span of the tail so that the elevator generates more force; however, a resultant consequence of increasing the span of the tail is that the entire tail must be stronger and heavier, which can result in undesired reduction of payload and efficiency. However, the present configuration provides improved performance by providing a tail 106 having a first horizontal stabilizer 124a and a second horizontal stabilizer 124b. It should be understood that one or more additional horizontal stabilizers can be used.

In some examples, a first horizontal stabilizer 124a is a lower horizontal stabilizer relative to a second horizontal stabilizer 124b. However, it should be appreciated that the horizontal stabilizers in some examples can be interchanged for performance purposes (e.g., the disclosed structure of the first horizontal stabilizer 124a can be incorporated in the upper horizontal stabilizer and the disclosed structure of the second horizontal stabilizer 124b can be incorporated in the lower horizontal stabilizer). In some non-limiting examples, the structure, shape, and/or performance of each horizontal stabilizer can be tailored as desired such that the lower horizontal stabilizer (in this example, the first horizontal stabilizer 124a) is more likely to experience aerodynamic effect from being in the wake of the blown-wing propulsion system disclosed herein or associated wake produced by alternative propulsion systems. In this way, greater aerodynamic control and/or downwards lift can be generated during desired phases of operation.

Some examples of the horizontal stabilizers 124a, 124b include one or more aerodynamic control surfaces, such as tail flaps 127 and elevators 126, which may comprise movable hinged surfaces on the trailing or leading edges of the horizontal stabilizer 124a, 124b for changing the aerodynamic shape of the respective horizontal stabilizer 124a, 124b. It should be recognized that at least one of the horizontal stabilizers 124a, 124b can be sized, shaped, and/or spaced relative to a second of the horizontal stabilizers 124a, 124b to enhance or minimize the aerodynamic effect on the adjacent stabilizers. In this way, the aerodynamic flow, pressures, and/or forces can be used to improve the efficiency or effectiveness of the adjacent stabilizer. In some examples, at least one of the horizontal stabilizers 124a, 124b can be actuated in an opposing direction. In some embodiments, at least one of the horizontal stabilizers 124a, 124b can define a ratio of a surface area of the first horizontal stabilizer to a surface area of the second horizontal stabilizer in the range of 0.9 to 1.6. In some non-limiting example configurations, the surface area of the first horizontal stabilizer is 5.7 m2, the surface area of the second horizontal stabilizer is 3.9 m2, both have a chord of about 1 m and a vertical separation of 1.8 m. In some embodiments, a vertical separation distance between the first horizontal stabilizer and the second horizontal stabilizer is in the range of 0.25 to 0.75 of the lower horizontal stabilizer span. In some examples, a vertical separation distance can be dependent on the required rudder authority and thus elevator size (driven by, e.g., yaw stability, or the need to counteract asymmetric thrust following powerplant failure). In some examples, a sweep offset moves the center of pressure further aft from the center of gravity, thus allowing the airfoil of the horizontal stabilizer to have less surface area overall, thus being smaller and lighter. In some examples, a dihedral in the bottom surface of the horizontal stabilizer adds stability. In some examples, the box tail design itself increases the efficiency due to the elimination of wingtip vortices of a typical tail. In some embodiments, a lower horizontal stabilizer may have approximately a 15% thickness-to-chord ratio to support the weight of the upper components, whereas the vertical and upper surfaces may be thinner, such as, for example, 10% thickness-to-chord ratio due to reduced structural load requirement, which enables the upper horizontal stabilizer to be more efficient (lower drag). It should be appreciated that the left and right elevator surfaces 126 can be controlled independently and/or differentially to create a rolling moment, thereby enabling the wing ailerons 120 to be made smaller. The smaller wing ailerons 120 further enable larger flaps 118. It should be appreciated that in some embodiments, using the vertical control surfaces 128a, 128b, 128n can change the pressure distribution across the elevator 126, for example, commanding a left 5 degree deflection in the left vertical control surface may move the mean pressure distribution left/right by a percentage of the elevator width.

Some examples of the tail flaps 127 are configured to selectively extend upward above the horizontal stabilizer 124 for changing a surface area, camber, aspect ratio, and/or shape of the horizontal stabilizer 124. The tail flaps 127 may include, for example, one or more of plain flaps, split flaps, slotted flaps, Fowler flaps, slotted or double-slotted Fowler flaps, Gouge flaps, Junkers flaps, or Zap flaps. That is, in some examples, tail flaps 127 serve to change an angle of attack of the horizontal stabilizer 124, change a chord line of the horizontal stabilizer 124, change a surface area of the horizontal stabilizer 124, and/or otherwise increase the net effective downwardly directed lift of the horizontal stabilizer 124. Such configurations effectively reduce the speed at which the horizontal stabilizer 124 becomes aerodynamically effective by creating additional net downward force at low airspeeds to aid in exerting a nose-up pitching moment of the craft 100. The elevators 126 may be configured for changing the aerodynamic shape of the horizontal stabilizer 124 to further control or vary a pitch of the craft 100.

In some examples operations, the tail flaps 127 are deployed for takeoff (e.g., transition from hydrofoil-borne mode to airborne mode) and landing (e.g., transition from airborne mode to hull-borne mode) to generate additional downforce on the tail system when additional pitch-up moment is required. Tail flaps 127 can be stowed for other phases of operation, such as hull-borne mode, to reduce downforce on the tail system and reduce drag.

In some examples, the elevators 126 are additionally configured to extend upward above the horizontal stabilizer 124 in a flaperon-like configuration (yet with elevators, rather than ailerons) to help the tail flaps 127 generate additional downward force on the horizontal stabilizer 124, which may be used to either create a pitching moment or additional balanced downward force. The tail flaps 127 and elevators 126 may each include one or more actuators 125 for raising and lowering the tail flaps 127 and elevators 126, singly or in combination. The actuators 125 can comprise any system configured to selectively actuate the associated system, such as but not limited to a flap track system (integrated into vertical stabilizers 122a, 122b, 122n, which can reduce complex hinge systems or external arms, thereby reducing wetted area and excrescences drag), an electric servo motor mounting within the vertical stabilizers 122a, 122b, 122n and/or horizontal stabilizers 124a, 124b, and/or a central vertical strut system generally mounted in the hull 102 or the fuselage of the craft 100 (to provide the potential for reduced cross-sectional area and associated drag).

Further, in some examples, the elevators 126 and/or the tail flaps 127 are positioned so that they are in the wake 129 of one or more of the propeller assemblies 116 of main wing 104. The elevators 126 and/or the tail flaps 127 may be positioned so that they are in the wake 129 of one or more of the propeller assemblies 116 to increase the effectiveness of the elevators at low forward velocities. In some examples, the propeller assemblies 116 are positioned so that no elevators 126 and/or tail flaps 127 are in the wake 129 to ensure consistent and/or predictable aerodynamic forces, independent of power application, are exerted during critical operational phases. In some examples, the propeller assemblies 116 are positioned so that the elevators 126 are in their wake 129 and the tail flaps 127 are not in the wake 129 (e.g., above the wake 129) and are exposed to clean air 131. It should be understood that positioning of the tail flaps 127 in the second horizontal stabilizer 124b, or at a distance above the center of gravity of the craft 100, will have the added unexpected benefit of creating additional nose-up pitching moment as a result of induced drag acting about the center of gravity causing the craft 100 to pitch upward.

Similar to the flaps 118 and the ailerons 120 of the main wing 104, some examples of the elevators 126 comprise movable hinged surfaces on the trailing or leading edges of the horizontal stabilizer 124 for changing the aerodynamic shape of the horizontal stabilizer 124 to control a pitch of the craft 100. The horizontal stabilizer 124 may be combined with the elevator 126, creating a fully articulating horizontal stabilizer (e.g., a stabilator). Raising the elevators 126 above the hinge point creates a net downward force on the tail system and causes the craft 100 to pitch upward. Lowering the elevators 126 below the hinge point creates a net upward force on the horizontal stabilizer 124 and causes the craft 100 to pitch downward. The elevators 126 may include actuators, which may be operated by a control system of the craft 100 in order to raise and lower the elevators 126.

In some examples, the tail 106 includes one or more rudders 128a, 128b, 128n. The rudders 128a, 128b, 128n may each comprise a movable hinged surface on the trailing edge of the corresponding vertical stabilizers 122a, 122b, 122n for changing the aerodynamic shape of the vertical stabilizer 122 to control the yaw of the craft 100 when operating in an airborne mode. It should be understood that rudders 128a, 128b, 128n can operate independently or in combination as desired. Moreover, in some examples, rudders 128a, 128b, 128n can be used as redundant systems, particularly useful in the event of one or more failures.

In some examples, the rudders 128a, 128b, 128n additionally change a hydrodynamic shape of the hull 102 to control the yaw of the craft 100 when operating in a waterborne mode. In order to facilitate such hydrodynamic control, the rudders 128a, 128b, 128n may be positioned low enough on the tail 106 that one or more of the rudders 128a, 128b, 128n is partially or entirely submerged when the hull 102 is floating in water. Namely, the rudders 128a, 128b, 128n may be positioned partially or entirely below a waterline of the hull 102. The rudders 128a, 128b, 128n may include one or more actuators, which may be operated by a control system of the craft 100 in order to rotate the hinged surface of the rudders 128a, 128b, 128n to the left or right of the vertical stabilizer 122. Actuating the rudders 128a, 128b, 128n to the left (relative to the direction of travel) causes the craft 100 to yaw left. Actuating the rudders 128a, 128b, 128n to the right (relative to the direction of travel) causes the craft 100 to yaw right. As such, the rudders 128a, 128b, 128n may be used in combination with any of the other mechanisms disclosed herein for controlling the yaw of the craft 100, including in combination with the ailerons 120 during airborne operation and in combination with varying the rotational speeds of different ones of the propeller assemblies 116 to help improve the maneuverability of the craft 100 during waterborne operation.

It should be understood that the fundamental shape of tail 106, having one or more vertical stabilizers 122a, 122b, 122n and one or more horizontal stabilizers 124a, 124b, can result in a box-like assembly, wherein the vertical stabilizers are generally coupled to the horizontal stabilizers to form a reinforced box-like construction. This box-like construction provides enhanced structural integrity that enables tail 106 of some examples to be lighter and/or smaller than otherwise constructed.

Some examples of the craft 100 include a distributed propulsion system on the tail 106, which may be similar to the distributed propulsion system of propeller assemblies 116 on the main wing 104. Such a distributed propulsion system may provide similar benefits of increasing the freestream velocity over the control surfaces (e.g., the elevators 126 and/or the rudder 128) to allow for increased pitch and yaw control of the craft 100 at lower travel speeds. When determining the number and size of propeller assemblies to include on the tail 106, one may apply the same factors described above when determining the number and size of propeller assemblies to include on the main wing 104.

### D. Hydrofoil Systems

As noted above, some examples of the craft 100 include a main hydrofoil assembly 108 and a rear hydrofoil assembly 110. In some examples, the main hydrofoil assembly 108 is positioned proximate to the middle or bow of the craft 100, and the rear hydrofoil assembly 110 is positioned proximate to the stern. For instance, some examples of the main hydrofoil assembly 108 is positioned between the bow and a midpoint (between the bow and stern) of the craft 100, and some examples of the rear hydrofoil assembly 110 is positioned below the tail 106 of the craft 100.

The main hydrofoil assembly 108 and the rear hydrofoil assembly 110 are configured to facilitate the breaking of contact between the hull of the craft and the water surface during takeoff, which, as noted above, can otherwise be challenging in some conventional craft designs. Some examples of the main hydrofoil assembly 108 and the rear hydrofoil assembly 110 are configured to be retractable, large enough to lift the entire craft out of the water and not impact the water surface, and to enable sustained operation in the hydrofoil-borne mode (where the entire weight of the craft is supported by the one or more hydrofoil assemblies).

Some examples of the main hydrofoil assembly 108 include a main hydrofoil 130, one or more main hydrofoil struts 132 that couple the main hydrofoil 130 to the hull 102, and one or more main hydrofoil control surfaces 134. Similarly, some examples of the rear hydrofoil assembly 110 include a rear hydrofoil 136, one or more rear hydrofoil struts 138 that couple the rear hydrofoil 136 to the hull 102, and one or more rear hydrofoil control surfaces 140.

Some examples of the main hydrofoil 130 and the rear hydrofoil 136 take the form of one or more hydrodynamic lifting surfaces (also referred to as “foils”) configured to be operated partially or entirely submerged underwater while the hull 102 of the craft 100 remains above and clear of the water's surface. In operation, as the craft 100 moves through water with the main hydrofoil 130 and the rear hydrofoil 136 submerged, the hydrofoils generate a lifting force that causes the hull 102 to rise above the surface of the water. In general, the lifting force generated by the hydrofoils must be at least equal to the weight of the craft 100 to cause the hull 102 to rise above the surface of the water. The lifting force of the hydrofoils depends on the speed and angle of attack at which the hydrofoils move through the water, as well as their various physical dimensions, including the aspect ratio, the surface area, the span, and the chord of the foils.

The height at which the hull 102 is elevated above the surface of the water during hydrofoil-borne operation is limited by the length of the one or more main hydrofoil struts 132 that couple the main hydrofoil 130 to the hull 102 and the length of the one or more rear hydrofoil struts 138 that couple the rear hydrofoil 136 to the hull 102. In some examples, the main hydrofoil strut 132 and the rear hydrofoil strut 138 are long enough to lift the hull 102 at least five feet above the surface of the water during hydrofoil-borne operation, which facilitates operation in substantially choppy waters. Struts of other lengths may be used as well. For instance, in some examples, longer struts that allow for better wave-isolation of the hull 102 (but at the expense of the stability of the craft 100 and increasing complexity of the retraction system) are utilized.

In practice, hydrofoils have a limited top speed before cavitation occurs, which results in vapor bubbles forming and imploding on the surface of the hydrofoil. Cavitation not only may cause damage to a hydrofoil but also significantly reduces the amount of lift generated by the hydrofoil and increases drag. Therefore, it is desirable to reduce the onset of cavitation by designing the main hydrofoil 130 and the rear hydrofoil 136 in a way that allows the hydrofoils to operate at higher speeds (e.g., ˜20-45 mph) and across the entire required hydrofoil-borne speed envelope before cavitation occurs. For instance, in some examples, the onset of cavitation is controlled based on the geometric design of the main hydrofoil 130 and the rear hydrofoil 136. Additionally, in some examples, the structural design of the main hydrofoil 130 and the rear hydrofoil 136 is configured to allow the surfaces of the hydrofoils to flex and twist at higher speeds, which may reduce loading on the hydrofoils and delay the onset of cavitation.

Further, in some examples, the distributed blown-wing propulsion system described above further facilitates the delay of onset of cavitation on the main hydrofoil 130 and the rear hydrofoil 136. Cavitation is caused by both (i) the amount of lift generated by a hydrofoil and (ii) the profile of the hydrofoil (which is affected by both the hydrofoil's angle of attack and its vertical thickness) as it moves through water. Reducing the amount of lift generated by the hydrofoil delays the onset of cavitation. Because the blown-wing propulsion system creates additional lift on the main wing 104, the amount of lift exerted on the main hydrofoil 130 and the rear hydrofoil 136 to lift the hull 102 out of the water is reduced. Further, because the main hydrofoil 130 and the rear hydrofoil 136 do not need to generate as much lift to raise the hull 102 out of the water, their angles of attack may be reduced as well, which further delays the onset of cavitation. In some examples, combining the blown-wing propulsion system with the hydrofoil designs described herein facilitates operating the craft 100 in a hydrofoil-borne mode at speeds above 35 knots before cavitation occurs.

As noted above, some examples of the main hydrofoil assembly 108 and the rear hydrofoil assembly 110 include one or more main and rear hydrofoil control surfaces 134, 140, respectively. Some examples of the main hydrofoil control surfaces 134 include one or more hinged surfaces on a trailing or leading edge of the main hydrofoil 130 as well as one or more actuators which are operated by the control system of the craft 100 to rotate the hinged surfaces so that they extend above or below the main hydrofoil 130. Some examples of the main hydrofoil control surfaces 134 on the main hydrofoil 130 are operated in a similar manner as the flaps 118 and ailerons 120 on the main wing 104 of the craft 100. In some examples, lowering the control surfaces 134 to extend below the main hydrofoil 130 changes the hydrodynamic shape of the main hydrofoil 130 in a manner that generates additional lift on the main hydrofoil 130, similar to the aerodynamic effect of lowering the flaps 118. In some examples, asymmetrically raising one or more of the control surfaces 134 (e.g., raising a control surface 134 on only one side of the main hydrofoil 130) changes the hydrodynamic shape of the main hydrofoil 130 in a manner that generates a roll force on the main hydrofoil 130, similar to the aerodynamic effect of raising one of the ailerons 120.

Likewise, some examples of the rear hydrofoil control surfaces 140 include one or more hinged surfaces on a trailing or leading edge of the rear hydrofoil 136 as well as one or more actuators, which are operated by the control system of the craft 100 to rotate the hinged surfaces so that they extend above or below the rear hydrofoil 136. In some examples, the rear hydrofoil control surfaces 140 on the rear hydrofoil 136 are operated in a similar manner as the elevators 126 on the tail 106 of the craft 100. In some examples, lowering the control surfaces 140 to extend below the rear hydrofoil 136 changes the hydrodynamic shape of the rear hydrofoil 136 in a manner that causes the craft 100 to pitch downwards, similar to the aerodynamic effect of lowering the elevators 126. In some examples, raising the control surfaces 140 to extend above the rear hydrofoil 136 changes a hydrodynamic shape of the rear hydrofoil 136 in a manner that causes the craft 100 to pitch upwards, similar to the aerodynamic effect of raising the elevators 126.

In some examples, one or both of the main hydrofoil control surfaces 134 or the rear hydrofoil control surfaces 140 include rudder-like control surfaces similar to the rudder 128 on the tail 106 of the craft 100. For instance, some examples of the main hydrofoil control surfaces 134 include one or more hinged surfaces on a trailing edge of the main hydrofoil strut 132 as well as one or more actuators, which are operated by the control system of the craft 100 to rotate the hinged surfaces so that they extend to the left or right of the main hydrofoil strut 132. Similarly, some examples of the rear hydrofoil control surfaces 140 include one or more hinged surfaces on a trailing edge of the rear hydrofoil strut 138 as well as one or more actuators, which are operated by the control system of the craft 100 in order to rotate the hinged surfaces so that they extend to the left or right of the rear hydrofoil strut 138. In some examples, actuating the main hydrofoil control surfaces 134 or the rear hydrofoil control surfaces 140 in this manner changes the hydrodynamic shape of the main hydrofoil strut 132 or the rear hydrofoil strut 138, respectively, which facilitates controlling the yaw of the craft 100 when operating in a waterborne or hydrofoil-borne mode, similar to the effect of actuating the rudder 128 of the craft 100, as described above.

In some examples, instead of (or in addition to) actuating hinged control surfaces on the main hydrofoil 130 and/or the rear hydrofoil 136, a control system of the craft 100 actuates the entire main hydrofoil 130 and/or the entire rear hydrofoil 136 themselves. In some examples, the craft 100 includes one or more actuators for rotating the main hydrofoil 130 and/or the rear hydrofoil 136 around the yaw axis. In some examples, the craft 100 includes one or more actuators for controlling the angle of attack of the main hydrofoil 130 and/or the rear hydrofoil 136 (i.e., rotating the main hydrofoil 130 and/or the rear hydrofoil 136 around the pitch axis). Some examples of the craft 100 include one or more actuators for rotating the main hydrofoil 130 and/or the rear hydrofoil 136 around the roll axis. Some examples of the craft 100 include one or more actuators for changing a camber or shape of the main hydrofoil 130 and/or the rear hydrofoil 136. Some examples of the craft 100 include one or more actuators for flapping the main hydrofoil 130 and/or the rear hydrofoil 136 to help propel the craft 100 forward or backward. Other examples are possible as well.

Further, some examples of the craft 100 dynamically control an extent to which the main hydrofoil 130 and/or the rear hydrofoil 136 are deployed based on an operational mode (e.g., hull-borne, hydrofoil-borne, or wing-borne modes) of the craft 100. For instance, in some examples, during hull-borne mode, the rear hydrofoil assembly 110 is partially deployed or retracted to increase turning authority. The amount of partial deployment or retraction may be a function of the desired overall vehicle draft when operating in a shallow water environment. In some examples, during hydrofoil-borne mode, the main hydrofoil assembly 108 is partially retracted to reduce the distance between the hull of the vehicle and the water's surface. This increases the amount of lift generated by the main wing 104 by operating the wing closer to the surface of the water, increasing the effects of the aerodynamic ground effect.

As noted above, some examples of the main hydrofoil assembly 108 and rear hydrofoil assembly 110 interface with a deployment system that facilitates retracting the respective hydrofoil assemblies 108, 110 into or toward the hull 102 for hull-borne or wing-borne operation and for extending the respective hydrofoil assemblies 108, 110 below the hull 102 for hydrofoil-borne operation. As described further below, in some embodiments, the deployment system is used in connection with extending, retracting, and/or otherwise controlling the positioning of the hydrofoil assemblies 108, 110 during takeoff when the craft is transitioning from hydrofoil-borne operation to wing-borne operation.

### E. Hydrofoil Deployment Systems

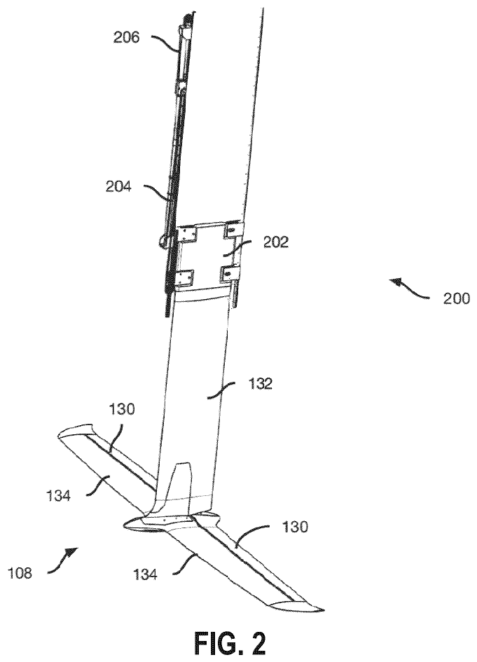

FIG. 2 illustrates an example of a main hydrofoil deployment system 200 that facilitates retracting and extending of the main hydrofoil assembly 108. As shown, some examples of the main hydrofoil deployment system 200 take the form of a linear actuator that includes one or more brackets 202 that couple the main hydrofoil assembly 108 (by way of the main hydrofoil strut 132) to one or more vertical tracks 204. Some examples of the brackets 202 are configured to move vertically along the tracks 204, such that when the brackets 202 move vertically along the tracks 204, the main hydrofoil assembly 108 likewise moves vertically. Some examples of the brackets 202 are coupled to a leadscrew 206 that, when rotated, causes vertical movement of the brackets 202. Some examples of the leadscrew 206 are rotatable by any of various sources of torque, such as an electric motor coupled to the leadscrew 206 by a gear assembly 208.

Some examples of the main hydrofoil deployment system 200 further include one or more sensors 210 configured to detect a vertical position of the main hydrofoil assembly 108. For example, a first sensor senses when the main hydrofoil assembly 108 has reached a fully retracted position and a second sensor senses when the main hydrofoil assembly 108 has reached a fully extended position. However, the main hydrofoil deployment system 200 may include additional sensors for detecting additional discrete positions or continuous positions of the main hydrofoil assembly 108. Some examples of the sensors are included as part of, or otherwise configured to communicate with, the control system of the craft 100 to provide the control system with data that indicates the position of the main hydrofoil assembly 108. Some examples of the control system use this data to determine whether to operate the electric motor to retract or extend the main hydrofoil assembly 108.

In some examples, such as examples where the linear actuator is not a self-locking linear actuator, the main hydrofoil deployment system 200 includes a locking or braking mechanism for holding the main hydrofoil strut 132 in a fixed position (e.g., in a fully retracted or fully extended position). An example of the locking mechanism corresponded to a dual-action mechanical brake that is coupled to the electric motor, the leadscrew 206, or the gear assembly.

While the above description provides various details of an example main hydrofoil deployment system 200, it should be understood that the main hydrofoil deployment system 200 illustrated in FIG. 2 is for illustrative purposes and is not meant to be limiting. For instance, the main hydrofoil deployment system 200 may include any of various linear actuators now known or later developed that are capable of retracting and extending the main hydrofoil assembly 108.

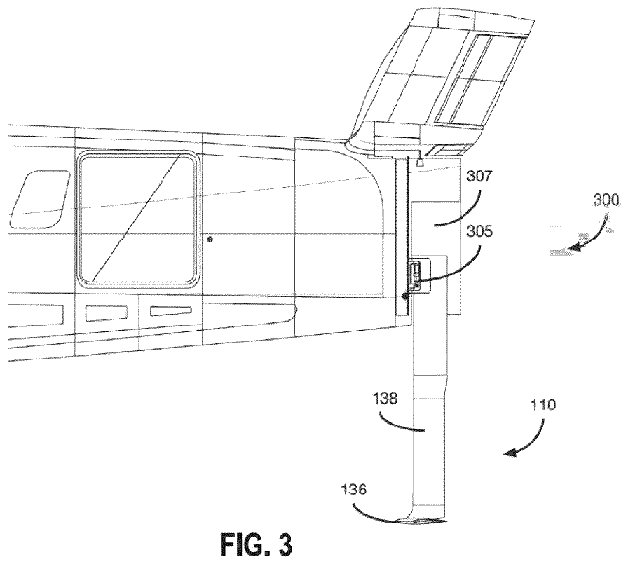

FIG. 3 illustrates an example of a rear hydrofoil deployment system 300 that facilitates retracting and extending the rear hydrofoil 136. As shown, some examples of the rear hydrofoil deployment system 300 include an actuator 305 to the rear hydrofoil strut 138. When actuated, the actuator 305 causes the rear hydrofoil strut 138 to raise or lower by causing the rear hydrofoil strut 138 to slide vertically along a shaft 307. While not illustrated in FIG. 3, in some examples, the rudder 128 is mounted to the shaft 307 such that, when the actuator 305 raises the rear hydrofoil strut 138, the rear hydrofoil strut 138 retracts at least partially into the rudder 128. Additionally, some examples of the rear hydrofoil deployment system 300 include one or more servo motors configured to rotate the rear hydrofoil strut 138 around the shaft. In this respect, in some examples, the rear hydrofoil strut 138 is rotated around the shaft to act as a hydro-rudder when submerged in water or to act as an aero-rudder when out of the water. Further, because the rudder 128 is mounted to the same shaft 307 as the rear hydrofoil strut 138 and the rear hydrofoil strut 138 can be retracted into the rudder 128, the same servo motor can also be used to control the rotation of the rudder 128.

The actuator 305 of the rear hydrofoil deployment system 300 may take various forms and may, for instance, include any of various linear actuators now known or later developed that are capable of retracting and extending the rear hydrofoil assembly 110. Further, in some examples, the actuator 305 has a non-unitary actuation ratio such that a given movement of the actuator 305 causes a larger corresponding induced movement of the rear hydrofoil assembly 110. This can help allow for faster retractions of the rear hydrofoil assembly 110, which may be beneficial during takeoff, as described in further detail below.

Some examples of the main hydrofoil assembly 108 and/or the rear hydrofoil assembly 110 are configured such that, when fully retracted, the hydrofoil assembly is flush, conformal, or tangent to the hull 102. For instance, some examples of the hull 102 include one or more recesses configured to receive the main hydrofoil assembly 108 and/or the rear hydrofoil assembly 110. In this regard, some examples of the main hydrofoil assembly 108 and/or the rear hydrofoil assembly 110 have a shape such that when the main hydrofoil assembly 108 and/or the rear hydrofoil assembly 110 are fully retracted into the recesses of the hull 102, the outer contour of the hull 102 forms a substantially smooth transition at the intersection of the hull 102 and the main hydrofoil assembly 108 and/or the rear hydrofoil assembly 110.

Other examples of the main hydrofoil assembly 108 and/or the rear hydrofoil protrude slightly below the hull 102 when retracted. These examples of the main hydrofoil assembly 108 and/or the rear hydrofoil assembly 110 are configured to have a non-negligible effect on the aerodynamics of the craft 100. Some examples of the craft 100 are configured to leverage these effects to provide additional control of the craft 100. For instance, in some examples, when the main hydrofoil assembly 108 and/or the rear hydrofoil assembly 110 are retracted but still exposed, the exposed hydrofoil is manipulated in flight to impart forces and moments on the craft 100 similar to an aero-control surface.

Some examples of the hydrofoil assemblies 108, 110 disclosed herein are mounted on a pivot that is locked underwater but is unlocked to allow the hydrofoil to move around the pivot in the air. At that point, the control surfaces act like trim tabs and are able to effect movement of the entire unlocked, pivoting hydrofoil, which would otherwise require impractically large and heavy servo motors. This configuration facilitates unlocking and moving of the hydrofoil using a slow servo and/or a combination of control surface movement combined with forward movement through water, and then re-locked such that the hydrofoil is at a selected angle of incidence.

As noted above, some examples of the main hydrofoil assembly 108 are configured to be retractable. Some examples of the hull 102 include openings through which the strut 132 of the main hydrofoil assembly 108 are retracted and extended. Some examples of the hull 102 are configured to isolate water that enters through these openings (e.g., when the hull 102 contacts the water surface) and to allow for the water to drain from the hull 102 after the hull 102 is lifted out of the water. For instance, some examples of the hull 102 include pockets 142 on each side of the hull 102 aligned above the strut 132. Some examples of the pockets 142 are isolated from the remainder of the interior of the hull 102 so that water that accumulates in the pockets 142 does not reach any undesired areas (e.g., the cockpit, passenger seating area, areas that house the battery system 400, components of the control system of the craft 100, etc.). Further, some examples of the pockets 142 include venting holes or other openings located at or near the bottom of the pockets 142. The venting openings are configured to allow water that enters the pockets 142 to vent out of the pockets 142 when the hull 102 is lifted out of the water.

Some examples of the main hydrofoil assembly 108 and/or the rear hydrofoil assembly 110 include one or more propellers for additional propulsion when submerged underwater. For instance, in some examples, one or more propellers are mounted to the main hydrofoil 130 and/or the rear hydrofoil 136. In some examples, the propellers are configured to provide additional propulsion force to the craft 100 during hydrofoil-borne or hull-borne operation.

In some examples, propellers are mounted to the hull 102. The propellers are submerged during hull-borne operation. In some examples, the propellers are configured to provide additional propulsion force to the craft 100 during hull-borne operation.

Some examples of the main and/or rear hydrofoil assemblies 108, 110 include various failsafe mechanisms in case of malfunction. For instance, in some examples, when one or both of the main and rear hydrofoil deployment systems 200, 300 cannot be retracted due to a malfunction, the craft 100 is configured to jettison the malfunctioning assembly. In this regard, some examples of the main and/or rear hydrofoil assemblies 108, 110 are coupled to the hull 102 by a releasable latch. Some examples of the control system of the craft 100 are configured to identify a retraction malfunction (e.g., based on data received from the positional sensors 210) and responsively open the latch to release the connection between the hull 102 and the malfunctioning hydrofoil assembly. In some examples, the weight of the malfunctioning hydrofoil assembly is sufficient to jettison the malfunctioning hydrofoil assembly out of the hull 102 when the latch is opened. Some examples of the craft 100 include an actuator or some other mechanism to jettison the malfunctioning hydrofoil assembly out of the hull 102. In some examples, the main and/or rear hydrofoil assemblies 108, 110 are configured to break in a controlled manner upon impact with water. For instance, in some examples, a joint between the main hydrofoil strut 132 and the hull 102 and/or a joint between the rear hydrofoil strut 138 and the hull 102 is configured to disconnect when subjected to a torque significantly larger than standard operational torques at the joints. Other designs for providing controlled breaks are possible as well.

### F. Battery System

FIG. 4 illustrates an example of an onboard battery system. In some examples, the battery system 400 is arranged in a protected area 402 of the hull 102 below a passenger seating area 404. Some examples of the battery system 400 are separated from the passenger seating area 404 by a firewall 406 to protect the passengers from harm if a thermal runaway occurs. In this regard, some examples of the craft 100 include a battery management system comprising voltage, current, and/or thermal sensors for detecting thermal runaway or some other fire detection system for detecting a fire in the protected area 402.

Some examples of the craft 100 include one or more mechanisms for flooding the battery system 400 (e.g., with an inert gas fire, with water, etc.) upon detecting a thermal runaway or a fire in the protected area 402. For instance, some examples of the hull 102 comprise one or more valves or other controllable openings. The control system of the craft 100 is configured to open the valves and/or controllable openings upon detecting a fire in the protected area 402 or thermal runaway in the battery system 400 to allow water to enter the protected area 402 and to extinguish or prevent a fire in the protected area 402.

In some examples, the battery system 400 is configured to be jettisoned through one or more of the controllable openings in the hull 102 described above. In this regard, in some examples, the weight of the battery system 400 is sufficient to jettison the battery system 400 out of the hull 102 when the hull 102 is opened. In some examples, the craft 100 comprises an actuator or the like configured to jettison the battery system 400 out of the hull 102.

In other examples, the craft 100 may take measures to become waterborne in response to detecting a fire in the protected area 402 or thermal runaway in the battery system 400. Some examples of the control system of the craft 100 determine a fire suppression operation to perform based on the operational state of the craft 100 (e.g., operating in hull-borne, hydrofoil-borne, or wing-borne mode). For instance, when operating in hull-borne mode and upon detecting a thermal runaway or a fire in the protected area 402, some examples of the control system are configured to flood the battery system 400 as described above. When operating in hydrofoil-borne or a wing-borne mode, the control system is configured to cause the craft 100 to transition to hull-borne mode upon detecting a thermal runaway or a fire in the protected area 402 and then flood the battery system 400.

### G. Control System

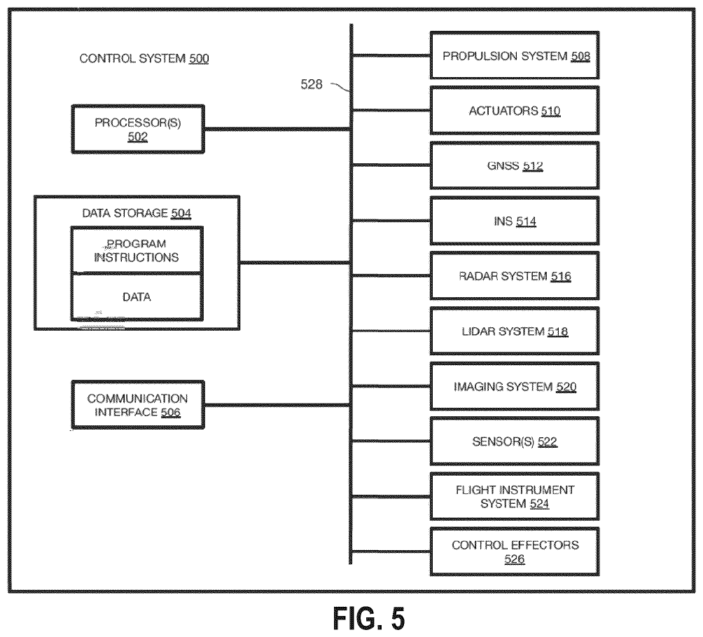

FIG. 5 illustrates an example of a control system 500 of the craft 100. As shown, some examples of control system 500 include one or more processors 502, data storage 504, a communication interface 506, a propulsion system 508, actuators 510, a Global Navigation Satellite System (GNSS) 512, an inertial navigation system (INS) 514, a radar system 516, a lidar system 518, an imaging system 520, various sensors 522, a flight instrument system 524, and flight controls 526. In some examples, some or all of these components communicate with one another via one or more communication links 528 (e.g., a system bus, a public, private, or hybrid cloud communication network, etc.)

Some examples of processors 502 correspond to or comprise general-purpose processors (e.g., a single- or multi-core microprocessor), special-purpose processors (e.g., an application-specific integrated circuit or digital-signal processor), programmable logic devices (e.g., a field-programmable gate array), controllers (e.g., microcontrollers), and/or any other processor components now known or later developed. Further, while the one or more processors 502 are illustrated as a separate stand-alone component of the control system 500, it should also be understood that the one or more processors 502 could comprise processing components that are distributed across one or more of the other components of the control system 500.

Some examples of the data storage 504 comprise one or more non-transitory computer-readable storage mediums that are collectively configured to store (i) program instructions executable by the one or more processors 502 such that the control system 500 is configured to perform some or all of the functions disclosed herein, and (ii) data that may be received, derived, or otherwise stored, for example, in one or more databases, file systems, or the like, by the control system 500 in connection with the functions disclosed herein. In this respect, the one or more non-transitory computer-readable storage mediums of data storage 504 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. Further, while the data storage 504 is illustrated as a separate stand-alone component of the control system 500, it should also be understood that the data storage 504 may comprise computer-readable storage mediums that are distributed across one or more of the other components of the control system 500.

Some examples of the communication interface 506 include one or more wireless interfaces and/or one or more wireline interfaces, which allow the control system 500 to communicate via one or more networks. Some example wireless interfaces provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Some example wireline interfaces include an Ethernet interface, a Universal Serial Bus (USB) interface, CAN Bus, RS-485, or similar interface to communicate via a wire, a twisted pair of wires, a coaxial cable, an optical link, a fiber-optic link, or other physical connection to a wireline network.

Some examples of the propulsion system 508 include one or more electronic speed controllers (ESCs) for controlling the electric motor propeller assemblies 116 distributed across the main wing 104 and, in some examples, across the horizontal stabilizer 124. Some examples of the propulsion system 508 include a separate ESC for each respective propeller assembly 116, such that the control system 500 individually controls the rotational speeds of the electric motor propeller assemblies 116.

Some examples of the actuators 510 include any of the actuators described herein, including (i) actuators for raising and lowering the flaps 118, ailerons 120, elevators 126, main hydrofoil control surfaces 134, and rear hydrofoil control surfaces 140, (ii) actuators for turning the rudder 128, the main hydrofoil control surfaces 134 positioned on the main hydrofoil strut 132, and the rear hydrofoil control surfaces 140 positioned on the rear hydrofoil strut 138, (iii) actuators for retracting and extending the main hydrofoil assembly 108 and the rear hydrofoil assembly 110, and/or (iv) actuators for performing the various other disclosed actuations of the main hydrofoil assembly 108 and the rear hydrofoil assembly 110. Each of the actuators described herein may include any actuators now known or later developed capable of performing the disclosed actuation. Some examples of the actuators correspond to linear actuators, rotary actuators, hydraulic actuators, pneumatic actuators, electric actuators, electro-hydraulic actuators, and mechanical actuators. Some examples of the actuators correspond to electric motors, stepper motors, and hydraulic cylinders. Other examples are contemplated herein as well.

Some examples of the GNSS system 512 are configured to provide a measurement of the location, speed, altitude, and heading of the craft 100. The GNSS system 512 includes one or more radio antennas paired with signal processing equipment. Data from the GNSS system 512 may allow the control system 500 to estimate the position and speed of the craft 100 in a global reference frame, which can be used for route planning, operational envelope protection, and vehicle traffic deconfliction by both understanding where the craft 100 is located and comparing the location with known traffic.

Some examples of the INS 514 include motion sensors, such as angular and/or linear accelerometers, and rotational sensors, such as gyroscopes, to calculate the position, orientation, and speed of the craft 100 using dead reckoning techniques. In some examples, one or more of these components are used by the control system to calculate actuator outputs to stabilize or otherwise control the vehicle during all modes of operation.

Some examples of the radar system 516 include a transmitter and a receiver. The transmitter may transmit radio waves via a transmitting antenna. The radio waves reflect off an object and return to the receiver. The receiver receives the reflected radio waves via a receiving antenna, which may be the same antenna as the transmitting antenna, and the radar system 516 processes the received radio waves to determine information about the object's location and speed relative to the craft 100. This radar system 516 may be utilized to detect, for example, the water surface, maritime or wing-borne vehicle traffic, wildlife, or weather.

Some examples of the lidar system 518 comprise a light source and an optical receiver. The light source emits a laser that reflects off an object and returns to the optical receiver. The lidar system 518 measures the time for the reflected light to return to the receiver to determine the distance between the craft 100 and the object. This lidar system 518 may be utilized by the flight control system to measure the distance from the craft 100 to the surface of the water in various spatial measurements.

Some examples of the imaging system 520 include one or more still and/or video cameras configured to capture image data from the environment of the craft 100. Some examples of the cameras correspond to or comprise charge-coupled device (CCD) cameras, complementary metal-oxide-semiconductor (CMOS) cameras, short-wave infrared (SWIR) cameras, mid-wave infrared (MWIR) cameras, or long-wave infrared (LWIR) cameras. Some examples of the imaging system 520 are configured to perform obstacle avoidance, localization techniques, water surface tracking for more accurate navigation (e.g., by applying optical flow techniques to images), video feedback, and/or image recognition and processing among other possibilities.

As noted above, some examples of the control system 500 include various other sensors 522 for use in controlling the craft 100. Examples of such sensors 522 correspond to or comprise thermal sensors or other fire detection sensors for detecting a fire in the hull 102 or for detecting thermal runaway in the battery system 400. As further described above, the sensors 522 may include position sensors for sensing the position of the main hydrofoil assembly 108 and/or the rear hydrofoil assembly 110 (e.g., sensing whether the assemblies are in a retracted or extended position). Examples of position sensors may include photodiode sensors, capacitive displacement sensors, eddy-current sensors, Hall effect sensors, inductive sensors, or any other position sensors now known or later developed.

Some examples of the sensors 522 facilitate determining the altitude of the craft 100. For instance, some examples of the sensor 522 include an ultrasonic altimeter configured to emit and receive ultrasonic waves. The emitted ultrasonic waves reflect off the water surface below the craft 100 and return to the altimeter. The ultrasonic altimeter measures the time for the reflected ultrasonic wave to return to the altimeter to determine the distance between the craft 100 and the water surface. Some examples of the sensor 522 include a barometer for use as a pressure altimeter. The barometer measures the atmospheric pressure in the environment of the craft 100 and determines the altitude of the craft 100 based on the measured pressure. Some examples of the sensor 522 include a radar altimeter to emit and receive radio waves. The radar altimeter measures the time for the radio wave to reflect off of the surface of the water below the craft 100 to determine a distance between the craft 100 and the water surface. In some examples, these sensors are placed in different locations on the craft 100 to reduce the impact of sensor constraints, such as sensor deadband or sensitivity to splashing water.

Some examples of the control system 500 are configured to use one or more of the sensors 522 or other components of the control system 500 to help navigate the craft 100 through maritime traffic or to avoid any other type of obstacle. For example, some examples of the control system 500 determine the position, orientation, and speed of the craft 100 based on data from the INS 514 and/or the GNSS 512, and the control system 500 may determine the location of an obstacle, such as a maritime vessel, a dock, or various other obstacles, based on data from the radar system 516, the lidar system 518, and/or the imaging system 520. Some examples of the control system 500 determine the location of an obstacle using the Automatic Identification System (AIS). Some examples of the control system 500 are configured to maneuver the craft 100 to avoid collision with an obstacle based on the determined position, orientation, and speed of the craft 100 and the determined location of the obstacle by actuating various control surfaces of the craft 100 in any of the manners described herein.

Some examples of the flight instrument system 524 include instruments for providing data about the altitude, speed, heading, orientation (e.g., yaw, pitch, and roll), battery levels, or any other information provided by the various other components of the control system 500.

Some examples of the flight controls 526 include one or more joysticks, thrust control levers, buttons, switches, dials, levers, or touch screen displays, etc. In operation, a pilot may use the flight controls 526 to operate one or more control surfaces (e.g., flaps, ailerons, elevators, rudder, propulsion propellers, etc.) of the craft 100 to thereby maneuver the craft 100 (e.g., control the direction, speed, altitude, etc., of the craft 100).

In some examples, the combinations of control surfaces on the craft 100 used by the control system 500 to control operations of the craft 100 depends on the mode of operation of the craft 100 and is determined based at least in part on aspects such as vehicle position, speed, attitude, acceleration, rotational rates, and/or altitude above water. Table 1 summarizes an example of the relationship between the control surfaces and the operation mode.

TABLE 1

| Control Surface | Hull-borne | Foil-borne | Wing-borne |
|---|---|---|---|
| Propulsion | Y | Y | Y |
| Aerodynamic | N | Y | Y |
| Elevator | | | |
| Aerodynamic | N | Y | Y |
| Ailerons | | | |
| Aerodynamic Rudder | Y | Y | Y |
| Aerodynamic Flaps | N | Y | Y |
| Hydrodynamic | Y | Y | N |
| Elevator | | | |
| Hydrodynamic Flaps | Y | Y | N |
| Hydrodynamic | Y | Y | N |
| Rudder | | | |

In some examples, the propulsion control surfaces in the table include the propeller assembly 116, as well as any propellers mounted to the hull 102, main hydrofoil assembly 108, or rear hydrofoil assembly 110. In some examples, the aerodynamic elevator control surfaces include elevator 126, the aerodynamic ailerons include ailerons 120, the aerodynamic rudder includes rudder 128 (when not submerged), the aerodynamic flaps include flaps 118, the hydrodynamic elevator includes rear hydrofoil control surfaces 140, the hydrodynamic flaps include main hydrofoil control surfaces 134, and the hydrodynamic rudder includes rudder 128 (when submerged).

In some examples, when actuating the control surfaces in the various examples, operational modes identified in Table 1 above, the control system 500 executes different levels of stabilization along the various vehicle axes during different modes of operation. Table 2 below identifies examples of stabilization controls that the control system 500 applies during the various modes of operation for each axis of the craft 100. Closed-loop control may comprise feedback and/or feed-forward control.

TABLE 2

| Vehicle | | | |
|---|---|---|---|
| Axis | Hull-borne | Foil-borne | Wing-borne |
| Pitch | None | Closed-loop control on | Closed-loop control |
| Axis | | vehicle ride height | on vehicle altitude |
| Roll | None | Closed-loop control | Stabilization and |
| Axis | | around vehicle bank | closed-loop control |
| | | angle = 0 | on heading |
| Yaw Axis | Rate | Closed-loop control on | Closed-loop control |
| | stabilization | vehicle heading | on vehicle heading |
| Speed | Closed-loop | Closed-loop control on | Closed-loop control |
| Control | control on | vehicle GPS Speed | on vehicle airspeed |
| | vehicle GPS | | |
| | Speed | | |

Further, in some examples, the control system 500 is configured to actuate different control surfaces to control the movement of the craft 100 about its different axes. Table 3 below identifies example axial motions that are affected by the various control surfaces of the craft 100.

TABLE 3

| Control | |
|---|---|
| Surface | Axis Control Function |
| Propulsion | (a) accelerate and decelerate the vehicle |
| | (b) turn the vehicle about yaw axis |
| | (c) create a rolling moment |
| Aerodynamic | (a) create a pitch up or pitch down moment |
| Elevator | |
| Aerodynamic | (a) create a rolling moment |
| Ailerons | (b) increase lift on aerodynamic wing |
| | (c) create a pitch-down moment |
| Aerodynamic | (a) create a yawing moment |
| Rudder | |
| Aerodynamic | (a) increase lift on aerodynamic wing |
| Flaps | (b) create a pitch-down moment |
| Hydrodynamic | (a) create a pitch moment |
| Elevator | (b) generate heave force on rear hydrofoil |
| Hydrodynamic | (a) generate heave force on main hydrofoil |
| Flaps | |
| Hydrodynamic | (a) create a yaw moment |
| Rudder | |

### III. EXAMPLE MODES OF OPERATION

### A. Maneuver-Borne Operation

In one embodiment, the craft 100 starts in a maneuver mode, which may sometimes be referred to herein as a standby or default mode. During this mode, the craft 100 can be docked and floating on the hull 102, with the buoyancy of the outriggers 114 providing for roll stabilization of the craft 100. While docked, the battery system 400 of the craft 100 may be charged. In some examples, rapid charging is aided by an open or closed-loop water-based cooling system. In some examples, the surrounding body of water is used in the loop or as a heat sink. In some examples, the craft 100 includes a heat sink integrated into the hull 102 for exchanging heat from the battery system 400 to the surrounding body of water. In other examples, the heat sink is located offboard in order to reduce the mass of the craft 100.

Additionally, in some examples, in maneuver mode, the propeller assemblies 116 are folded in a direction away from the dock while the craft 100 is docked to help avoid collision with nearby structures or people. This folding may be actuated in various ways, such as by metal spring force, hydraulic pressure, electromechanical actuation, or centrifugal force due to propeller rotation. Other examples are possible as well. Further, in some examples, the main hydrofoil assembly 108 and the rear hydrofoil assembly 110 are retracted (or partially retracted) to avoid collisions with nearby underwater structures.

### B. Hull-Borne Operation

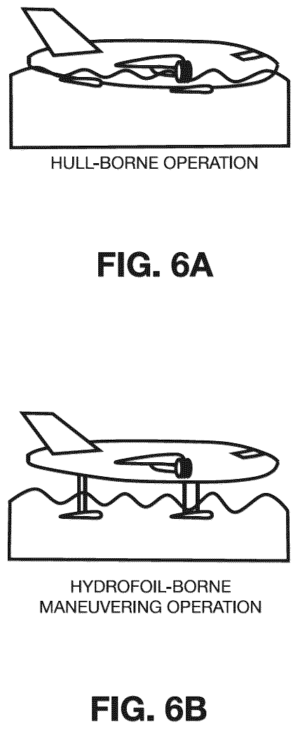

When the craft 100 is ready to depart, the craft 100 enter a hull-borne mode (see FIG. 6A). In this mode, the craft 100 uses its propulsion systems, including the propeller assemblies 116 and/or the underwater propulsion system (e.g., one or more propellers mounted to the hull 102, the main hydrofoil 130, and/or the rear hydrofoil 136), to maneuver away from the dock while remaining hull-borne. In some examples, the main hydrofoil assembly 108 and the rear hydrofoil assembly 110 remain retracted (or partially retracted) during this maneuvering to reduce the risk of hitting underwater obstacles near docks or in shallow waterways. However, when there is a limited risk of hitting underwater obstacles, the craft 100 may partially or fully extend the main hydrofoil assembly 108 and/or the rear hydrofoil assembly 110. With the main hydrofoil assembly 108 and/or the rear hydrofoil assembly 110 extended, the craft 100 actuates the main hydrofoil control surfaces 134 and/or the rear hydrofoil control surfaces 140 to improve maneuverability as described above.

In some examples, at low speeds during hull-borne operation, the control system 500 controls the position and/or rotation of the craft 100 by causing all of the propeller assemblies 116 to spin at the same idle speed, but with a first subset spinning in a forward direction and a second subset spinning in a reverse direction. For instance, in some examples, the control system 500 causes propeller assemblies 116a, 116c, 116e, 116h, 116j, and 1161 to idle in reverse and propeller assemblies 116b, 116d, 116f, 116g, 116i, and 1161 to idle forward. In this arrangement, the control system 500 causes the craft 100 to make various maneuvers without having to change the direction of rotation of any of the propeller assemblies 116. For instance, to induce a yaw on the craft 100, in some examples, the control system 500 increases the speed of the reverse propeller assemblies on one side of the main wing 104 while increasing the speed of the forward propeller assemblies on the other side of the main wing 104 and without causing any of the propeller assemblies to transition from forward to reverse or from reverse to forward. For example, idling the propellers at a nominal RPM may allow for a faster response in generating a yaw moment on the craft 100 because the propellers required for generating the yaw moment do not have to increase from zero RPM to the desired RPM value. They can spin from the idle RPM to the desired RPM value.

### C. Foil-Borne Maneuvering Operation

FIG. 6B illustrates an example of the craft 100 when the craft 100 is operating in hydrofoil-borne maneuvering mode. During this mode, the craft 100 is configured to, for example, move through harbors and crowded waterways at speeds generally between 20-45 mph. In this regard, the craft 100 may extend the main hydrofoil assembly 108 and the rear hydrofoil assembly 110 (if not already extended) and accelerate using the previously described propulsion system towards a desired takeoff speed. During acceleration, the craft 100 reaches a speed at which the main hydrofoil assembly 108 and the rear hydrofoil assembly 110 alone support the weight of the craft 100, and the hull 102 is lifted above the surface of the water (e.g., by 3-5 ft) so that the hull is clear of any surface waves. After the hull 102 leaves the surface of the water, the drag forces exerted on the craft 100 drop significantly, and the amount of thrust required to maintain acceleration can be reduced. Therefore, in some examples, after the hull 102 has left the water, the control system 500 reduces the speed of the propeller assemblies 116 to lower the thrust of the craft 100.

Some examples of the control system 500 sustain this operational mode by actively controlling the pitch and speed of the craft 100 so that the main hydrofoil assembly 108 and the rear hydrofoil assembly 110 continue to entirely support the weight of the craft 100. In this regard, some examples of the control system 500 actuate the main hydrofoil control surfaces 134 and/or the rear hydrofoil control surfaces 140 and/or the propulsion system to stabilize the attitude of the craft 100 to maintain the desired height above the surface of the water, vehicle heading, and vehicle forward speed. In this regard, some examples of the control system 500 are configured to detect various changes in the yaw, pitch, or roll of the craft 100 based on data provided by the INS 514 and to make calculated actuations of the main hydrofoil control surfaces 134 and/or the rear hydrofoil control surfaces 140 to counteract the detected changes.

### D. Foil-Borne Takeoff Operation

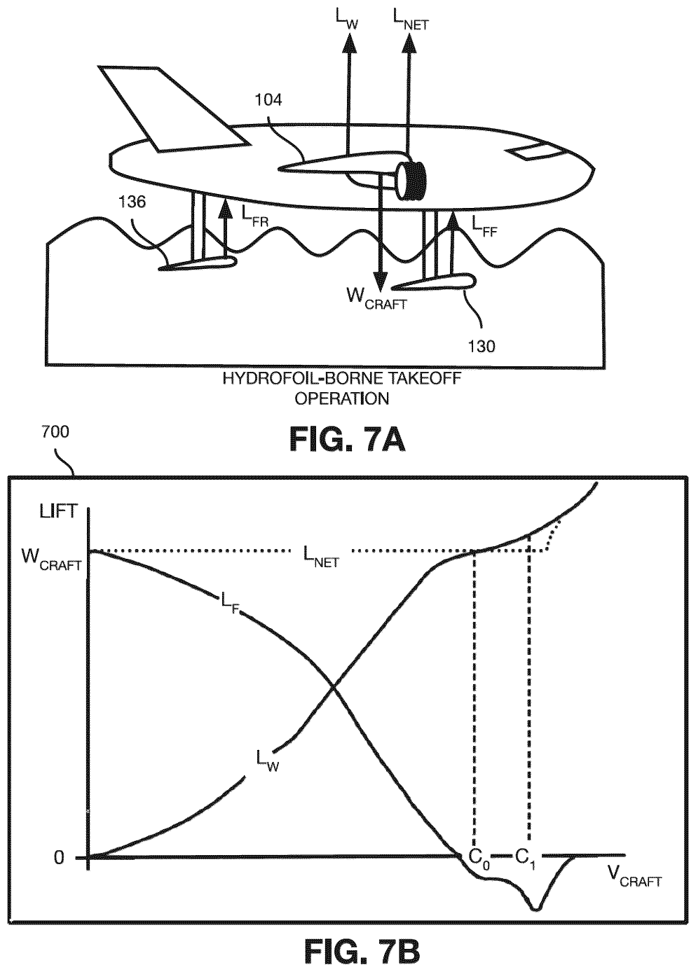

FIG. 7A illustrates an example of the craft 100 when the craft 100 is operating in hydrofoil-borne takeoff mode. During this mode, the craft 100 is configured to, for example, move through open waters and obtain speeds generally between 40-50 mph to facilitate generating the lift required to become wing-borne.

Referring to FIG. 7A, aerodynamic lift, L_{W}, generally represents the lift generated by the main wing 104 of the craft 100 but can also include the lift generated by other surfaces such as the tail wing, hull, or propulsive devices such as propellers, rotors, jets, etc. L_{F} generally corresponds to the lift generated by one or more hydrofoils 130, 136 of the craft 100, where L_{FF} corresponds to the lift generated by the front foil and the L_{FR} corresponds to the lift generated by the rear foil. W_{CRAFT} corresponds to the force of gravity exerted on the craft 100 and is also referred to as the weight of the craft. During steady state operation, W_{CRAFT} generally corresponds to L_{W}+L_{FR}+L_{FF} which also corresponds to L_{NET}. Throughout the description, the term L_{F} is generally understood to correspond to L_{FR}+L_{FF}.

As previously noted, some experimental craft developed by Applicant that include aerodynamic foils were unable to achieve the lift required to sustain flight. In these experimental craft, in an attempt to become airborne, the craft 100 would ramp up to a speed at which point the hydrofoil would breach the surface of the water, as W_{CRAFT}<L_{W}+L_{F}, and L_{F}>0, resulting in L_{W}<W_{CRAFT}. However, in order to takeoff from the water's surface, the aerodynamic lift must be greater than or equal to the weight of the craft, however prior to takeoff, the hydrofoils are still under the water's surface, and up until takeoff, have been generating lift (L_{F}>0) as the aerodynamic lift has been insufficient for takeoff up until this point. If the hydrodynamic lift and the aerodynamic lift sum to greater than the weight of the craft, the vehicle will accelerate upwards and potentially create a premature takeoff condition (prior to condition C0 in FIG. 7B) as the aerodynamic lift, L_{W}, generated by the wings, etc., of the craft 100 would be insufficient to sustain flight, and, as a result, the craft 100 would come back down and breach the water, ultimately preventing takeoff. The techniques disclosed below ameliorate these problems by controlling the hydrofoil lift vector, L_{F}, specifically by generating downward forces of one or more hydrofoils 130, 136 of the craft 100 to keep the hydrofoils 130, 136 submerged until after the upwards aerodynamic lift, L_{W}, is sufficient to allow the craft 100 to sustain flight.

In some examples, the lift L_{F} is in the downward direction, and is introduced via the hydrofoil(s) as L_{W} increases beyond W_{CRAFT} while the craft 100 is increasing in speed in anticipation of takeoff. This allows the craft 100 to generate a greater overall aerodynamic lift, L_{W}, prior to actual takeoff than would otherwise be possible. Then, at the appropriate time (e.g., when L_{W} reaches some predetermined threshold such as the weight of the craft 100 or some margin thereof), the negative lift, L_{F}, can be “released” from the craft 100, and the craft 100 can, as a result, proceed to become wing-borne.

FIG. 7B is an example of a graph 700 that relates these aspects. The relationships shown in the graph 700 and the ways in which various lift forces, thresholds, etc., are depicted are merely examples and are provided to aid understanding of the various operations and procedures described herein. As shown, the net lift, L_{NET}, on the craft 100 initially corresponds to the combination of the aerodynamic lift, L_{W}, generated by the wing (e.g., main wing, tail wing, etc.) and the lift, L_{F}, generated by the hydrofoils 130, 136 (e.g., L_{NET}=L_{W}+L_{F}). On the left side of the graph 700, the speed of the craft 100 is such that L_{NET} is sufficient to allow the craft 100 to operate in hydrofoil-borne maneuvering mode but is insufficient to allow the craft 100 to become wing-borne. Moving to the right of the graph 700 as speed increases, L_{W} increases with increased craft 100 water speed. To maintain ride height and prevent the hydrofoils 130, 136 from breaching the water surface, L_{F} is reduced in proportion to an increase in L_{W}. For example, L_{F} is adjusted with the speed of the craft 100 to maintain L_{NET} at a margin equal to the weight, W_{CRAFT}, of the craft 100, or small deviations about equal to control ride height. The overall lift provided by the hydrofoils 130, 136 may decrease at the same rate at which lift from the wing is increased towards zero or even become negative with increased speed. For example, just before the speed of the craft 100 reaches the speed associated with condition C₀, L_{F} may be reduced to zero. The conditions at C₀ (e.g., speed of the craft 100, angle of attack of craft 100, deflection angles of control surfaces, angle of incidence of hydrofoils, etc.) may be such that L_{F} may be zero or close to zero. At C₀, the aerodynamic lift, L_{W}, generated by the main wing 105 may be expected to be able to transition the craft 100 to a wing-borne mode of operation if the downwards hydrofoil lift, L_{F}, were to be removed as L_{W}=W_{CRAFT}. Accordingly, at some time and/or increased speed after this point (e.g., speed associated with condition C₁) where L_{W}>W_{CRAFT}, L_{F} may be gradually or abruptly removed/released. This, in turn, allows L_{NET} to approximately equal to or greater than W_{CRAFT} which allows the craft 100 to take off and become wing-borne.

While not shown in the graph, in some examples, L_{F} is not removed/released as described. Rather, as the craft 100 continues to accelerate, the downwards hydrofoil lift, L_{F}, increases to a maximum downwards amount (e.g., a predetermined maximum amount and/or a maximum amount achievable due to the limitations of the control capabilities of the hydrofoil). As the aerodynamic lift, L_{W}, generated by the main wing 105 continues to increase past this maximum amount of downwards hydrofoil lift, L_{F}, L_{NET} increases in the upwards direction beyond W_{CRAFT} and the craft 100 is pulled from the water. This, in turn transitions the craft 100 to a wing-borne mode of operation.

### E. Wing-Borne Operation

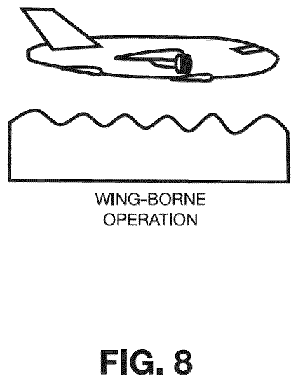

FIG. 8 illustrates an example of the craft 100 after becoming wing borne. In some examples, once the transition from hydrofoil-borne operation to wing-borne operation is complete, the control system 500 causes the main hydrofoil deployment system 200 and the rear hydrofoil deployment system 300 to respectively retract the main hydrofoil assembly 108 and the rear hydrofoil assembly 110. In some examples, the control system 500 initiates this retraction as soon as the hydrofoil assemblies 108, 110 are clear of the water to reduce the chance of the hydrofoil assemblies 108, 110 reentering the water. The control system 500 may determine that the hydrofoil assemblies 108, 110 are clear of the water in various ways. For instance, in an example, the control system 500 makes such a determination based on a measured altitude of the craft 100 (e.g., based on data provided by the radar system 516, the lidar system 518, and/or the other sensors 522 described above for measuring an altitude of the craft 100). In another example, the sensors 522 may further include one or more conductivity sensors, temperature sensors, pressure sensors, strain gauge sensors, or load cell sensors arranged on the hydrofoil assemblies 108, 110, and the control system 500 may determine that the hydrofoil assemblies 108, 110 are clear of the water-based on data from these sensors.

Once the craft 100 is clear of the water, the control system 500 continues to accelerate the craft 100 to the desired cruise speed by controlling the speed of the propeller systems 116. In some examples, the control system 500 retracts the flap systems when the craft 100 has achieved sufficient airspeed to generate enough lift to sustain altitude without them and actuates various control surfaces of the craft 100 and/or applies differential thrust to the propeller systems 116 to perform any desired maneuvers, such as turning, climbing, or descending, and to provide efficient lift distribution. While in wing-borne mode, the craft 100 can fly both low over the water's surface in ground-effect or above ground-effect depending on operational conditions and considerations.

### F. Return to Hull-Borne and Maneuver Operation

To facilitate transitioning from wing-borne to hull-borne mode of operation (See FIG. 6A), the control system 500 determines that the hydrofoil assemblies 108, 110 are fully or partially retracted so that the craft 100 may safely land on its hull 102. In some examples, the control system 500 additionally determines and suggests the desired landing direction and/or location-based on observed, estimated, or expected water surface conditions (e.g., based on data from the radar system 516, the lidar system 518, the imaging system 520, or other sensors 522).

The control system 500 initiates deceleration of the craft 100, for instance, by reducing the speeds of the propeller systems 116 until the craft 100 reaches a desired landing airspeed. (The control system 500 can also be used to implement the functioned noted in the following sections.) During the deceleration, the control system 500 may deploy the flaps 118 to increase lift at low airspeeds and/or to reduce the stall speed. Once the craft 100 reaches the desired landing airspeed (e.g., approximately 50 knots), the control system 500 reduces the descent rate (e.g., to be less than approximately 200 ft/min). As the craft 100 approaches the surface of the water (e.g., once the control system 500 determines that the craft 100 is within 5 feet of the water surface), the control system 500 further slows the descent rate to cushion the landing (e.g., to be less than approximately 50 ft/min). As the hull 102 of the craft 100 impacts the surface of the water, the control system 500 reduces thrust, and the craft 100 rapidly decelerates due to the presence of hydrodynamic drag, the reduction in forward thrust, and the reduction or elimination of blowing air over the wing which significantly reduces lift causing the vehicle to settle into the water. The hull 102 settles into the water as the speed is further reduced until the craft 100 is stationary.

In some examples, after the craft 100 is settled in the water, the craft 100 is transitioned back to hydrofoil-borne maneuvering mode (See FIG. 6B) by extending the hydrofoil assemblies 108, 110 to transition from hull-borne operation to hydrofoil-borne operation in the same manner as described above. In some examples, the control system 500 then sustains the hydrofoil-borne mode at the fifth stage and maneuvers the craft 100 into port while keeping the hull 102 insulated from surface waves. The control system 500 then reduces the thrust generated by the propeller assemblies 116 to lower the speed of the craft 100 until the hull 102 settles into the water, thereby transitioning that craft back to hull-borne operation at the sixth stage. The control system 500 then retracts the hydrofoil assemblies 108, 110 and folds the propeller assemblies 116 in a direction away from the dock and performs maneuver operations described above to maneuver the craft 100 into a dock for disembarking passengers or goods and recharging the battery system 400.

### IV. EXAMPLE COCKPIT LAYOUT

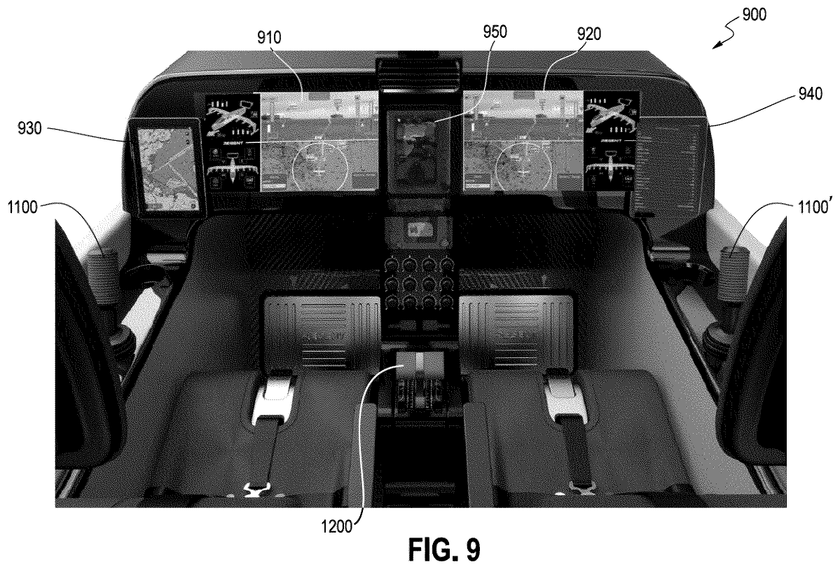

Returning to the drawings, FIG. 9 is an illustration of an example layout of a cockpit 900 of an embodiment. As shown in FIG. 9, this example layout comprises first and second touchscreen display devices 910, 920 for displaying Flight Instrument System information and Flight controls such as vehicle control, system status, alerts, and sensor information, first and second tablets (e.g., iPads) 930, 940 for displaying less critical information, such as weather, charts, and checklists, and an independent, back-up touchscreen display 950.

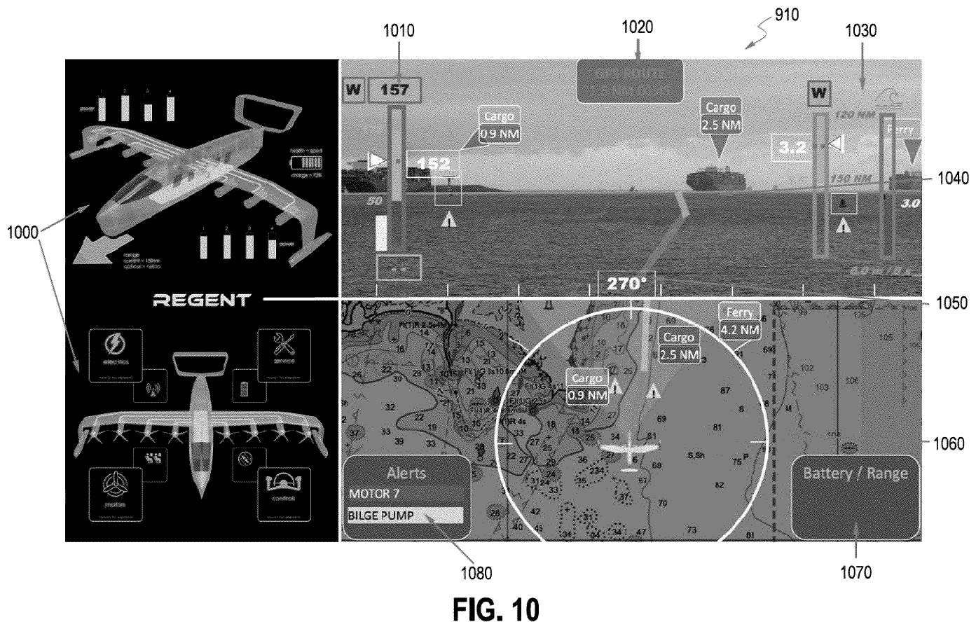

FIG. 10 shows the display output of the first and second touchscreen displays 910, 920 in more detail. As shown in FIG. 10, this example display output comprises two selectable system information synoptics regions 1000 that allows the crew of the craft to control system modes, change values, and provide other inputs. The rest of the display is divided into an upper half and a lower half. The upper half of the display is laid out similar to an aviation primary flight display (PFD) but with seaglider-specific gauges. More specifically, the upper half of the display in this example comprises a speed gauge 1010, a region 1020 that displays navigational information (heading/route) and the selected navigation mode, a height gauge 1030 that also displays wave statistics, an artificial horizon line 1040, and an augmented camera view 1050 with route, vessels, and obstacles overlaid. Also, as will be explained in more detail below, the speed and height gauges 1010, 1030 are displayed in such a way as to provide an indication of the seaglider mode (e.g., hull, foil, or wing mode).

The lower half of the display in this example displays navigation information, such as various notational layers 1060 (e.g., charts, other vessels, color-coded routes (e.g., magenta representing the current route, and white representing other routes), obstacles, and a compass), battery and range information 1070, and a critical alerts and alarms list 1080, which can be selectable to bring up detail on the alert on a side page.

Additional pages that can be displayed include, but are not limited to, pages on battery status, propulsion status, the electrical system, the flight control system, route selection, charts, maintenance, and communications. It should be understood that other display layouts and display information can be used. For example, an augmented reality view can be displayed that is mapped to the real world, including dimensions and orientation of objects (e.g., boats, aircraft, land, buoys, etc.) with tags/identifiers overlain with location/distance information). More information about the example display and other feedback/alert outputs are provided in one of the below sections.

Returning to FIG. 9, the cockpit 900 in this example also contains first and second sidestick controllers 1100, 1100′. In other embodiments, instead of having two sidestick controllers (one for the pilot and one for the co-pilot), a single controller is positioned in the center of the cockpit and shared by the pilot and co-pilot. The sidestick controller can have any suitable layout and functionality. In one embodiment, the craft is controlled in part by its navigation system, but the sidestick controller allows the operator of the craft to make an adjustment, for example, to the steering or ride height.

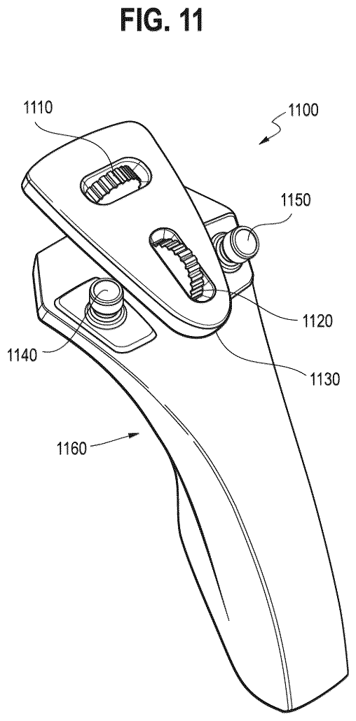

FIG. 11 depicts one possible design of a sidestick controller 1100, which has a different shape than shown in FIG. 9, and comprises first and second wheels 1110, 1120 on a raised portion 1130 (which serves as a guarding feature to prevent non-deliberate actuation of the wheels 1110, 1120), first and second buttons 1140, 1150 on either side of the raised portion 1130, and a trigger 1160. These user input elements can have any suitable function, and additional/fewer/different user input elements can be used. In this example, the first wheel 1110 is a momentary re-centering dial that, when held to one side, increments either heading or lateral translation, the second wheel 1120 is an infinite rotating dial with tactile detents that adjusts the target ride height or altitude, the first button 1140 is an accessory button, the second button 1150 is a reversionary (emergency) control button, and the trigger 1160 is a pull-to-talk or push-to-talk switch for the intercom or VHF radio. It should be noted that the sidestick controller 110 does not necessarily need to be in the form of a “stick” and can take any suitable form, such as, but not limited to, wheel/steering wheel, which may be more desirable than a stick in controlling the craft in maneuver mode. Also, while FIG. 11 used the notation “1100” for the sidestick controller, the same or different configuration can be used for the other sidestick controller 1100′ shown in FIG. 9.

As also shown in FIG. 9, the cockpit 900 in this example contains a center-mounted single control lever 1200 that is movable among a plurality of positions within a guide slot to provide user input. In addition to the lever 1200 itself serving as a user input device, one or more user input elements can be included on the lever 1200. For example, one or more of the wheels and buttons of the sidestick controller 1100 can be located on the lever 1200. Also, it should be noted that while a lever is being used in this example, user input devices other than a lever can be used. Examples of other user input devices include, but are not limited to, a dial, a wheel, a switch, a button, etc., each with its own equivalent version of a detent, as discussed below Also, a user input device can be virtual (e.g., displayed on a touch screen) instead of physical.

The following section provides examples of various configurations and uses of the control lever 1200. It should be understood that these are merely examples and that other implementations can be used.

### V. EXAMPLE CONFIGURATIONS AND USES OF THE CONTROL LEVER

In one embodiment, the lever 1200 serves as a combination throttle and mode selector. (In other embodiments, the lever 1200 serves as a throttle, but not a mode selector, or vice versa, with the other function being located on a different user input device.) In controlling the throttle, movement of the lever 1200 can adjust the power and/or speed of the craft. In general, references to “power” (or revolutions per minute (RPM) with respect to fixed pitch propellers) can involve the control system of the craft applying a set (commanded) power/RPM to the propellers on the craft's wing. Power can be represented as percent power, manifold pressure, or torque (such as when piston engines and turbines are used), The control system of the craft can maintain that applied power/RPM, potentially without regard for other considerations, including resulting speed. On the other hand, references to “speed” can involve the control system of the craft applying a set (commanded) speed (e.g., airspeed, ground speed, or water speed) and closing a power/RPM control loop necessary to achieve that commanded speed (e.g., depending on environmental conditions, such as water chop and/or head/tailwind). In short, controlling speed may involve “closing a control loop” around a desired speed, whereas controlling power may only involve a set point for a given mechanism for applying craft power. As will discussed below, whether the lever 1200 controls power or speed, as well as the range of those items, can be determined based on the mode of the craft.

Using the lever 1200 to control throttle of the craft is similar in some ways to how an operator would control throttle on some traditional boats. Additionally, port-starboard steering of the craft can be done automatically with a navigation system or manually (e.g., with a sidestick controller). This is also somewhat similar to how an operator would control steering of a boat (e.g., but using a sidestick controller instead of a wheel, although a wheel can be used in the craft). While controlling the craft in these two dimensions may be similar to how a boat is controlled, unlike a boat, the craft additionally requires control in a third dimension (height or altitude), which can in some ways be a complex and non-intuitive task, especially when transitioning between control on the water and control in the air. For example, for take-off and landing, various components of the craft (e.g., hydrofoil assemblies, wing control surfaces, etc.) need to be controlled, in addition to the power/speed of the craft.

Which components need to be controlled—and how they are controlled—can depend on the mode of the operation of the craft. As mentioned above, in one embodiment, the craft can operate in a plurality of modes: maneuver/standby/default (“maneuver”) mode, hull-borne (“hull”) mode, hydrofoil-borne (“foil”) mode, and wing-borne (“wing”) mode. (Fewer/more/different modes can be used.) In maneuver mode, the craft moves essentially in two dimensions while on the water to perform maneuvers, such as anchoring, docking, or taxiing. The maneuvering can be done automatically and/or manually (e.g., using a sidestick controller). In maneuver mode, the propeller assemblies of the craft may be folded in a direction away from the dock to help avoid collision with nearby structures or people, and/or the hydrofoil assemblies can be retracted (or partially retracted) to avoid collisions with nearby underwater structures. In hull mode, the craft is still floating on the water on its hull and movable only in two dimensions. However, the propeller assemblies can be used to propel the craft in the water at a faster speed than in maneuver mode. Accordingly, in hull mode, the propeller assemblies can be placed in an unfolded position if previously folded.

In foil mode, the craft extends its hydrofoil assemblies (if not already extended during hull mode) and accelerates to a takeoff speed. However, unlike the two-dimensional moving in maneuver and hull modes, the craft begins to move in third dimension in foil mode, as the hydrofoil assemblies cause the hull of the craft to rise above the water surface. As another difference, during foil mode, the pitch of the craft may need to be adjusted, so the hydrofoil assemblies stabilize the attitude of the craft to maintain the desired height between the hull and the surface of the water.

In wing mode, forces generated by the main wing or other surfaces of the craft result in the lift required to cause the craft to become airborne, and the craft continues its movement further into the third dimension. During wing mode, the hydrofoil assemblies can be retracted, and various aerodynamic control surfaces on the craft can be actuated to control the altitude of the craft. For landing, the craft is returned to hull mode (foil mode can be skipped if the hydrofoil assemblies are not needed for landing, although, in some embodiments, the craft transitions to foil mode before transitioning to hull mode). During the transition from wing mode to hull mode, various control surfaces can be adjusted to cause the craft to descend at a desired rate. Once in the water, the craft can transition from hull mode to maneuver mode, or back to foil mode.

As seen from the above, while operating the craft in maneuver and hull modes is somewhat similar to operating a boat since it involves controlling the craft in only two dimensions, operating the craft in foil and wing modes is quite different since it involves operating the craft in a third (height) dimension. This can present additional challenges. The following embodiments can be used to address this issue by making the operation of the craft more like the operation of a boat even in the third dimension, and even as the craft transitions through all of its available modes. More specifically, as mentioned above, the lever 1200 of this embodiment serves as a combination throttle and mode selector that can be used to present a seamless and consistent control experience for the operator even as the craft transitions through its various modes of operation, including those involving the third dimension (height). With these embodiments, the operator of the craft does not necessarily need to be focused on actively controlling the altitude of the craft, as the altitude can be an automatic function of the mode of the craft, as selected by the lever 1200. In other words, the operator can be focused on controlling the speed/power of the craft as well as the direction/heading of the craft (i.e., two dimensions of control, as with a boat), whereas the altitude of the craft (the third dimension) can be controlled semi-automatically as a function of the power/speed and mode transitions commanded by the operator via the lever 1200.

One advantage of this is that the lever 1200 can be used to carry the two-dimensional control experience of a boat over to the craft even when the craft is in flight, thereby bringing a maritime flight control experience to a WIG craft. This results in a relatively “lower mental bandwidth” operation for the operator than might otherwise be required, since the control across all modes that would otherwise require “many hands” is condensed down to movement of a single lever 1200. This significantly decreases the cognitive load of the operator and can improve the overall experience of both the operator and the passengers of the craft.

To further make the control of the craft more like the control of a boat, the craft can be designed without rudder pedals, which are conventional in airborne craft. This further allows the operator to focus only on controlling throttle and steering despite being able to fly. Further, if automatic flight control or autopilot is a significant portion of the flight control for the craft, the operator often may not need to manually/directly control flight/aerodynamic control surfaces, thereby providing the opportunity to reduce or eliminate “normal”/“standard” flight controls found in other aircraft.

The lever 1200 can be configured in any suitable way to control power/speed and mode transitions of the craft. The following section provides a discussion of one example implementation. It should be understood that this is merely an example and that other implementations can be used.

### VI. EXAMPLE MODE TRANSITIONS MADE VIA THE CONTROL LEVER

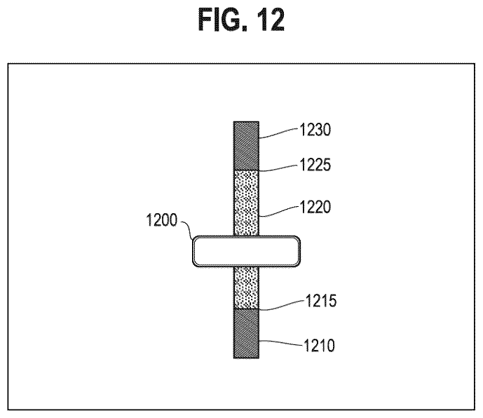

Returning to the drawings, FIG. 12 illustrates the range of movement of the lever 1200 in one example implementation. As shown in FIG. 12, the lever 1200 in this embodiment is movable between a lower detent 1210, a main detent 1220, and an upper detent 1230 within a slot. In this example, a first (down) gate 1215 provides physical resistance to the lever 1200 in moving between the lower detent 1210 and the main detent 1220, and a second (up) gate 1225 provides physical resistance to the lever 1200 in moving between the main detent 1220 and the upper detent 1230. In some embodiments, the physical resistance provided by one or both gates 1215, 1225 is overcome by the operator providing additional force to the lever 1200. In other embodiments, the physical resistance is overcome by the operator performing some additional action, such as, for example, pulling up on a locking tab, moving the lever 1200 to one side, pushing the lever 1200 down, pushing a button on the lever 1200, etc. Each gate 1215, 1225 can require the same or different type of additional force or action to overcome the physical resistance. Also, one or both gates 1215, 1225 can provide resistance and/or require additional force or action only when the lever 1220 is moved in a certain direction (e.g., up instead of down).

In this embodiment, one or both of the upper and lower detents 1210, 1230 provide little or no range of movement of the lever 1200. So, the lever 1200 is either in or not in the upper or lower detents 1210, 1230. In contrast, the main detent 1220 of this embodiment provides the lever 1200 with a range of movement between the lower and upper detents 1210, 1230.

In this embodiment, the speed/power of the craft is adjusted by movement of the lever 1200 within the range of movement provided by the main detent 1220. As mentioned above, whether the lever 1200 controls speed or power can depend on the mode of the craft. For example, it may be desired for the lever 1200 to control power/RPM in hull and foil modes as the operator contends with, for example, obstacles in the water, heavy waves, or other challenges of the water. On the other hand, it may be desired for the lever 1200 to control speed in wing mode, as the operator typically desires to maintain a particular set/commanded airspeed without a direct concern for what RPM in particular is required to maintain such airspeed. Also, as will be discussed below, the range of power/speed controlled by the range of movement of the lever 1200 within the main detent 1220 can be based on the mode of the craft.

While the speed/power of the craft is adjusted by movement of the lever 1200 in the main detent 1220, transition between states of the craft is caused at least in part by movement of the lever 1200 from one detent to another. For example, as will be discussed in more detail below, movement of the lever 1200 from the lower detent 1210 to the main detent 1220 can transition the craft from maneuver mode to hull mode. From there, movement of the lever 1200 from the main detent 1220 to the upper detent 1230 (the mode-up command range) can transition the craft from hull mode to foil mode. After the lever is moved to the upper detent 1230 and the mode transition has completed, the lever 1200 can automatically or manually be moved to a position in the main detent 1220 associated with a current speed/power and mode of the craft (e.g., a solenoid can drive the lever 1200 out of the upper detent 1230 into the main detent 1220). Another movement of the lever 1200 from the main detent 1220 to the upper detent 1230 can transition the craft from foil mode to wing mode. Conversely, movement of the lever 1200 from the main detent 1220 to the lower detent 1210 (the mode-down command range) can “down-transition” modes (e.g., transition from hull mode to maneuver mode). At each transition of a mode, the processor(s) of the control system of the craft can adjust various components of the craft. For example, the processor(s) can change a control surface setting, change a hydrofoil state setting, change a ride height setting, change a pitch of the craft, change an altitude of the craft, change an available power range of the craft, change an available speed range of the craft, initiate a take-off routine, and/or initiate a landing routine. These actions can be taken automatically by the processor(s) in response to the operator's movement of the lever 1200 (together, a semi-automatic operation), thereby simplifying the operation of the craft.

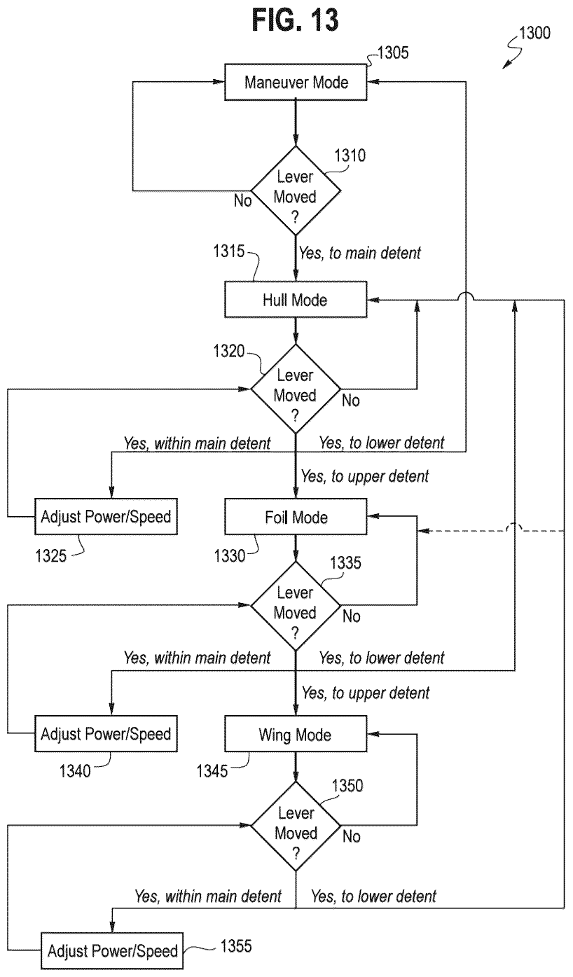

The flow chart 1300 of FIG. 13 and several of the subsequent figures will now be described to illustrate example operations of the lever 1200 as well as corresponding operations of the craft. It is important to note that these are merely examples and that the details mentioned herein should not be read into the claims unless expressly recited therein.

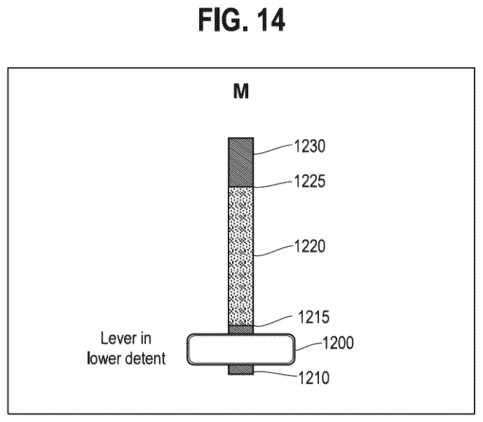

As a starting/default/initial state, the lever 1200 is in the lower detent 1210 (see FIG. 14), and the craft is in maneuver mode (act 1305). It should be noted that, although the flow chart 1300 is “starting” in maneuver mode at act 1305, this is not necessary. Instead, control of the lever 1200 and the craft may be understood to start/begin at any point (shown or not shown in the flow chart 1300). That is, the lever 1200 may be operated while the lever 1200 and/or craft are in any state. However, for purposes of this example, the flow starts while the craft is in maneuver mode. As described above, in maneuver mode, the craft operates in only a lower power/speed, which can be applied using the sidestick controller 1100 (not the lever 1200). Additionally or alternatively, small amounts of power/speed can be autonomously applied by the craft in carrying out automatic functions. In maneuver mode, the craft may accomplish particular maneuvers (either via manual and/or automatic control) such as, but not limited to, anchoring (holding the craft in place), taxiing (on water), and/or docking.

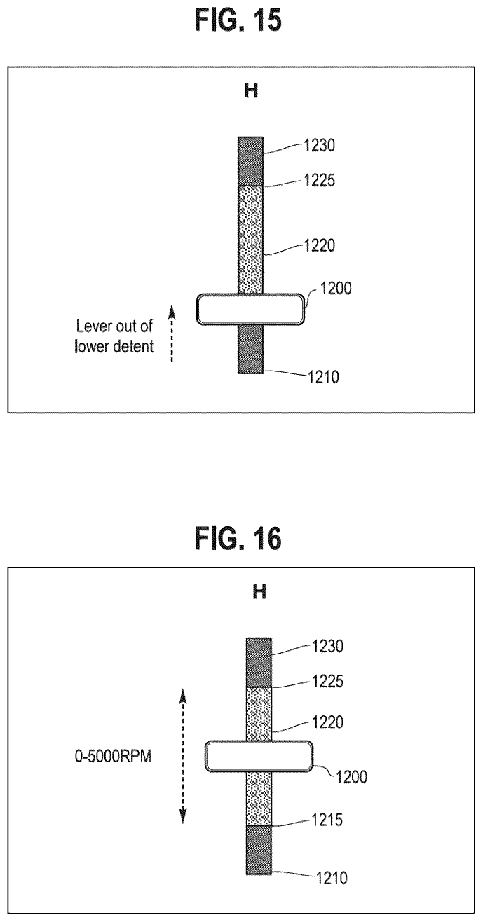

The processor(s) of the control system actively or passively monitor the lever 1200 for movement (act 1310). Here, since the lever 1200 is in the lower detent 1210, the processor(s) monitor the lever 1200 to determine whether it has been moved from the lower detent 1210 to the main detent 1220 (act 1310). If the lever 1200 has been moved to the main detent 1220 (see FIG. 15), the processor(s) cause the craft to enter hull mode (act 1315). The processor(s) can also configure the range of movement of the lever 1200 with a certain range of power/speed of the propellers. So, when the lever 1200 is moved within the main detent 1220 (see FIG. 16), the processor(s) cause the power/speed of the craft to be adjusted according to the power/speed range (e.g., 0-5,000 RPM) assigned to the range of movement of the lever for this mode (act 1325).

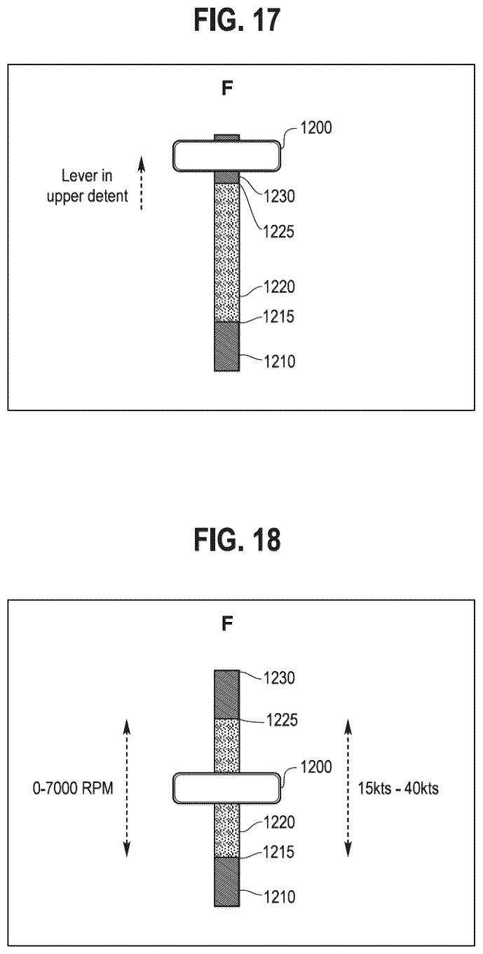

If the lever 1200 is moved to the lower detent (see FIG. 24), the processor(s) cause the craft to transition back to the maneuver mode (act 1305). However, if the lever 1200 is moved to the upper detent 1230 (see FIG. 17), the processor(s) cause the craft to transition to foil mode (act 1330). (The operator can abort this transition by moving the lever 1200 back to the main detent 1220.) For this transition, the processor(s) can automatically adjust the power/speed of the propellers to that of the value that is at the top of the range for hull mode and the bottom of the range for foil mode (e.g., 5,000 RPM, which is what may be needed for a hull-to-foil-mode transition in one example). To accomplish this, the processor(s) can automatically adjust various settings per presets, such as, but not limited to, ride height and pitch target.

It should be noted that there are many ways for movement of the lever 1200 to the upper detect 1230 to cause the transition to foil mode (or wing mode). For example, if the power/speed associated with upper power/speed range of the main detent 1220 is desired to be achieved for transition to foil mode, incremental movement of the lever 1200 from the upper range of the main detent 1220 into the upper detect 1230 (after taking the appropriate action, if any, to clear the up gate 1225), can cause the craft to transition to foil mode. In another example, the transition can be triggered by the operator moving the lever 1220 quickly from a position below the upper range of the main detent 1220 temporarily into the upper detect 1230 without the motors revving up equally as fast. That may be desired in situations where the operator does not want to go to the maximum hull power/speed before transitioning into foil mode (e.g., where there is an overlap between the minimum speed to foil and the maximum hull speed). In yet another example, the operator may be required to hold the lever 1200 in the upper detent 1230 for some period of time (e.g., until the craft completes the transition to foil mode, which can be indicated when the craft reaches its target ride height). In yet another example, the operator may be required to move the lever 1220 quickly from a position below the upper range of the main detent 1220 into the upper detent 1230 without the motors revving up equally as fast.

After the lever 1200 is moved into the upper detent 1230 and the transition is complete, the lever 1200 is repositioned back into the main detent 1220, so that the lever 1200 can once again control the speed/power of the propellers of the craft (now in foil mode). As discussed above, when the craft transitions from one mode to another, the range of power/speed represented by the main detent 1220 can change. In the example shown in FIG. 18, the range is 0-7,000 RPM (15-40 kts) in foil mode, whereas the range was 0-5,000 RPM in hull mode (see FIG. 16). In another example, the range can correspond to maximum hull mode RPM (at the bottom of the main detent 1220) to a maximum foil mode RPM (at the top of the main detent 1220) (e.g., 5,000 RPM to 7,000 RPM). As yet another example, the range can correspond to some minimum RPM that overlaps somewhat with the range of RPMs available in hull mode (e.g., 3,000 RPM to 7,000 RPM), where the minimum here could be a minimum foiling speed. Additionally, the range of power available while in foil or any other mode can change dynamically depending on a variety of considerations, such as, for example, atmospheric conditions. For example, if the weather is rough, the maximum power/speed may decrease due to pressure or wind. So, at any given time of operation of the craft, the range of power/speed that is available can change.

The lever 1200 can be moved into the main detent 1220 from the upper detent 1230 in any suitable way. For example, the processor(s) can cause the lever 1200 to automatically reposition itself to the position in the main detent 1220 that corresponds to the actual speed/power of the craft. In one embodiment, the processor(s) can automatically move the lever 1200 to the position in the main detent 1220 that corresponds with the current actual power/speed of the craft. Alternatively, the operator can move the lever 1200 to the appropriate position in the main detent 1220, with the processor(s) optionally recalibrating the range based on the final position of the lever 1200.

When the lever 1200 is moved (automatically or manually) downward from the upper detent 1230 to the main detent 1220), such movement would normally send a command signal to the processor(s) to decrease the power/speed, which would be an undesired result in this “lever-repositioning” situation. For example, if the maximum RPM for hull mode is ˜5,000 RPM, and the maximum RPM for foil mode is ˜7,000 RPM, there is potential that, when the craft enters the transition from hull mode to foil mode, it is operating at ˜5,000 RPM. However, when the lever 1200 leaves the upper detent 1230 to return to the main detent 1220, it would pass through the top range of the RPM command region (the main detent 1220) causing a “blip” up in the RPM command signal, perhaps while the lever 1200 is returned to a point lower in the main detent 1200 RPM command range. To handle these types of“blippy” signals, the processor(s) can ignore the movement of the lever 1200 out of the upper detect 1230 (e.g., for a few seconds) to avoid decreasing the power/speed of the craft. Alternatively, the processor(s) can ignore the input signal until the lever 1200 is moved down into the main detent 1220 to a speed command that matches the current speed of the craft. As another alternative, the processor(s) can disregard the input command until the lever 1200 is moved to a predetermined position within the main detent 1200 (e.g., halfway down). As yet another alternative, instead of wholesale ignoring the input command, the processor(s) can “smooth” the input command or average the input command with the existing speed in some way, so that the “blippy” input is not as disruptive. Other alternatives are possible.

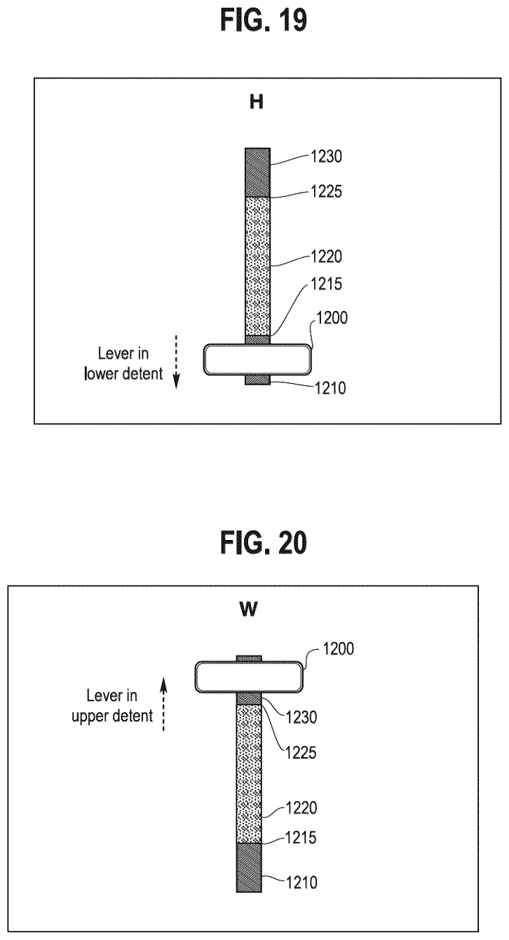

After the lever 1200 is repositioned, the processor(s) monitor for movement of the lever 1200 (act 1335). If the lever 1200 is moved within the main detent 1220, the processor(s) adjust the power/speed of the craft accordingly, as noted above (act 1370). If the lever 1200 is moved (e.g., temporarily (“place and hold”)) into the lower detent 1210 (see FIG. 19), the processor(s) transition the craft back to hull mode (act 1315). To transition back to hull mode, the processor(s) can change various settings in the craft's hydro-controller, such as ride height and pitch. For example, if the ride height setting is <0.15 meters, once the craft is at that ride height, transition to hull mode is complete.

If the lever 1200 is moved to the upper detect 1230 (FIG. 20), the processor(s) cause the craft to transition to wing mode (act 1345). This can require, for example, the lever 1200 to be temporarily placed in the upper detent 1230 or “placed and held” in the upper detent 1230 until the transition is complete or the takeoff procedure is at initiated. Once the transition is complete, the processor(s) can initiate a predetermined take-off routine, as described in U.S. patent application Ser. No. 17/885,463, filed Aug. 10, 2022 and 63/374,596, filed Sep. 5, 2022, which are hereby incorporated by reference. In general, the processor(s) can automatically change/set various craft settings and then automatically adjust them over time to facilitate takeoff and eventual flight. For example, aerodynamic surfaces and the rear foil extension can be automatically configured. As another example, the ride height setting can be set to some predetermined altitude in the air, but the transition to wing mode is considered complete when the craft is “off water.” U.S. Patent Application No. 63/495,852, filed Apr. 13, 2023, which is hereby incorporated by reference, describes one technique for making an on/off water determination.

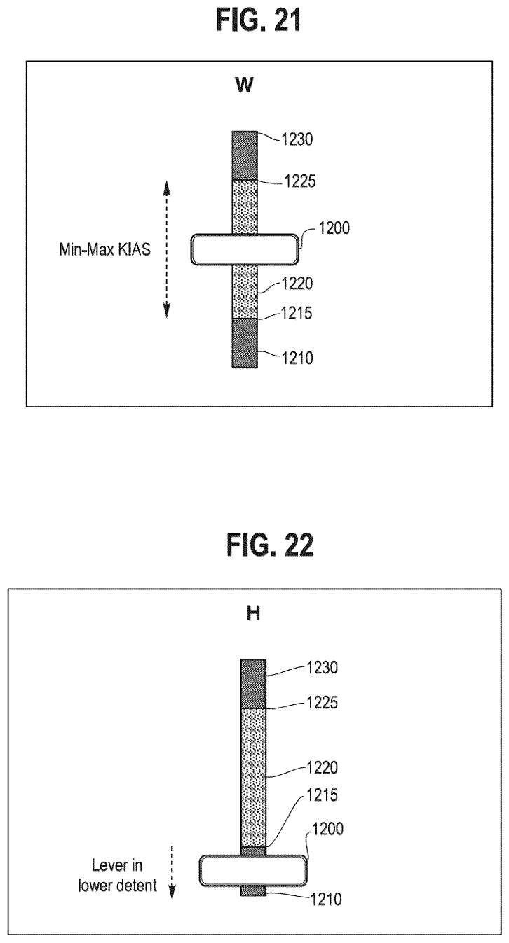

Also, in transitioning from foil mode to wing node, the processor(s) can slew the throttle automatically to some amount higher than the amount that was last commanded while in foil mode so as to support takeoff/flight. For example, the throttle can be slewed to 8,000 RPM from 7,000 RPM (the last commanded speed while in foil mode). As noted above, while in wing mode, moving the lever 1200 through the main detent 1220 will either add or remove power to the propellers of the craft. This will adjust the air speed of the craft while flying and will have a minimum and maximum setting. The range of RPMs while in wing mode can take different forms. In an example, while flying, the craft may be controlled according to actual speed (e.g., actual airspeed) as opposed to commanded propeller RPMs. For example, in wing mode, the minimum and maximum RPM/airspeeds may be referred to and/or represented/displayed as “knots of indicated airspeed” or “KIAS” (see FIG. 21).

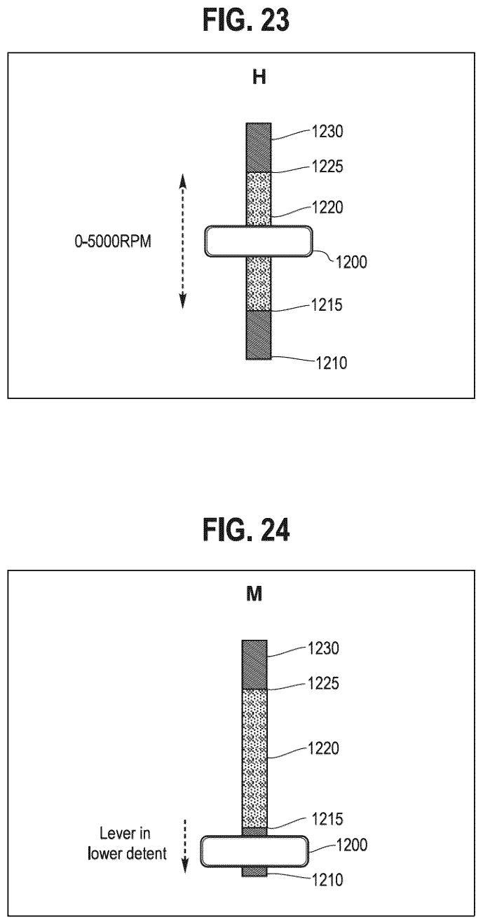

After the craft transitions to wing mode, the lever 1200 can be manually or automatically positioned in the appropriate location in the main detent 1220 based on the craft's current power/speed (see FIG. 21), as discussed above. The processor(s) then monitor for movement of the lever 1200. If the lever 1200 is moved in the main detent 1220, the processor(s) adjust the power/speed accordingly (act 1355). If the lever 1200 is moved the lower detent 1210 (see FIG. 22), the processor(s) can transition the craft directly back to hull mode (act 1315) (see FIG. 23). Optionally, this movement of the lever 1200 can transition the craft back to foil mode (act 1330) and require another movement of the lever 1200 into the lower detent 1210 to transition to hull mode, or the foil mode can be used for landing when the craft can land on the water using its foils. As yet another alternative, different command inputs cause the craft to down-transition to hull mode or foil mode from wing mode.

When the transition from hull mode is initiated, the processor(s) can initiate a predetermined “landing” routine, such as that discussed in U.S. Patent Application No. 63/493,575, filed Mar. 31, 2023, which is hereby incorporated by reference. As discussed in that application, the craft can be assumed to have transitioned into and be operating in hull mode once it completes the “on water declaration” phase of the landing routine. After landing (i.e., the transition from wing mode to hull mode), the motor can be at 0 RPM, if the motor is fully cut during the landing procedure. Once back in hull mode, moving the lever 1200 through the main detent 1220 can either add or remove power to the propellers of the craft (e.g., 0-5,000 RPM in one example).

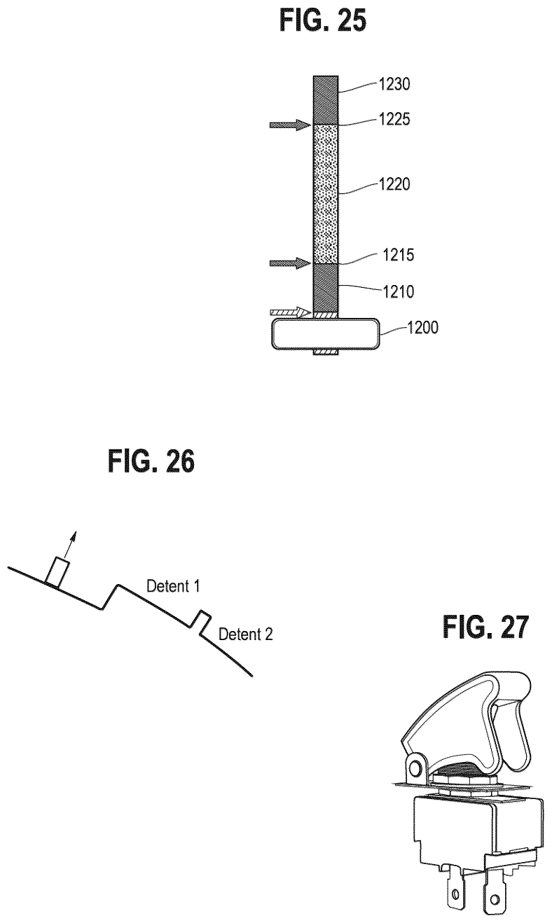

When the lever 1200 is moved to the lower detent 1210 (see FIG. 24), the processor(s) transition the craft back to maneuver mode (act 1305). (The lever 1200 can be “locked” (e.g., using a solenoid) to maintain the lever 1200 in the lower detent 1210 during maneuver mode, as, during maneuver mode, the lever 1200 is not used to control the power/speed of the craft.) As mentioned above, this can involve bringing the craft to zero groundspeed while maintaining the current heading of the craft and holding a commanded position/heading. Maneuver mode may be “sticky” because, as noted above, while in maneuver mode, only very low RPM is available (e.g., using the sidestick controller 1100). So, to ensure it is desired that the craft enters the maneuver mode and/or as an extra precaution, when attempting to move from hull mode to maneuver mode, the lever 1200 can be configured to require an additional operator action (e.g., modification/adjustment of the lever 1200) after the lever 1200 is placed in the lower detent 1210. For example, with reference to FIGS. 25 and 26, the lower detent 1210 can have an additional gate (e.g., a bi-directional guard that requires the operator to pull up on a locking tab to both enter and exit the lower detent) to prevent the operator from accidentally bumping the lever 1200 out of maneuver mode into hull mode. Other examples include moving the lever 1200 to one side, pushing the lever 1200 down, pushing a button on the lever 1200, etc. Also, each lower detent region can have two ranges within it, and entering maneuver mode may require intentionally placing the lever into the second of the lower-detent ranges.

In another embodiment, a guarded “disable motor” switch (see FIG. 27), key, or T-handle can be used to cause the craft to enter maneuver mode and lock the throttle into the low-detent position. The “disable motor” control can be located on the lever 1200 or elsewhere in the cockpit. If off the lever 1200, it may be desired to locate the control in a position in the cockpit where it is both easily visible from either operator position and is unlikely to get bumped.

There are many alternatives that can be used with these embodiments. For example, as discussed in detail above, through the use of the lever 1200, the operator of the craft can make a deliberate choice and take an affirmative action to move the lever 1200 to transition between modes. In one alternative, the craft can automatically (i.e., without the movement of the lever 1200) transition between modes (e.g., when the speed of the craft exceeds a threshold) for at least some of the mode transitions. However, deliberate choice/affirmative action may be desirable in at least some instances because in use/action, the craft is controlled and behaves differently within different modes (e.g., the drag on the craft can be different when in hull mode versus when in foil mode). So, requiring the deliberate choice/affirmative action provides a natural mental queue to the operator that the behavior of the craft will be changing as a result of the mode change and/or of how the craft will behave as the craft moves between modes.

Another alternative relates to the operator's ability to abort a requested mode transition. A transition to a mode may trigger the execution of predetermined sequences/routines, such as, for example, those described in U.S. Patent Application Nos. 63/374,596, filed Sep. 5, 2022, and 63/493,575, filed Mar. 31, 2023, which are hereby incorporated by reference. However, it may be desired that the operator not actually be (or feel to be) “locked in” to those procedures. So, in one alternative, the operator is given the ability to “abort” a transition. In this way, even if the automated system of the craft is automatically performing some of the steps required to accomplish a mode transition, providing the operator with the ability to abort allows the operator to have the feeling of being in control of the craft and provides the operator with more control over the automation.

The abort functionality can be provided in any suitable way, such as, for example, by reverse movement of the lever 1200, which may be an intuitive/convenient action by the operator. As another example, the craft can be equipped with a separate “abort” (or “emergency”) button (e.g., on the sidestick controller 1100, on the lever 1200, or elsewhere in the cockpit). In general, it may be desired to implement the abort control element in such a way that it can be easily understood (e.g., so that a minimally-trained crew can perform a simple function to stop the craft in the event that the primary crew is incapacitated). Also, as will be discussed in the following section, the visual display/touchscreen (or other user interface/user experience element) may provide an indication of when a mode transition is underway. This allows the operator to know when a mode transition is ongoing (and subject to an abort) or whether the mode transition is complete.

As mentioned above, when the operator aborts a mode transition, the craft can revert to the mode it was in prior to the transition being initiated by movement of the lever 1200. In other embodiments when a transition is aborted, the craft can enter an entirely different operating mode or can assume an entirely different or modified operating state. Also, the type of abort operation can depend on the mode of the craft. The following paragraphs provide some example abort situations. It is important to note that these are merely examples and that other implementations can be used.

To abort a hull-to-foil-mode transition in one example, the operator can pull the lever 1200 back into the main detent 1210 while the transition is occurring, which will cause the craft to abort the transition and return to hull mode. Aborting this transition may be considered “acceptable” from a passenger comfort perspective, as reverting back to hull mode during a transition to foil mode should not be especially disruptive.

In this example, once fully transitioned to foil mode, the operator can be given the ability to perform an “emergency stop” to immediately return to hull mode (e.g., in case the craft encounters an obstacle). When the emergency stop is activated, the processor(s) can fully cut the motors or take the motors to 0 RPM (or reverse the motors), at least temporarily. The mechanism to initiate an emergency stop can take any suitable form. For example, an emergency stop can be requested by pulling the lever 1200 down to the lower detent 1210 and holding it against a spring at the very bottom of the lower detent 1210. As another example, the cockpit can be equipped with an “emergency button” (e.g., separate from the lever 1200).

For much the same considerations of emergency stop from foil mode, it may be necessary to initiate an emergency landing (transitioning back to hull mode) while flying in wing mode. The mechanisms for initiating the emergency landing can be the same as for emergency stop above (e.g., moving the lever 1200 down into the lower detent 1210 and/or pressing a separate emergency button). In one example, the emergency landing may initiate the normal landing routine. In another example, the emergency landing may initiate a modified landing routine, which may be shorter in duration (i.e., a quicker transition to hull mode) and/or may include a “reverse thrust” applied once in hull mode to help the craft come to a full stop quickly.

As another example, a landing routine of the craft can be aborted to keep the craft flying. For instance, it is possible that an interruption/obstacle may be encountered during landing and that the craft may need to abandon the landing routine. The mechanisms for abandoning landing can be the same as for the emergency stop discussed above (e.g., moving the lever 1200 back up into the upper detent 1230, using a separate “emergency/abandon landing” button, or just returning the lever 1200 back to the main detent 1220 before the transition is completed, as discussed above). In one example, the craft might simply return back to initial flying mode depending on what state of the landing routine the craft is in. Also, depending on if the landing routine has advanced to a certain point, the “abort landing routine” option might not be available. When landing, an “emergency stop” may be a (modified) landing routine that is quicker than usual and, optionally, initiates/includes reverse thrust if the lever 1200 is held in the lower detent 1210. Additionally, there can be another abort where, if the lever 1200 is pulled back into the main detent 1220 during the procedure, the craft will reinitiate flight (depending on state).

In another alternative, the control system of the craft has the ability to identify and then handle various potential failure modes. In general, there can be back-up methods to safely transition down from one mode to another, such as from wing mode to hull mode. There can also be back-up methods to transition up to another mode, but this may not be deemed desirable since simply cutting power to the motors may be sufficient to stop while in hull or foil modes. In contrast, cutting power to the motors may not make a good (or even safe) landing due to blown wing effects. So, failure state/resolution can be provided if the lever 1200 fails in operation (in particular, in wing mode). In one example, there is a separate control mechanism (e.g., a button or switch) that the operator can interact with to initiate a landing sequence and can potentially trigger an override of any control signal that the inoperable lever 1200 is sending to the control system. For example, if the lever 1200 fails when it is in “wide open throttle,” the failure button can cause override of that throttle signal.

Also, as noted above, while a lever was used in the above examples, any suitable type of user input device can be used. For example, a dial, a wheel, a switch, a button, etc. can be moveable in a plurality of regions, with each region being separated by a gate configured to provide physical resistance in moving the user input device between regions. The various regions can function similar to the various detents discussed above. Accordingly, the use of a lever should not be read into the claims unless expressly recited therein.

### VII. OPERATOR FEEDBACK BASED ON CONTROL LEVER USAGE

Various audio, visual, and/or haptic devices in the cockpit can provide alerts/feedback to the operator on the use of the lever 1200 (e.g., to indicate that the craft is in transition and/or to indicate that the mode transition is complete). For example, a low-to-high climbing tone can be played to signal mode-up movement of the lever 1200, while a high-to-low descending tone can be played to signal mode-down movement of the lever 1200. Further, a series of beeps (e.g., beep-beep-beep) can be played to indicated that a mode transition is complete, or vocal feedback can be used (e.g., with spoke phrases, such as “Transitioning to Hull Mode” and “Mode Transition Complete”). As another example, special tones can be played if a mode change is aborted or fails. Also, a haptic output can provide an alert/feedback (e.g., through vibration of the lever 1200 or the operator's seat).

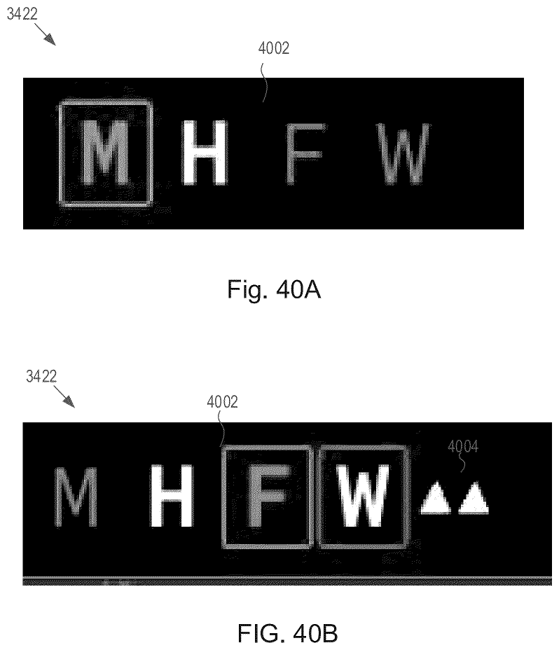

Further, visual feedback can be given (e.g., in one or more display screens in the cockpit). Various cockpit (or crew interface) displays can provide an indication of transition state (e.g., success, failure, current mode, etc.) as discussed below with respect to FIG. 40B, for example. There can also be other visual indications (off screen), such as, for example, light-emitting diodes (LEDs) on or off the lever 1200, that provide an indication of transition state. In general, each mode may be associated with a separate, unique, color and/or color scheme.

In one embodiment, a visual display/touchscreen (or other user interface (UI)/user experience (UX) element) can provide an indication of when a mode transition is underway and when the mode transition is complete. This allows the operator to know when he/she is able to abort the mode transition, as noted above. Additionally, dynamic gauges can be used that provide an intuitive, efficient, and easy display of craft state information, especially as the craft transitions through modes using the lever 1200. In this embodiment, at least some of the information displayed is the result of real-time sensor inputs and processing of those sensor inputs. Further, the specific arrangement of the display (e.g., positioning, indicators, colors, etc.) can have a specific functional purpose for providing information to an operator in a useful manner.

The following paragraphs will describe some example visual displays that can be used to provide feedback to the operator of the craft. It should be understood that these are merely examples and that other displays can be used. As such, the details presented herein should not be read into the claims unless expressly recited therein.

Referring back to FIGS. 9 and 10 and as discussed above, a visual display outputted on a display device in the cockpit can include speed and/or height gauges. In one embodiment, the speed gauge 1010 and the height gauge 1030 are persistently displayed (e.g., concurrently overlaid with the other information), so that they will always be available for the operator. Also, by displaying the speed and height gauges 1010, 1030 in the same position in the display (e.g., the speed gauge 1010 on the left side of the display and the height gauge 1030 on the right side of the display), the operator will always know where to look for those gauges 1010, 1030. This layout is also consistent with the six-pack layout and primary-flight-display layout of aviation cockpits with airspeed on the left and altitude on the right of the attitude indicator. Further, as will be discussed below, a displayed color or other indicia can indicate which mode the craft is operating in. So, depending on the color or other characteristics of the display at any given time, the operator can easily and intuitively infer what mode the craft is in.

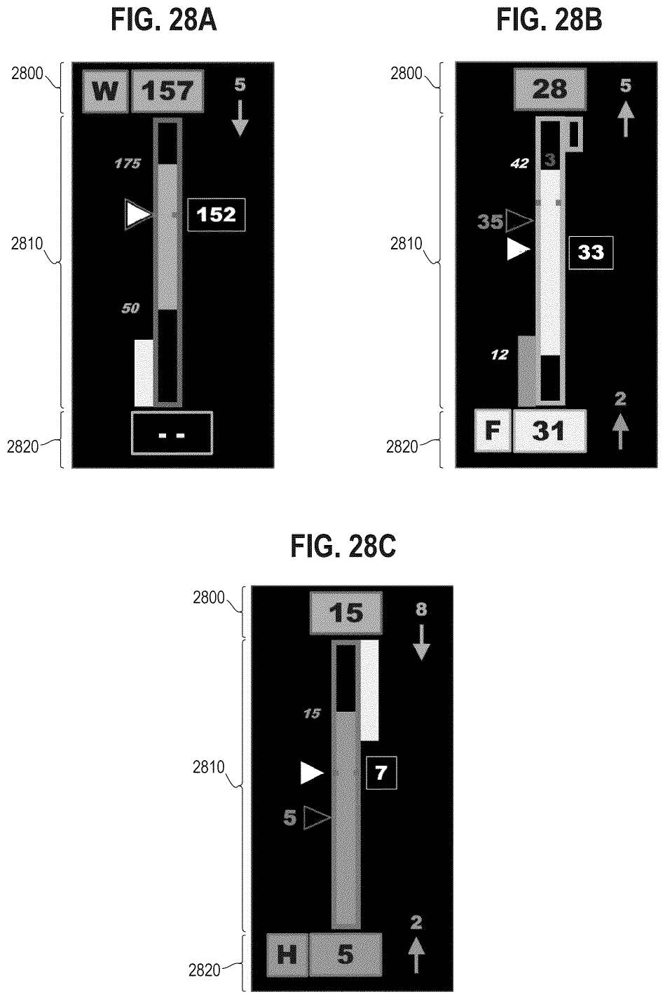

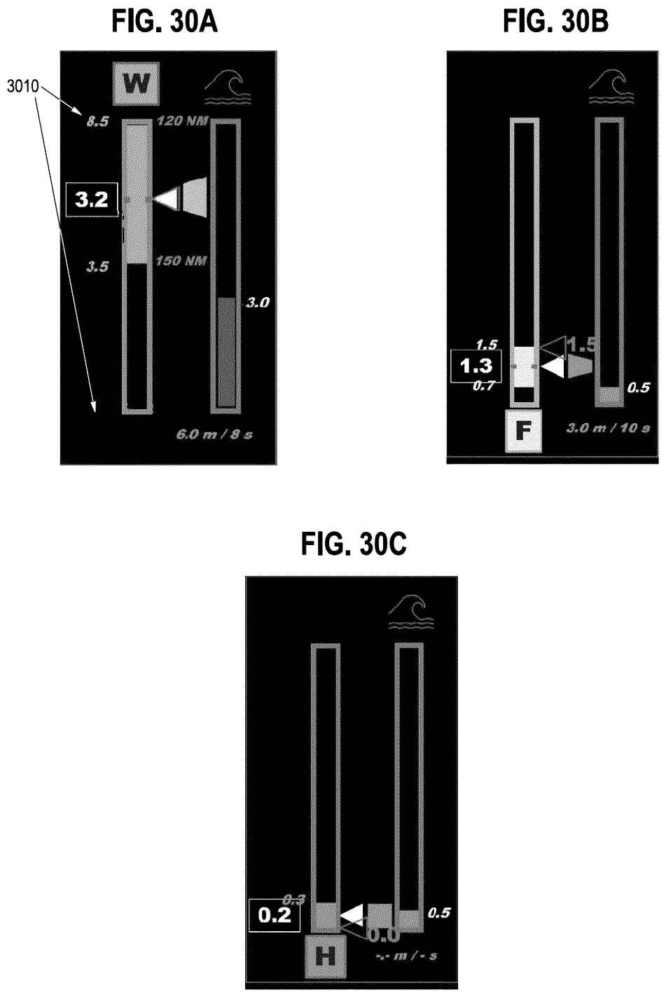

FIGS. 28A-C and 29 are illustrations of displays of various speed gauge modes of an embodiment, and FIGS. 30A-C and 31 are illustrations of displays of various height gauge modes of an embodiment. In general, according to the color/shape philosophy of this particular embodiment, modes are reflected by colors. More specifically, green represents hull mode, gray represents foil mode, and cyan represents wing mode. Also, air-related speeds are in cyan, water-related speeds are in green, and current values are in white, with groundspeed, ride height, and heading being boxed in white. Commanded (crew-selectable) items are in magenta and line-up with current (white) values when tracking (e.g., white pointers nestle inside magenta hollow pointers). Dashed magenta items are computer-recommended values (e.g., recommended speed for a route plan or recommended ride height for comfort/efficiency). Further, speeds are in knots (whole units, no decimals), and heights are in meters with one decimal place.

Turning now to FIGS. 28A-C, these drawings illustrate displays of various speed gauge modes of an embodiment. As shown in these drawings, the speed gauge comprises a first region 2800 that displays air reference information, a second region 2810 that displays earth reference information (which can be the primary method of control), and a third region 2830 that displays water reference information (which is not be available in wing mode in one embodiment).

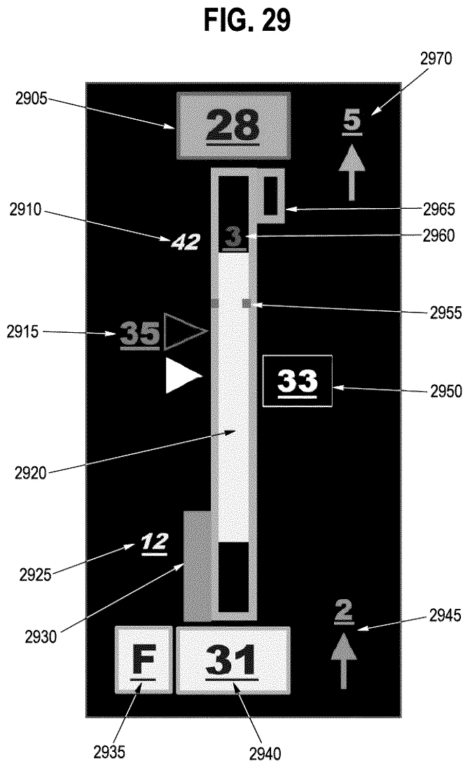

FIG. 29 is a more-detailed view of the speed gauge of FIG. 28B that illustrates various displayed indicia. As shown in FIG. 29, the speed gauge of this embodiment displays the airspeed 2905, the maximum selectable groundspeed 2910, a commanded groundspeed pointer 2915 (e.g., what the lever 1200 selects, where the value shown while adjusting the lever 1200 is plus about ten seconds), a shaded bar showing achievable groundspeed in the current mode (between min/max) 2920, a minimum selectable groundspeed for the mode 2925, an available groundspeed in a mode that is one mode down from the currently mode (here, hull mode) 2930 (this can be shown in solid if selectable or hollow if not), the current mode 2935, the water speed 2940, the water current with a head/tail component (showing the effect between two reference frames) 2945, current groundspeed and pointer on the opposite side (which can slide up/down and be nestled inside the commanded pointer when tracking groundspeed) 2950, a recommended groundspeed (e.g., based on planned arrival time and in consideration of each planned leg/mode) 2955, a speed deficit to transition modes (which can be hidden if there is no deficit) 2960, available groundspeed in one mode up (here, wing mode) (can be solid if the mode is selected and hollow if not) 2965, and a wind, head/tail component (which shows the effect between reference frames) 2970.

As mentioned above, a shaded bar can show achievable groundspeed. In one embodiment, this achievable speed bar may be dynamically determined depending on environmental conditions, in addition to changing size/position depending on the mode. In contrast, the size of the overall “tape” that the shaded bar sits inside of represents the “available speed” in theoretical/deal conditions and generally does not change in the range that it represents within a given mode.

Turning back to FIGS. 28A-C, in FIG. 28A, the color cyan indicates that the craft is in wing mode. The speed gauge indicates that the craft is flying at a commanded 152 kn groundspeed and a 157 kn airspeed, due to a 5 kn headwind. In FIG. 28B, the color gray indicates that the craft is in foil mode. The speed gauge indicates that the craft is foiling at 33 kn groundspeed but that the commanded speed is 35 kn. As such, the craft cannot take off since there is a 3 kn speed deficit due to a tail wind. In FIG. 28C, the color green indicates that the craft is in hull mode. The speed gauge indicates that the craft is traveling at 7 kn but that the commanded speed is 5 kn because of a 2 3 kn tail speed current. In this situation, the operator can choose to transition to foil mode.

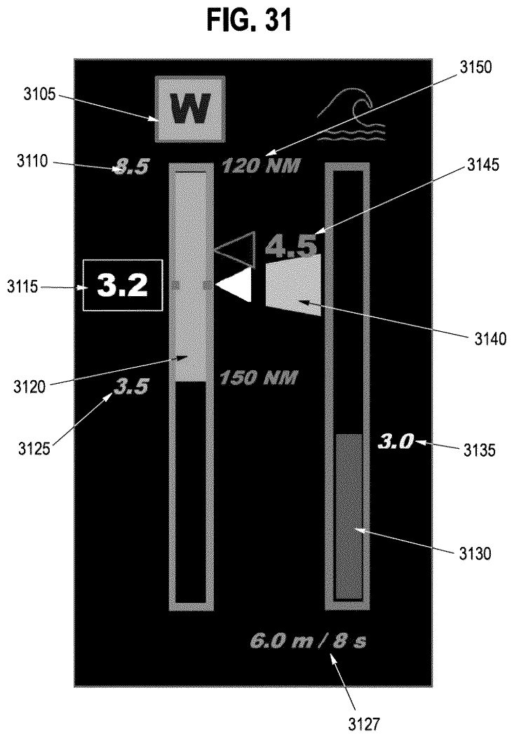

Turning now to FIGS. 30A-C, these drawings are illustrations of displays of various height gauge modes of an embodiment. As indicated by the depicted range 3010, the height gauge in this embodiment is not dynamic and always reflects the range from 0.0 (floating) to the maximum ground effect height. FIG. 31 is a more-detailed view of the height gauge of FIG. 30A. As shown in FIG. 31, the height gauge of this embodiment displays the current mode 3105, the maximum selectable right height 3110, a current ride height and white pointer on the opposite side, which is nestled inside the commanded pointer when tracking ride height 3115, a shaded bar showing achievable ride height in the current mode (between min/max) 3120, a minimal selectable ride height 3125, primary swell amplitude (half height) and period, which affects landing and contour foiling 3127, a colored bar that reflects mode ability (red=can't land (only shown in wing mode); yellow=can land but can't foil; and green=can land and foil) 3130, a maximum short period (wind-driven) amplitude (half height, affects ability to foil) 3135, a ride height tracking performance trapezoid 3140 (orange if not tracking well; green if tracking well, where the spread on the right reflects the average variance, and the left side is the same width and is centered on the white pointer to show average ride height), a commanded ride height pointer 3145 (which can be what the crew controls, where the value is shown while adjusting the lever plus about ten seconds) 3145, and an estimated range given min/max ride heights 3150.

Turning back to FIGS. 30A-C, in FIG. 30A, the color cyan indicates that the craft is in wing mode. The height gauge indicates that the craft is flying at a 3.2 meters commanded ride height and that the operator can select a ride height between 3.5 and 8.4 meters. The height gauge also indicates that the craft cannot land because the 3.0 meters wave height is indicated in red. (U.S. patent application Ser. No. 17/875,942, filed Jul. 28, 2022, which is hereby incorporated by reference, describes one suitable type of wave state estimator that can be used to estimate wave height.) In FIG. 30B, the color gray indicates that the craft is in foil mode. The height gauge indicates that the craft is foiling at a 1.3 meter ride height but that the commanded ride height is 1.5 meters. The operator can select a ride height between 0.7 and 1.5 meters. In FIG. 30C, the color green indicates that the craft is in hull mode, and the height gauge indicates a 0.2 meter ride height on the hull, but the selected floating is at 0.0 meters.

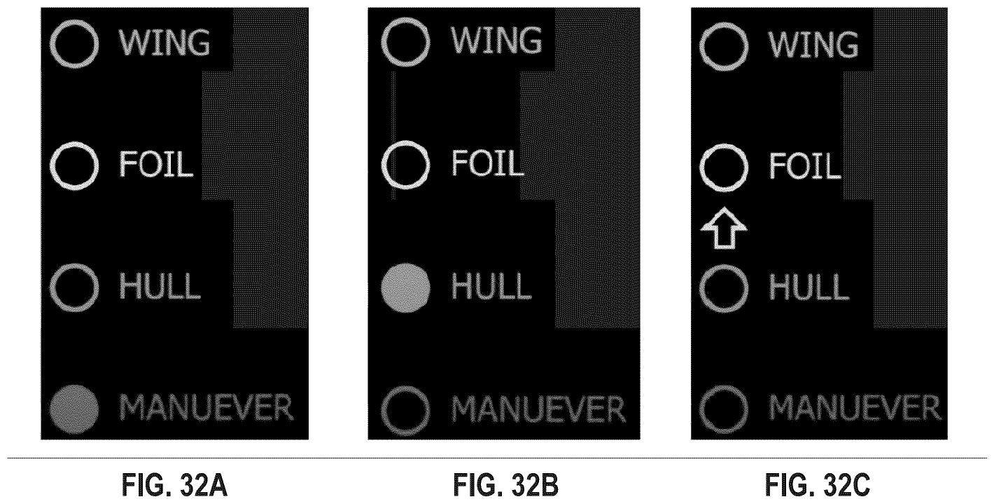

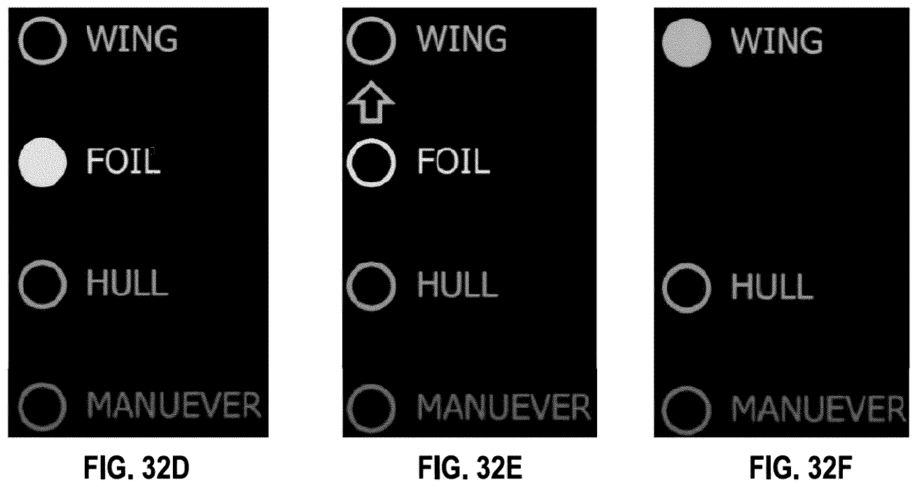

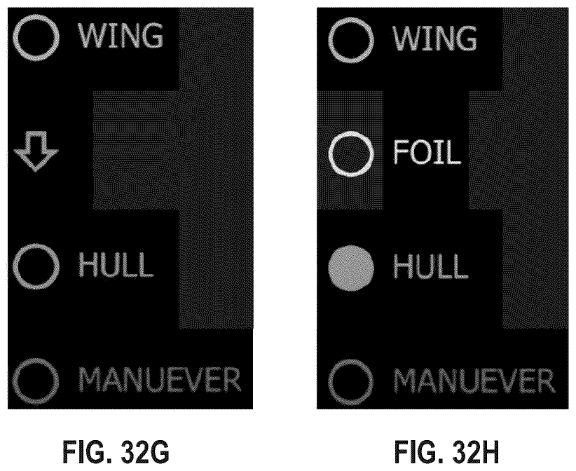

Many other alternatives are possible, which can be used individually or in combination with the above embodiment. In one alternative, a display in the cockpit outputs a toggle/color listing of available modes that changes depending on mode operation. Such a display may be provided separate from, or in combination with, any of the displays discussed elsewhere herein. FIGS. 32A-H present an example of such a display including a list of modes and mode transitions.

As shown in FIGS. 32A-H, for example, a series of vertically-arranged open circles can be displayed, with the open circles color-coded to the modes (the names of the modes can be written next to the open circles). These circles can be overlaid (temporarily or permanently) on the same cockpit display that the gauge displays are shown, or they can be displayed on a separate display region. In this example, an open circle changes to a closed (solid) circle when the craft is in the mode that corresponds to the circle.

For example, with reference to FIG. 32A, the craft may currently be in maneuver mode. Correspondingly, a closed circle is shown adjacent to the maneuver indication, whereas open circles are shown adjacent to each other mode. On the other hand, with reference to FIG. 32B, the craft may currently be in hull mode, and correspondingly a closed circle is shown adjacent to the “hull” indication.

An arrow or other indicia can appear during a mode transition to indicate that transition is ongoing from one mode to another (e.g., a flashing arrow pointing from the “maneuver mode circle” to the “hull mode circle”). For example, with reference to FIG. 32C, an arrow (understood to be flashing) is shown indicating that the craft is currently in the process of transitioning from hull to foil mode. At this time, open circles are shown adjacent to all modes, as the craft is not currently in any particular mode. Similarly, with reference to FIG. 32E, an arrow is shown indicating that the craft is currently in the process of transitioning from foil to wing mode. Such an additional transition might occur after the craft has operated for some time in foil mode, as indicated in the display shown in FIG. 32D.

As shown in FIG. 32F, when in wing mode, the foil mode circle and indication can disappear if the craft is configured to directly “down-transition” from wing mode to hull mode, as discussed above. This is because, as discussed above, in some embodiments the craft may only be capable of transitioning to hull mode from wing mode (as opposed to transitioning to foil mode). According to such an example, when the craft transitions from wing mode to hull mode, an arrow may be shown indicating that the craft is in the process of transitioning from wing mode to hull mode, as shown in FIG. 32G. After such a transitioning is complete, the display may indicate that the craft is currently operating in hull mode as shown in FIG. 32H, using a display that is similar to that discussed above with respect to FIG. 32B.

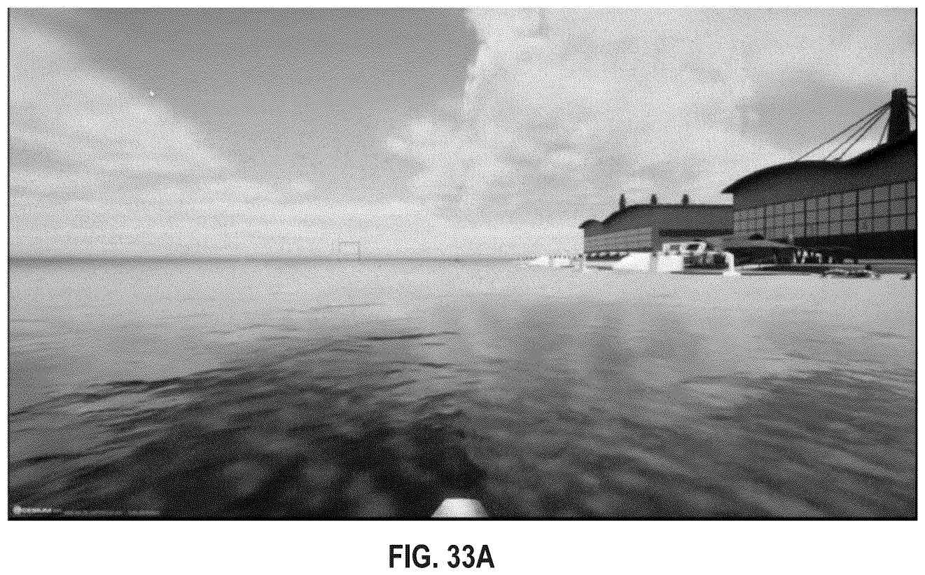

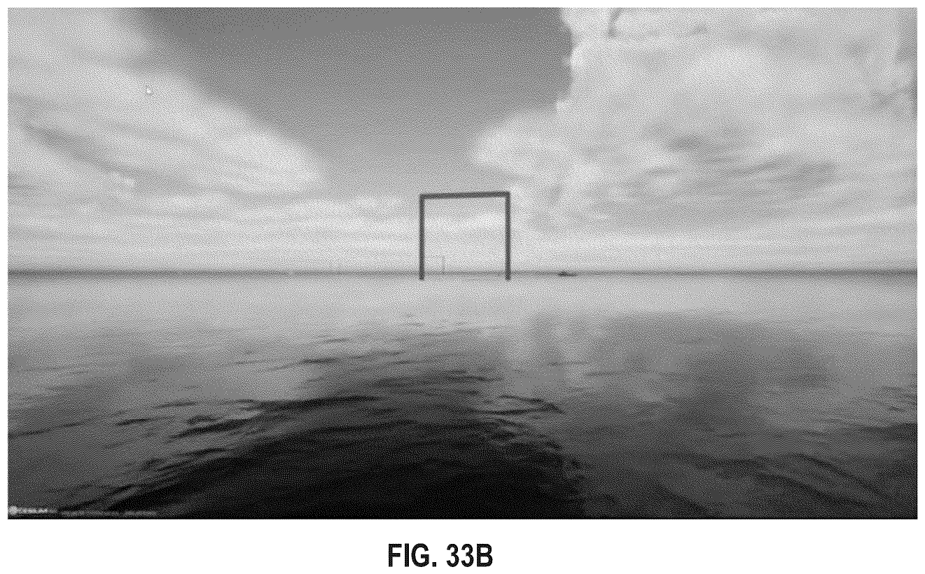

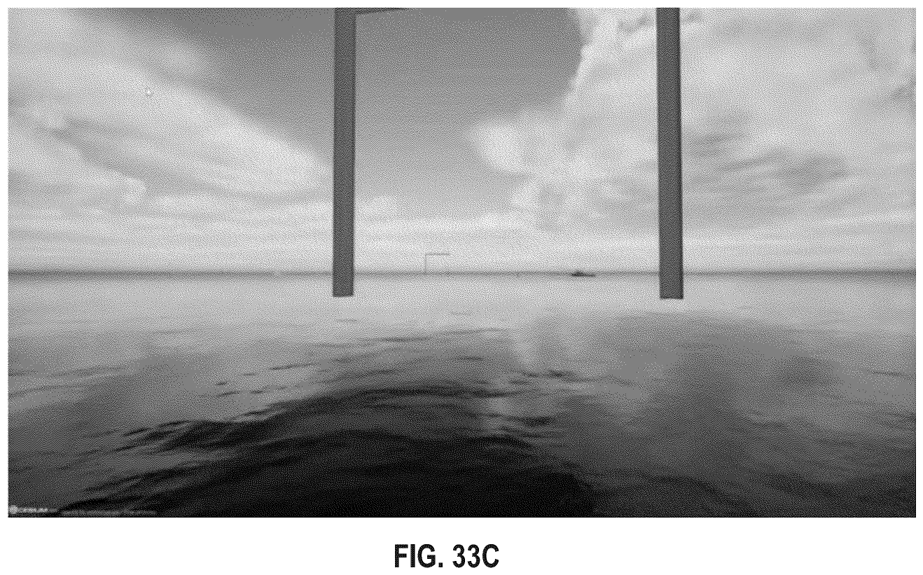

In another alternative, while in hull mode or foil mode (or in other modes), the cockpit display can provide an augmented reality navigation “target” (gate or hoop) on the horizon that the craft is to be navigated towards and through. FIGS. 33A-C show one example of such a display providing an augmented reality navigation target. In addition to an augmented reality navigation target, the display may provide other augmented reality items such as buoys, other crafts and/or ships, shallow areas, and landing and/or takeoff areas.

As shown in FIG. 33A, at a first time while on the water, perhaps in either hull mode or foil mode (while the display is relevant to other modes as well), a navigation “target” may be overlaid on top of a real time display or representation of the craft's environment. Here, a box-shaped target is shown in the distant horizon, towards which the operator may navigate the craft. As the craft navigates toward the target, the augmented reality display will update such that it appears the target remains “fixed” in the environment.

As shown in FIG. 33B, at a second time at which the craft may be understood to have navigated toward the target, the navigation target may be displayed as closer and larger as the craft approaches. Further, the display may update to include one or more additional supplemental targets that the craft may proceed towards after passing through the first target.

As shown in FIG. 33C, at a third time at which the craft may be understood to have further navigated toward the target and is “passing through” the target, the navigation target may be displayed as surrounding the craft as the craft passes through. At the same time, the display of the additional supplemental target(s) may also be updated in a similar manner as the craft continues to navigate and continues on a path towards the additional supplemental target(s).

Of course, the details discussed in connection with FIGS. 33A-C are merely examples, and other configurations can be used.

### VIII. ADDITIONAL EXAMPLE COCKPIT LAYOUT

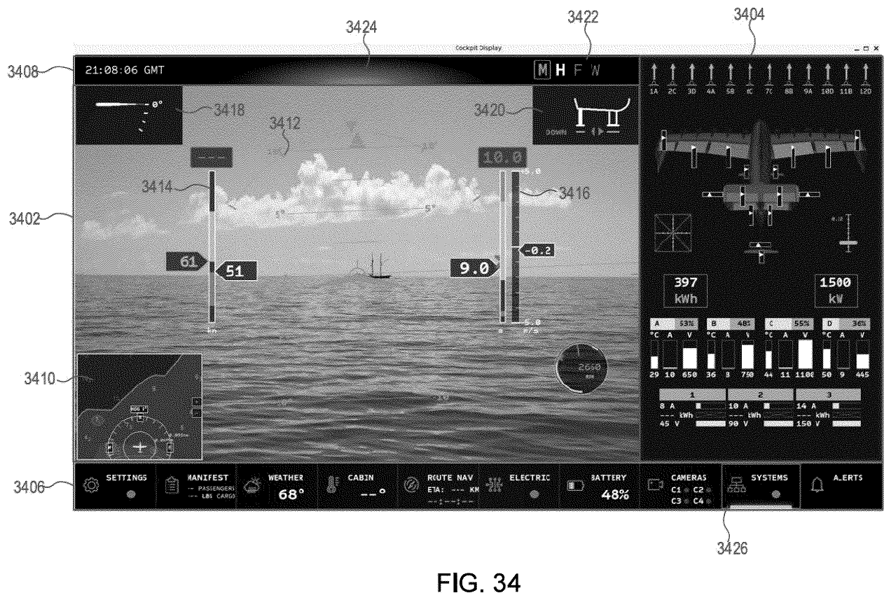

Returning to FIG. 9, FIG. 34 illustrates another implementation of a display output that may be provided to the first and second touchscreen displays 910, 920. As shown in FIG. 34, this display output includes a main display region 3402, a secondary display region 3404, a plurality of display toggle buttons 3406, and a banner region 3408. In some implementations, an orientation of at least the main display region 3402 and the secondary display region 3404 are configurable such that the secondary display region 3404 may be positioned to the right or to the left of the main display region 3402.

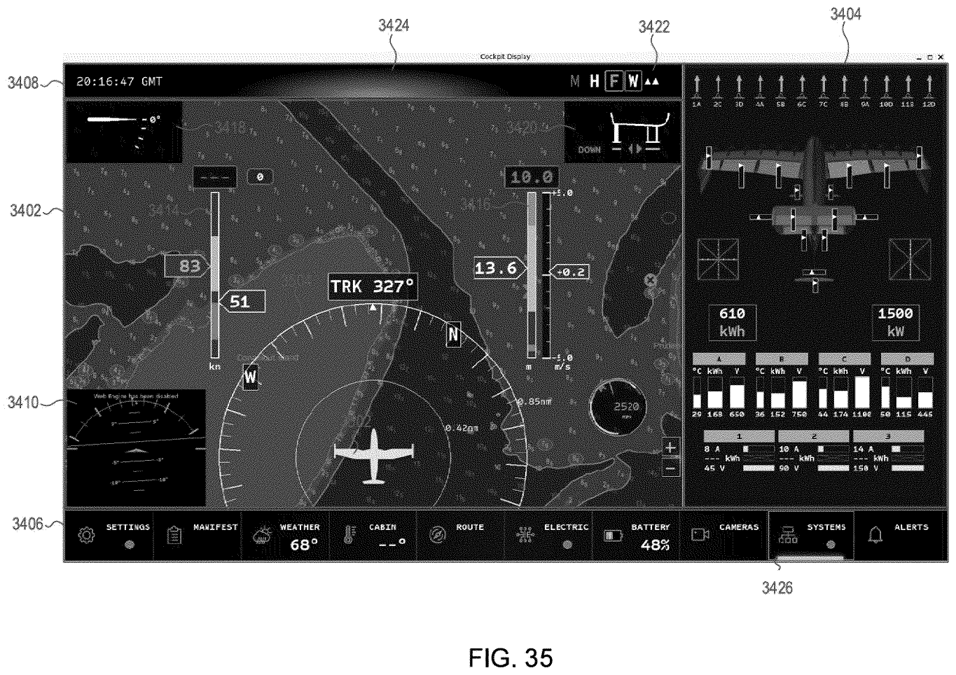

In some examples the main display region 3402 may be toggled between an augmented environment overlay view as illustrated in FIG. 34 and a map overlay view as illustrated in FIG. 35, although other variations are possible. A user may toggle between the augmented environment overlay view and the map overlay view by selecting a background display toggle button 3410, positioned in a lower left-hand corner of the main display region 3402 in the illustrative example. In some implementations, the background display toggle button 3410 itself may display information related to the environment overlay view or the map overlay view that is not presently displayed in the main display region 3402.

The augmented environment overlay view generally presents an augmented reality view of a heading of the craft. The augmented environment overlay view may include one or more illustrations of craft operational information such as, in an example, pitch and roll information, navigation information, and/or collision avoidance information 3412; a speed gauge 3414; a height gauge 3416; a flap retraction window 3418; and a foil position window 3420.

As shown in FIG. 34, the pitch and roll information and navigation information 3412 may be displayed in green in a manner that is similar to traditional navigation indicators such as aircraft attitude indicators or helmet mounted displays (HUDs).

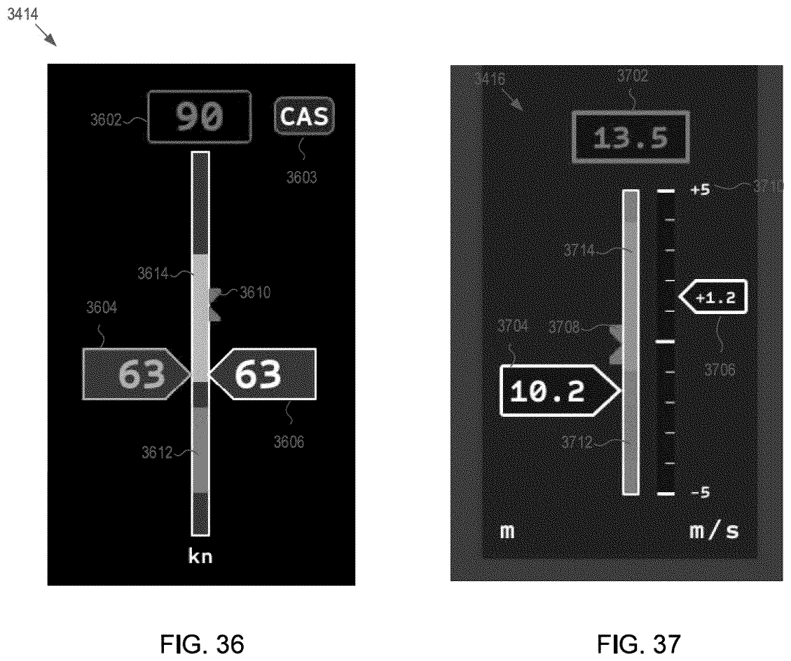

Referring to FIG. 36, the speed gauge 3414 may include a set target speed indicator 3602, a water/ground speed indicator 3604, and an air speed indicator 3606. The set target speed 3602 is displayed in magenta and is positioned at a top of the speed gauge 3414. Adjacent to the set target speed 3602 may also be symbols 3603 indicating whether the set target speed 3602 is displayed as a calibrated airspeed (CAS) or an indicated airspeed (IAS).

The air speed indictor 3606 is displayed in white and is positioned on a right side of the speed gauge 3414. A set air speed indicator 3610 may also be positioned on a right side of the speed gauge 3414. The set air speed indicator 3610 may be a magenta arrow that allows a user to quickly visually identify a current air speed 3606 relative to the set air speed 3610.

The water/ground speed indicator 3604 is displayed in cyan and is positioned on a left side of the speed gauge 3414. A set water/ground speed indicator (not shown) may also be positioned on the left side of the speed gauge 3414. In some implementations, the set air speed indicator 3610 or the set water/ground speed indictor will be displayed on the right side or the left side of the speed gauge 3414 depending on whether the air speed or the water/ground speed is currently controlling.

The air speed gauge 3414 may additionally include a vertical on-water speed range bar 3612 and a vertical air speed range bar 3614. The vertical on-water speed range bar 3612 is displayed in cyan and conveys a representative range of available water/ground speed available to the craft while operating in a hull-borne mode of operation and/or a hydrofoiling mode of operation. The vertical air speed range bar 3614 is displayed in grey and illustrates a representative range of available air speed available to the craft while the craft is flying in a wing mode of operation.

In some implementations, the speeds provided in the speed gauge 3414 are provide in knots as indicated at a bottom of the speed gauge 3414. However, other units of speed could be utilized in other implementations.

Referring to FIG. 37, the height gauge 3416 may include a set target height 3702, a current height indicator 3704, and an indicator showing a speed at which a height is changing (vertical speed) 3706. The set target height 3702 is displayed in magenta and is positioned at a top of the height gauge 3416.

The current height indicator 3704 is displayed in white and is positioned on a left side of the height gauge 3416. A set target height indicator 3708 may also be positioned on a left side of the height gauge 3416. The set target height indicator 3708 may be a magenta arrow that allows a user to quickly visually identify a current height 3704 vs a set height 3708.

The indicator showing a speed at which a height is changing 3706 is displayed in white and positioned on a right side of the height gauge 3416. The speed at which a height is changing 3706 may be shown relative to a displayed range of positive and negative speeds 3710.

The height gauge 3416 may additionally include an on-water height range bar 3712 and a vertical flying height range bar 3714. The on-water height range bar 3712 is shown in cyan and conveys a representative range of available height to the craft while operating on the water in a hydrofoiling mode or hull mode of operation, for example. The vertical flying height range bar 3714 is shown in gray and conveys a representative range of height (or altitude) available to the craft while the craft is flying in a wing mode of operation.

In some implementations, the left side of the height gauge 3416 may present information in meters and the right side of the height gauge 3416 may present information in meters per second. However, other units of height and accelerations could be utilized in other implementations.

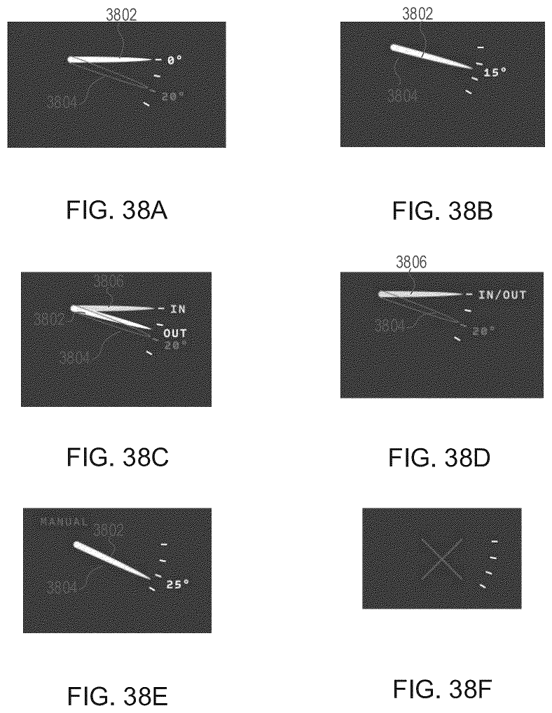

Referring to FIGS. 34, 35, and 38A-38F, a flap retraction window 3418 may include a current flap state 3802, a set flap position 3804, and/or an abnormal flap state position 3806 of the aerodynamic flaps on a wing of the craft. Referring to FIG. 38A, for example, a current flap state 3802 is displayed in white and a set flap position 3904 is displayed in magenta. In FIG. 38A, the current flap state 3802 is transitioning to the set flap position 3804 of 20 degrees. In FIG. 38B, the current flap state 3802 is positioned at the set flap position 3804 of 15 degrees.

In FIGS. 38C and 38D, in addition to the set flap position 3804, the abnormal flap state position 3806 is displayed in yellow. When only one of the flaps has failed, as shown in FIG. 38C, both the current flap state 3802 and the abnormal flap state position 3806 are shown with “In” or “Out” labels to identify which of an inner or outer aerodynamic flaps of the wing (or inboard or outboard flaps) is abnormally positioned. Alternatively, referring to FIG. 38D, when both flaps are abnormally positioned, both flaps are illustrated by the abnormal flap state position 3806 with both the “In” and “Out” labels adjacent to the abnormal flap state position 3806.

FIG. 38E illustrates a current flap state 3802 and set flap position 3804 when a flap is moved manually as indicated by the “MANUAL” indicator in the top left portion and FIG. 38F illustrates a display when a position of the flap is unknown.

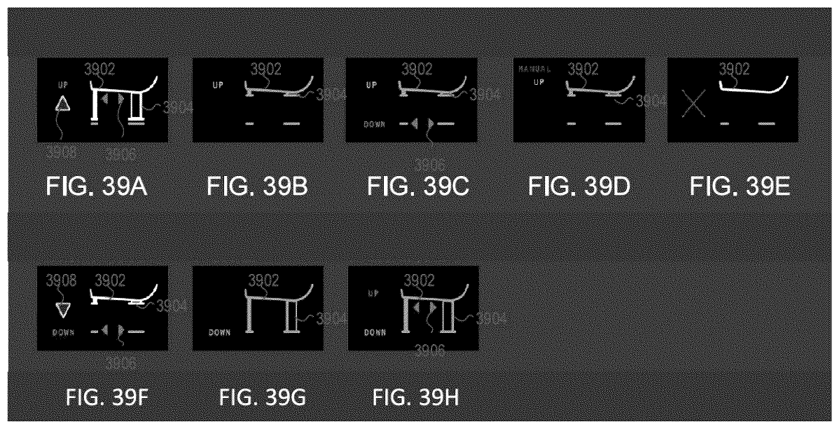

Referring to FIGS. 34, 35, and 39A-39H, the foil position window 3420 allows an operator to quickly understand a state and position of one or more of the hydrofoils of a craft. As shown in FIG. 39A, the foil position window 3420 may illustrate a partial representation of the craft hull 3902 and a position of the foil 3904. In implementations such as FIG. 39A where the foil is transitioning between positions, the craft hull 3902 and foils 3904 are shown in white. However, in other states, such as in FIG. 39B discussed below where the foils are in a locked position, the craft hull 3902 and foils 3904 are shown in green.

As shown in FIG. 39A, the foil position window 3420 may additionally include a set foil position 3906 and a directional movement indicator 3908. The set foil position 3906 is shown in magenta and allows an operator to visually determine a position of the foils 3904 in relation to the set foil position 3906. The directional movement indicator 3908 is displayed in yellow and may be a triangle pointing in a direction of movement of the foils. The direction movement indicator may additionally include text such as “UP” or “DOWN” and serves to caution an operator that the foils should not be loaded (e.g., the craft should not move through water) while the foils are transitioning at this time.

FIG. 39A illustrates the foil position window 3420 when the foils are unlocked and transitioning from a down position to an up position.

FIG. 39B illustrates the foil position window 3420 when the foils are in an up position and locked.

FIG. 39C illustrates the foil position window 3420 when the foils are in an up position and locked, but an operator has set a command to lower the foils.

FIG. 39D illustrates the foil position window 3420 when the foils are in an up position and locked, but being manually controlled.

FIG. 39E illustrates the foil position window 3420 when a position of the foils is unknown.

FIG. 39F illustrates the foil position window 3420 where the foils are unlocked and transitioning from an up position to a down position.

FIG. 39G illustrates the foil position window 3420 where the foils are locked in a down position.

FIG. 39H illustrates the foil position window 3420 where the foils are locked in a down position, but an operator has set an up command to transition the foils to an up position.

Referring again to FIG. 34 and FIG. 35, it will be appreciated that the speed gauge 3414, the height gauge 3416, the flap retraction window 3418, and the foil position window 3420 described above may be displayed in the same position in the main display region 3402 as the user toggles between the augmented environment overlay view as illustrated in FIG. 34 and the map overlay view as illustrated in FIG. 35.

Referring to FIG. 35, the map overlay view presents a bird's eye view of the craft 3502 heading or ground track on top of a chart such as a chart representing a surrounding environment. In some implementations, the chart may be a nautical chart, however other types of charts and/or maps could also be used. Directional elements 3504 surrounding the craft 3502 may include compass/directional information. In some implementations, the craft 3502 and direction elements 3504 are displayed in white.

In some implementations, ground track (TRK) information is presented in the map view overlay instead of a technical heading. However, based on user selection, other information could be displayed such as magnetic heading (HDG) information.

Referring again to FIGS. 34 and 35, the banner region 3408 may include an operating mode indicator 3422 and an alert indication area 3424.

The operating mode indicator 3422 remains present when the main display region 3402 displays the augmented environment overlay view or the map overlay view so that an operator can quickly obtain determine what mode the craft is operating in as well as whether or not a different mode has been commanded and/or if the craft is transitioning between modes.

Referring to FIGS. 34, 35, 40A and 40B, the operating mode indicator 3422 may include a series of symbols 4002 representing different operating modes as well as symbols 4004 indicating substates of a transition. For example, the series of symbols 4002 may include the symbols M, H, F, and W, where M stands for maneuver operation mode, H stands for a hull-borne operation mode, F stands for hydrofoil-borne operation mode, and W stands for wing-borne operation mode, as described above. The symbols may be colored such as a current mode is shown in green, bold, and boxed in green.

Modes that are available for the craft to transition into are shown in white. It will be appreciated that a craft is not able to transition into all modes at all times so only those modes that are available for the craft to transition into are shown in white. For example, in FIG. 40A, when in maneuver mode, the craft may only transition into hull mode. Accordingly, the H for hull mode is displayed in white where the F for hydrofoil mode and the W for wing mode are shown in grey. Similarly, in FIG. 40B, when in hydrofoil mode, the craft may only transition into hull mode and wing mode so the related symbols are shown in white. The craft may not transition from hydrofoil mode into maneuver mode so the related M symbol is shown in grey.

When a command is provided for the craft to transition into an available mode, the selected mode is boxed in magenta. For example, in FIG. 40B, the craft is currently in hydrofoil mode and a command has been set to transition the craft into wing mode. Accordingly, the related symbol F for hydrofoil mode has been boxed in green and the related symbol W for wing mode has been boxed in magenta.

In an addition example not illustrated, when a craft is operating in wing mode, the W symbol is shown in green, bold, and boxed in green. Because the craft is able to transition from the wing-borne mode to the hull-borne mode, the H symbol would be shown in white. Because the craft is not able to transition from the wing-borne mode into the hydrofoil-borne mode and the maneuver operation mode, the F and the M symbols are shown in grey.

The symbols 4004 indicating substates of a transition are positioned adjacent to the symbols 4002 representing different operating modes. In some implementations, the symbols 4004 indicating substates of a transition may be multiple (e.g., three) arrows pointing upward or downward based on whether a craft is transitioning upward, such as from a foil mode to a wing mode, or downward, such as from a foil mode to a hull mode. Referring to FIG. 40B, a craft is transitioning from a foil mode (F) to a wing mode (W). The transition may include three substates of: 1. accelerate on the water, 2. takeoff, and 3. climb to altitude. In FIG. 40B, the craft is in the second substate of taking off. Accordingly, two of the three arrows are shown in white. After the craft has taken off and begins to climb to altitude, the craft would enter the third substate and the third triangle of the symbols 4002 representing different operating modes would be shown in white.

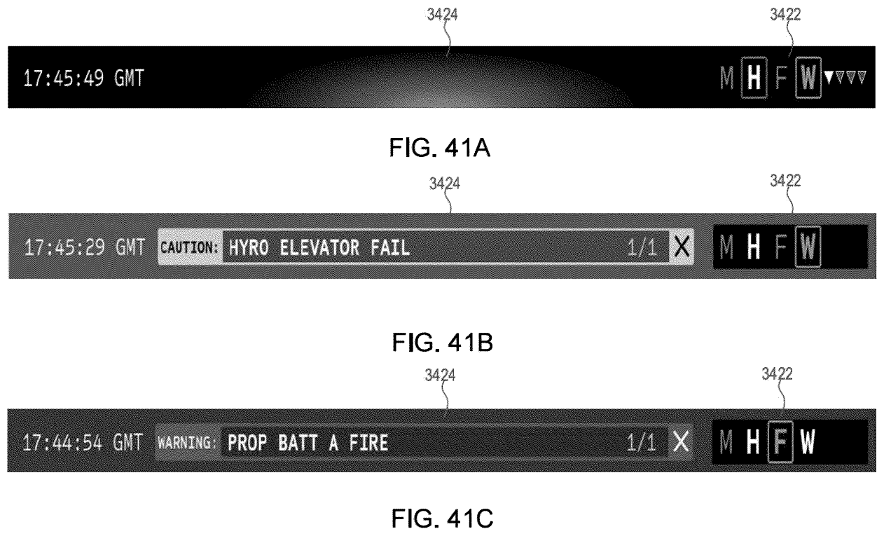

Referring again to FIGS. 34 and 35, like the operating mode indicator 3422, the alert indication area 3424 of the banner region 3408 remains present when the main display region 3402 displays the augmented environment overlay view or the map overlay view so that an operator may quickly review and system alerts or warnings. Referring to FIGS. 34, 35, and 41A-C, when a system is operating normally, the alert indication area 3408 is empty and appears in grey with no message as shown in FIG. 41A.

However, when a cautionary alert is provided to the operator, the alert is provided in the alert indication area 3424 in amber (yellow) as shown in FIG. 41B. Similarly, when a warning is provided to the operator, the alert is provided in the alert indication area 3424 in red as shown in FIG. 41C.

Referring again to FIGS. 34 and 35, the secondary display 3404 and the plurality of display toggle buttons 3406 also remain present when the main display region 3402 displays the augmented environment overlay view or the map overlay view. The secondary display 3404 and the plurality of display toggle buttons 3406 operate in conjunction with each other such that when an operator activates one of the display toggle buttons 3406, information associated with the selected display toggle button is displayed on the secondary display 3404. For example, in FIG. 34, the SYSTEMS toggle button 3426 is actuated and information corresponding to the SYSTEMS toggle button 3426 is displayed in the secondary display 3404.

Other example display toggle buttons that may be actuated for the display of associated information in the secondary display 3404 include a SETTINGS button, a MANIFEST button, a WEATHER button, a CABIN button (e.g., cabin temperature), a ROUTE button, an ELECTRIC button (e.g., electrical systems), a CAMERAS button, and/or an ALERTS button. However, any display toggle button may be provided for information available to display on the secondary display 3404.

In some implementations, the plurality of display toggle buttons 3406 may additionally provide data associated with the relevant display toggle button. For example, the setting button, electrical system button, and system button may include a colored dot representing a status of the system associated with the button; the weather button may include an icon representing a current weather status as well as a current temperature; and the battery button may include a visual representation of a battery charge as well we a numerical representation of the battery charge.

### IX. CONCLUSION

While the systems and methods of operation have been described with reference to certain examples, it will be understood by those skilled in the art that various changes can be made, and equivalents can be substituted without departing from the scope of the claims. Therefore, it is intended that the present methods and systems not be limited to the particular examples disclosed, but that the disclosed methods and systems include all embodiments falling within the scope of the appended claims.

As discussed above, in one aspect, the present disclosure provides a craft comprising a user input device; a display device; at least one processor; a non-transitory computer-readable medium; and program instructions stored on the non-transitory computer-readable medium.

When the program instructions are executed by the at least one processor, they cause the at least one processor to: transition from a first mode of operating the craft to a second mode of operating that craft in response to actuation of the user input device; and dynamically change a display generated on the display device in response to the transition from the first mode of operating the craft to the second mode of operating the craft, wherein the display comprises a speed gauge, wherein a range of the speed gauge is dynamically changed in response to the transition.

In some implementations, the first and second modes are different ones of maneuver mode, hull mode, foil mode, or wing mode.

In some implementations, the program instructions, when executed by the at least one processor, further cause the at least one processor to generate an audio signal indicating a status of the transition.

In some implementations, the audio signal indicates that the transition is in progress.

In some implementations, the audio signal indicates that the transition is complete.

In some implementations, the display is dynamically changed by changing a display color from a color representing the first mode of operating the craft to a second color representing the second mode of operating the craft.

In some implementations, the program instructions, when executed, further cause the at least one processor to provide feedback on a progress of the transition.

In some implementations, different displayed colors are used to display air-related metrics, water-related metrics, actual values, commanded values, or recommended values.

In some implementations, the user input device comprises a lever.

In some implementations, the program instructions, when executed by the at least one processor, further cause the at least one processor to change a power or a speed of the craft in response to movement of the user input device in a movement range designated for changing the power or speed.

In some implementations, the user input device is positionable in a lower detent, a main detent, and an upper detent, wherein a lower gate is configured to provide physical resistance to the user input device in moving from the lower detent to the main detent, and wherein an upper gate is configured to provide physical resistance to the user input device in moving from the main detent to the upper detent.

In some implementations, the display further comprises a height gauge that does not dynamically change in response to the transition.

In some implementations, the display further comprises a height gauge that dynamically changes in response to the transition.

As described above, in another aspect, the present disclosure provides a method comprising performing in a control system of a craft comprising a user input device and a speaker receiving a signal indicating movement of the user input device; attempting to transition from a first mode of operating the craft to a second mode of operating that craft in response to receiving the signal; and generating audio via the speaker to provide feedback on the attempt to transition.

In some implementations, the audio comprises a tone or spoken alert indicating that the transition is in progress.

In some implementations, the audio comprises a tone indicating that the transition is complete.

In some implementations, the audio comprises a tone indicating that the transition has been aborted or has failed.

As described above, in a further aspect, the present disclosure provides a craft comprising: a lever positionable in a lower detent, a main detent, and an upper detent, wherein a first gate is configured to provide physical resistance in moving the lever from the lower detent to the main detent and a second gate is configured to provide physical resistance in moving the lever from the main detent to the upper detent; a user interface device; at least one processor; a non-transitory computer-readable medium; and program instructions stored on the non-transitory computer-readable medium.

When executed by the at least one processor, the program instructions cause the at least one processor to: transition the craft from maneuver mode to hull mode in response to the lever being moved from the lower detent to the main detent when the craft is in maneuver mode; transition the craft from hull mode to foil mode in response to the lever being moved from the main detent to the upper detent when the craft is in hull mode; and transition the craft from foil mode to wing mode in response to the lever being again moved from the main detent to the upper detent when the craft is in wing mode. The program instructions further cause the at least one processor to: change a power or a speed of the craft in response to movement of the lever within the main detent; and generate an output via the user interface device in response to movement of the lever.

In some implementations, the user interface device comprises a display device and generating the output comprises dynamically changing a display outputted on the display device to provide a visual indication of a transition from one mode to another mode.

In some implementations, dynamically changing the display comprises changing a displayed color that represents a current mode.

In some implementations, dynamically changing the display comprises changing a range of values of a displayed gauge.

In some implementations, the user interface device comprises a speaker, and wherein generating the output comprising playing a tone indicating an opportunity to abort a mode transition.

In some implementations, the craft further comprises program instructions stored on the non-transitory computer-readable medium that, when executed by the at least one processor, cause the at least one processor to generate a display on the user interface device, the display comprising a speed gauge (such as, in an example, speed gauge 3414), the speed gauge comprising a first region (such as, in an example, on-water speed range bar 3612) and a second region (such as, in an example, air speed range bar 3614), wherein the first region corresponds to a representative range of speed available while the craft is in a first mode of operation, and wherein the second region corresponds to a representative range of speed available while the craft is in a second mode of operation.

Generating the output via the user interface device in response to movement of the lever comprises: dynamically changing the display generated on the user interface device in response to movement of the lever, such that: while the craft is in the first mode of operation, a set speed gauge (such as, in an example, set speed indicator 3610) is displayed adjacent the first region, and while the craft is in the second mode of operation, the set speed gauge is displayed adjacent the second region.

In some implementations, the display further comprising a height gauge (such as, in an example, height gauge 3416), the height gauge comprising a first region (such as, in an example, height range bar 3712) and a second region (such as, in an example, height range bar 3714), wherein the first region corresponds to a representative range of height available while the craft is in the first mode of operation, and wherein the second region corresponds to a representative range of height available while the craft is in the second mode of operation.

In some implementations, dynamically changing the display generated on the user interface device in response to the transition from the first mode of operating the craft to the second mode of operating the craft further comprises dynamically changing the display generated on the user interface device in response to the transition from the first mode of operating the craft to the second mode of operating the craft, such that: while the craft is in the first mode of operation, a set height gauge (such as, in an example, set target height indicator 3708) is displayed adjacent the first region, and while the craft is in the second mode of operation, the set height gauge is displayed adjacent the second region.

In some implementations, the display further comprising a foil position indicator (such as, in an example, foil position window 3420), the foil position indicator comprising at least (a) a state of the hydrofoil and (b) a position of the hydrofoil.

In some implementations, dynamically changing the display generated on the user interface device in response to the transition from the first mode of operating the craft to the second mode of operating the craft further comprises dynamically changing the display generated on the user interface device in response to the transition from the first mode of operating the craft to the second mode of operating the craft, such that: while the craft is in the first mode of operation, the state of the hydrofoil comprises locked and the position of the hydrofoil comprises a down position (such as, in an example, as shown in FIG. 39G); and while the craft is in the second mode of operation, the state of the hydrofoil comprises locked and the position of the hydrofoil comprises an up position (such as, in an example, as shown in FIG. 39B).

As discussed above, in a further aspect, the present disclosure provides a craft comprising a user input device; a display device; at least one processor; a non-transitory computer-readable medium; and program instructions stored on the non-transitory computer-readable medium.

When executed by the at least one processor, the program instructions cause the at least one processor to: generate a display on the display device, the display comprising a speed gauge (such as, in an example, speed gauge 3414), the speed gauge comprising a first region (such as, in an example, on-water speed range bar 3612) and a second region (such as, in an example, air speed range bar 3614), wherein the first region corresponds to a representative range of speed available while the craft is in a first mode of operation, and wherein the second region corresponds to a representative range of speed available while the craft is in a second mode of operation; and transition from the first mode of operating the craft to the second mode of operating that craft in response to actuation of the user input device.

When executed by the at least one processor, the program instructions further cause the at least one processor to: dynamically change the display generated on the display device in response to the transition from the first mode of operating the craft to the second mode of operating the craft, such that: while the craft is in the first mode of operation, a set speed gauge (such as, in an example, set speed indicator 3610) is displayed adjacent the first region, and while the craft is in the second mode of operation, the set speed gauge is displayed adjacent the second region.

In some implementations, the display further comprises a height gauge (such as, in an example, height gauge 3416), the height gauge comprising a first region (such as, in an example, height range bar 3712) and a second region (such as, in an example, height range bar 3714), wherein the first region corresponds to a representative range of height available while the craft is in the first mode of operation, and wherein the second region corresponds to a representative range of height available while the craft is in the second mode of operation.

In some implementations, dynamically changing the display generated on the display device in response to the transition from the first mode of operating the craft to the second mode of operating the craft further comprises dynamically changing the display generated on the display device in response to the transition from the first mode of operating the craft to the second mode of operating the craft, such that: while the craft is in the first mode of operation, a set height gauge (such as, in an example, set target height indicator 3708) is displayed adjacent the first region, and while the craft is in the second mode of operation, the set height gauge is displayed adjacent the second region.

In some implementations, the display further comprises a foil position indicator (such as, in an example, foil position window 3420), the foil position indicator comprising at least (a) a state of the hydrofoil and (b) a position of the hydrofoil.

In some implementations, dynamically changing the display generated on the display device in response to the transition from the first mode of operating the craft to the second mode of operating the craft further comprises dynamically changing the display generated on the display device in response to the transition from the first mode of operating the craft to the second mode of operating the craft, such that: while the craft is in the first mode of operation, the state of the hydrofoil comprises locked and the position of the hydrofoil comprises a down position (such as, in an example, as shown in FIG. 39G); and while the craft is in the second mode of operation, the state of the hydrofoil comprises locked and the position of the hydrofoil comprises an up position (such as, in an example, as shown in FIG. 39B).

In some implementations, the user input device comprises a lever positionable in a lower detent, a main detent, and an upper detent, wherein a first gate is configured to provide physical resistance in moving the lever from the lower detent to the main detent and a second gate is configured to provide physical resistance in moving the lever from the main detent to the upper detent.

In some implementations, the craft comprises program instructions stored on the non-transitory computer-readable medium that, when executed by the at least one processor, cause the at least one processor to: transition the craft from the first mode of operation to the second mode of operation in response to one of: (a) the lever being moved from the main detent to the lower detent; and (b) the lever being moved from the main detent to the upper detent.

As discussed above, in a further aspect, the present disclosure provides a craft comprising: a user input device; a display device; at least one processor; a non-transitory computer-readable medium; and program instructions stored on the non-transitory computer-readable medium.

When executed by the at least one processor, the program instructions cause the at least one processor to: generate a display on the display device, the display comprising a height gauge (such as, in an example, height gauge 3416), the height gauge comprising a first region (such as, in an example, height range bar 3712) and a second region (such as, in an example, height range bar 3714), wherein the first region corresponds to a representative range of height available while the craft is in a first mode of operation, and wherein the second region corresponds to a representative range of height available while the craft is in a second mode of operation; and transition from the first mode of operating the craft to the second mode of operating that craft in response to actuation of the user input device.

When executed by the at least one processor, the program instructions further cause the at least one processor to: dynamically change the display generated on the display device in response to the transition from the first mode of operating the craft to the second mode of operating the craft, such that: while the craft is in the first mode of operation, a set height gauge (such as, in an example, set target height indicator 3708) is displayed adjacent the first region, and while the craft is in the second mode of operation, the set height gauge is displayed adjacent the second region.

In some implementations, the user input device comprises a lever positionable in a lower detent, a main detent, and an upper detent, wherein a first gate is configured to provide physical resistance in moving the lever from the lower detent to the main detent and a second gate is configured to provide physical resistance in moving the lever from the main detent to the upper detent.

In some implementations, the craft further comprising program instructions stored on the non-transitory computer-readable medium that, when executed by the at least one processor, cause the at least one processor to: transition the craft from the first mode of operation to the second mode of operation in response to one of: (a) the lever being moved from the main detent to the lower detent; and (b) the lever being moved from the main detent to the upper detent.

As discussed above, in a further aspect, the present disclosure provides a craft comprising: a user input device; a display device; at least one processor; a non-transitory computer-readable medium; and program instructions stored on the non-transitory computer-readable medium.

When executed by the at least one processor, the program instructions cause the at least one processor to: generate a display on the display device, the display comprising an indicator, the indicator comprising a first region and a second region, wherein the first region corresponds to a representative range of values available while the craft is in a first mode of operation, and wherein the second region corresponds to a representative range of values available while the craft is in a second mode of operation; and transition from the first mode of operating the craft to the second mode of operating that craft in response to actuation of the user input device.

When executed by the at least one processor, the program instructions further cause the at least one processor to dynamically change the display generated on the display device in response to the transition from the first mode of operating the craft to the second mode of operating the craft, such that: while the craft is in the first mode of operation, a set indicator is displayed adjacent the first region, and while the craft is in the second mode of operation, the set indicator is displayed adjacent the second region.

As described above, in a further aspect, the present disclosure provides a craft comprising: a hydrofoil; a user input device; a display device; at least one processor; a non-transitory computer-readable medium; and program instructions stored on the non-transitory computer-readable medium.

When executed by the at least one processor, the program instructions cause the at least one processor to: generate a display on the display device, the display comprising a foil position indicator (such as, in an example, foil position window 3420), the foil position indicator comprising at least (a) a state of the hydrofoil and (b) a position of the hydrofoil; and transition from a first mode of operating the craft to a second mode of operating that craft in response to actuation of the user input device.

When executed by the at least one processor, the program instructions further cause the at least one processor to dynamically change the display generated on the display device in response to the transition from the first mode of operating the craft to the second mode of operating the craft, such that: while the craft is in the first mode of operation, the state of the hydrofoil comprises locked and the position of the hydrofoil comprises a down position (such as, in an example, as shown in FIG. 39G); and while the craft is in the second mode of operation, the state of the hydrofoil comprises locked and the position of the hydrofoil comprises an up position (such as, in an example, as shown in FIG. 39B).

In some implementation, the user input device comprises a lever positionable in a lower detent, a main detent, and an upper detent, wherein a first gate is configured to provide physical resistance in moving the lever from the lower detent to the main detent and a second gate is configured to provide physical resistance in moving the lever from the main detent to the upper detent.

In some implementations, the craft further comprises program instructions stored on the non-transitory computer-readable medium that, when executed by the at least one processor, cause the at least one processor to transition the craft from the first mode of operation to the second mode of operation in response to one of: (a) the lever being moved from the main detent to the lower detent; and (b) the lever being moved from the main detent to the upper detent.

As described above, in yet another aspect, the present disclosure provides a craft comprising a user input device; a display device; at least one processor; a non-transitory computer-readable medium; and program instructions stored on the non-transitory computer-readable medium.

When executed by the at least one processor, the program instructions cause the at least one processor to: generate a display on the display device, the display comprising an operating mode indicator (such as, in an example, operating mode indicator 3422) comprising a set of at least three symbols, the set of symbols comprising a first-mode symbol corresponding to a first mode of operating the craft, a second-mode symbol corresponding to a second mode of operating the craft, and a third-mode symbol corresponding to a third mode of operating the craft; and transition from the second mode of operating the craft to the third mode of operating that craft in response to actuation of the user input device.

When executed by the at least one processor, the program instructions further cause the at least one processor to: dynamically change the display generated on the display device in response to the transition from the first mode of operating the craft to the second mode of operating the craft, such that: while the craft is in the second mode of operation, the second-mode symbol indicates that the craft is in the second mode of operation, the first-mode symbol indicates that the craft may transition to the first mode of operation, and the third-mode symbol indicates that the craft may transition to the third mode of operation; and while the craft is in the third mode of operation, the third-mode symbol indicates that the craft is in the third mode of operation, the first-mode symbol indicates that the craft may transition to the first mode of operation, and the second-mode symbol indicates that the craft may not transition to the second mode of operation.

In some implementations, the user input device comprising a lever positionable in a lower detent, a main detent, and an upper detent, wherein a first gate is configured to provide physical resistance in moving the lever from the lower detent to the main detent and a second gate is configured to provide physical resistance in moving the lever from the main detent to the upper detent.

In some implementations, the craft comprises program instructions stored on the non-transitory computer-readable medium that, when executed by the at least one processor, cause the at least one processor to transition the craft from the first mode of operation to the second mode of operation in response to one of: (a) the lever being moved from the main detent to the lower detent; and (b) the lever being moved from the main detent to the upper detent.

As described above, in an additional aspect, the present disclosure provides a craft comprising: a user input device movable in a plurality of regions, wherein each region is separated from at least one other region by a respective gate configured to provide physical resistance in moving the user input device between regions; at least one processor; a non-transitory computer-readable medium; and program instructions stored on the non-transitory computer-readable medium.

When executed by the at least one processor, the program instructions cause the at least one processor to change an operation of the craft in response to the user input device being moved from one region of the plurality of regions to another region of the plurality of regions.

In some implementations, the user input device comprises a lever.

In some implementations, the plurality of regions comprises a lower detent, a main detent, and an upper detent; a lower gate configured to provide physical resistance to the user input device in moving from the lower detent to the main detent; and an upper gate configured to provide physical resistance to the user input device in moving from the main detent to the upper detent.

In some implementations, the operation of the craft is changeable between at least two of the following modes: maneuver mode, hull mode, foil mode, or wing mode.

In some implementations, the operation of the craft is changeable by performing at least one of the following: changing a control surface setting, changing a hydrofoil state setting, changing a ride height setting, changing a pitch of the craft, changing an altitude of the craft, changing an available power range of the craft, changing an available speed range of the craft, initiating a take-off routine, or initiating a landing routine.

In some implementations, the program instructions, when executed by the at least one processor, further cause the at least one processor to change a power or a speed of the craft in response to movement of the user input device in a region of the plurality of regions designated for changing the power or speed.

As described above, in an additional aspect, the present disclosure provides a craft comprising: a lever positionable in a lower detent, a main detent, and an upper detent; at least one processor; a non-transitory computer-readable medium; and program instructions stored on the non-transitory computer-readable medium.

When executed by the at least one processor, the program instructions cause the at least one processor to: transition the craft from maneuver mode to hull mode in response to the lever being moved from the lower detent to the main detent when the craft is in maneuver mode; transition the craft from hull mode to foil mode in response to the lever being moved from the main detent to the upper detent when the craft is in hull mode; transition the craft from foil mode to wing mode in response to the lever being again moved from the main detent to the upper detent when the craft is in wing mode; and change a power or a speed of the craft in response to movement of the lever within the main detent.

In some implementations, the program instructions, when executed by the at least one processor, further cause the at least one processor to: transition the craft from hull mode to maneuver mode in response to the lever being moved from the main detent to the lower detent when the craft is in hull mode; transition the craft from foil mode to hull mode in response to the lever being moved from the main detent to the lower detent when the craft is in foil mode; and at least one of transition the craft from wing mode to hull mode in response to the lever being moved from the main detent to the lower detent when the craft is in wing mode; or transition the craft from wing mode to foil mode in response to the lever being moved from the main detent to the lower detent when the craft is in wing mode.

In some implementations, transitioning the craft from hull mode to maneuver mode in response to the lever being moved from the main detent to the lower detent when the craft is in hull mode comprises transitioning the craft from hull mode to maneuver mode in response to the lever being moved from the main detent to the lower detent when the craft is in hull mode and an additional action by an operator of the craft is performed to confirm the craft is to be transitioned from hull mode to maneuver mode.

In some implementations, the craft further comprises a first gate configured to provide physical resistance in moving the lever from the lower detent to the main detent; and a second gate configured to provide physical resistance in moving the lever from the main detent to the upper detent.

In some implementations, a range of power or speed defined by movement of the lever within the main detent depends on a current mode of the craft and/or atmospheric condition.

In some implementations, the program instructions, when executed by the at least one processor, further cause the at least one processor to ignore at least a portion of movement of the lever from the upper detent to the main detent to avoid decreasing the power or speed of the craft.

In some implementations, the craft further comprises a side-stick controller configured to change a power or a speed of the craft when the craft is in maneuver mode.

In some implementations, the craft further comprises a user input device on the lever configured to change a power or a speed of the craft when the craft is in maneuver mode.

In some implementations, transitioning between modes comprises: changing a control surface setting, changing a hydrofoil state setting, changing a ride height setting, changing a pitch of the craft, changing an altitude of the craft, changing an available power range of the craft, changing an available speed range of the craft, initiating a take-off routine, or initiating a landing routine.

As described above, in a further aspect, the present disclosure provides a method comprising: performing in a control system of a craft comprising a lever movable between a first detent and a second detent, wherein a gate provides physical resistance to movement of the lever from the first detent to the second detent: receiving a signal indicating movement of the lever from the first detent to the second detent; and in response to receiving the signal, transitioning the craft from a first mode of operation to a second mode of operation.

In some implementations, the method further comprises changing a power or a speed of the craft in response to movement of the lever within one of the first and second detents.

In some implementations, the method further comprises aborting the transition in response to a request from an operator of the craft.

In some implementations, the method further comprises entering a failure mode in response to failing to transition from the first mode of operation to the second mode of operation.

In some implementations, transitioning comprises: changing a control surface setting, changing a hydrofoil state setting, changing a ride height setting, changing a pitch of the craft, changing an altitude of the craft, changing an available power range of the craft, changing an available speed range of the craft, initiating a take-off routine, or initiating a landing routine.

In some implementations, the method further comprises performing an emergency stop routine in response to the lever being held against a bottom stop.

What is claimed is:

1. A craft comprising:
a lever positionable in a lower detent, a main detent, and an upper detent, wherein a first gate is configured to provide physical resistance in moving the lever from the lower detent to the main detent and a second gate is configured to provide physical resistance in moving the lever from the main detent to the upper detent;
a user interface device;
at least one processor;
a non-transitory computer-readable medium; and
program instructions stored on the non-transitory computer-readable medium that, when executed by the at least one processor, cause the at least one processor to:
transition the craft from maneuver mode to hull mode in response to the lever being moved from the lower detent to the main detent when the craft is in maneuver mode;
transition the craft from hull mode to foil mode in response to the lever being moved from the main detent to the upper detent when the craft is in hull mode;
transition the craft from foil mode to wing mode in response to the lever being again moved from the main detent to the upper detent when the craft is in wing mode;
change a power or a speed of the craft in response to movement of the lever within the main detent; and
generate an output via the user interface device in response to movement of the lever.

2. The craft of claim 1, wherein the user interface device comprises a display device and generating the output comprises dynamically changing a display outputted on the display device to provide a visual indication of a transition from one mode to another mode.

3. The craft of claim 2, wherein dynamically changing the display comprises changing a displayed color that represents a current mode.

4. The craft of claim 2, wherein dynamically changing the display comprises changing a range of values of a displayed gauge.

5. The craft of claim 1, wherein the user interface device comprises a speaker, and wherein generating the output comprises playing a tone indicating an opportunity to abort a mode transition.

6. The craft of claim 1, further comprising program instructions stored on the non-transitory computer-readable medium that, when executed by the at least one processor, cause the at least one processor to:
generate a display on the user interface device, the display comprising a speed gauge, the speed gauge comprising a first region and a second region, wherein the first region corresponds to a representative range of speed available while the craft is in a first mode of operation, and wherein the second region corresponds to a representative range of speed available while the craft is in a second mode of operation,
wherein generating the output via the user interface device in response to movement of the lever comprises:
dynamically changing the display generated on the user interface device in response to movement of the lever, such that:
while the craft is in the first mode of operation, a set speed gauge is displayed adjacent the first region, and
while the craft is in the second mode of operation, the set speed gauge is displayed adjacent the second region.

7. The craft of claim 6, the display further comprising a height gauge, the height gauge comprising a first region and a second region, wherein the first region corresponds to a representative range of height available while the craft is in the first mode of operation, and wherein the second region corresponds to a representative range of height available while the craft is in the second mode of operation.

8. The craft of claim 6, wherein dynamically changing the display generated on the user interface device in response to movement of the lever further comprises dynamically changing the display generated on the user interface device in response to a transition from the first mode of operating the craft to the second mode of operating the craft, such that:
while the craft is in the first mode of operation, a set height gauge is displayed adjacent the first region, and
while the craft is in the second mode of operation, the set height gauge is displayed adjacent the second region.

9. The craft of claim 6, wherein the display further comprises a foil position indicator, the foil position indicator comprising at least (a) a state of a hydrofoil and (b) a position of the hydrofoil.

10. The craft of claim 9, wherein dynamically changing the display generated on the user interface device in response to movement of the lever further comprises dynamically changing the display generated on the user interface device in response to a transition from the first mode of operating the craft to the second mode of operating the craft, such that:
while the craft is in the first mode of operation, the state of the hydrofoil comprises locked and the position of the hydrofoil comprises a down position; and
while the craft is in the second mode of operation, the state of the hydrofoil comprises locked and the position of the hydrofoil comprises an up position.

11. The craft of claim 1, further comprising program instructions stored on the non-transitory computer-readable medium that, when executed by the at least one processor, cause the at least one processor to:
transition from a first mode of operating the craft to a second mode of operating that craft in response to actuation of the user input device; and
dynamically change a display generated on the user interface device in response to the transition of a mode of operating the craft from the first mode of operating the craft to the second mode of operating the craft, wherein the display comprises a speed gauge, wherein a range of the speed gauge is dynamically changed in response to the transition of the mode.

12. The craft of claim 1, wherein the user interface device comprises a speaker, and wherein generating the output comprises playing a tone indicating feedback on the transition.

13. The craft of claim 1, further comprising program instructions stored on the non-transitory computer-readable medium that, when executed by the at least one processor, cause the at least one processor to:
generate a display on the user interface device, wherein the display comprises a foil position indicator, the foil position indicator comprising at least (a) a state of a hydrofoil and (b) a position of the hydrofoil.

14. The craft of claim 13, further comprising program instructions stored on the non-transitory computer-readable medium that, when executed by the at least one processor, cause the at least one processor to:
transition from a first mode of operating the craft to a second mode of operating that craft in response to actuation of the user input device; and
dynamically change a display generated on the user interface device in response to the transition of a mode of operating the craft from the first mode of operating the craft to the second mode of operating the craft, wherein while the craft is in the first mode of operation, the state of the hydrofoil comprises locked and the position of the hydrofoil comprises a down position, and wherein while the craft is in the second mode of operation, the state of the hydrofoil comprises locked and the position of the hydrofoil comprises an up position.

15. The craft of claim 1, further comprising program instructions stored on the non-transitory computer-readable medium that, when executed by the at least one processor, cause the at least one processor to:
generate a display on the user interface device, the display comprising an operating mode indicator comprising a set of at least three symbols, the set of symbols comprising a first-mode symbol corresponding to the hull mode, a second-mode symbol corresponding to the foil mode, and a third-mode symbol corresponding to the wing mode.

16. The craft of claim 15, further comprising program instructions stored on the non-transitory computer-readable medium that, when executed by the at least one processor, cause the at least one processor to:
dynamically change the generated display in response to the transition from the hull mode to the foil mode, such that:
while the craft is in the foil mode, the foil mode symbol indicates that the craft is in the foil mode, the hull mode symbol indicates that the craft may transition to the hull mode, and the wing mode symbol indicates that the craft may transition to the wing mode; and
while the craft is in the wing mode, the wing mode symbol indicates that the craft is in the wing mode, the hull mode symbol indicates that the craft may transition to the hull mode, and the foil mode symbol indicates that the craft may not transition to the foil mode.

17. A control system comprising:
at least one processor;
a non-transitory computer-readable medium; and
program instructions stored on the non-transitory computer-readable medium that, when executed by the at least one processor, cause the at least one processor to:
transition a craft from maneuver mode to hull mode in response to a lever being moved from a lower detent to a main detent when the craft is in maneuver mode;
transition the craft from hull mode to foil mode in response to the lever being moved from the main detent to an upper detent when the craft is in hull mode;
transition the craft from foil mode to wing mode in response to the lever being again moved from the main detent to the upper detent when the craft is in wing mode;
change a power or a speed of the craft in response to movement of the lever within the main detent; and
generate an output via a user interface device in response to movement of the lever.

18. The control system of claim 17, wherein further comprising program instructions stored on the non-transitory computer-readable medium that, when executed by the at least one processor, cause the at least one processor to:
generate a display on the user interface device, the display comprising a speed gauge, the speed gauge comprising a first region and a second region, wherein the first region corresponds to a representative range of speed available while the craft is in a first mode of operation, and wherein the second region corresponds to a representative range of speed available while the craft is in a second mode of operation,
wherein generating the output via the user interface device in response to movement of the lever comprises:
dynamically changing the display generated on the user interface device in response to movement of the lever, such that:
while the craft is in the first mode of operation, a set speed gauge is displayed adjacent the first region, and
while the craft is in the second mode of operation, the set speed gauge is displayed adjacent the second region.

19. A method comprising:
transitioning a craft from maneuver mode to hull mode in response to a lever being moved from a lower detent to a main detent when the craft is in maneuver mode;
transitioning the craft from hull mode to foil mode in response to the lever being moved from the main detent to an upper detent when the craft is in hull mode;
transitioning the craft from foil mode to wing mode in response to the lever being again moved from the main detent to the upper detent when the craft is in wing mode;
changing a power or a speed of the craft in response to movement of the lever within the main detent; and
generating an output via a user interface device in response to movement of the lever.

20. The method of claim 18, further comprising:
generating a display on the user interface device, the display comprising a speed gauge, the speed gauge comprising a first region and a second region, wherein the first region corresponds to a representative range of speed available while the craft is in a first mode of operation, and wherein the second region corresponds to a representative range of speed available while the craft is in a second mode of operation,
wherein generating the output via the user interface device in response to movement of the lever comprises:
dynamically changing the display generated on the user interface device in response to movement of the lever, such that:
while the craft is in the first mode of operation, a set speed gauge is displayed adjacent the first region, and
while the craft is in the second mode of operation, the set speed gauge is displayed adjacent the second region.
